(19) United States
(12) Patent Application Publication
(10) Pub. No.: US 2015/0294587 A1
(43) Pub. Date: Oct. 15, 2015

(54) NEUROPERFORMANCE

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(21) Appl. No.: 14/469,011

(22) Filed: Aug. 26, 2014

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.

(51) Int. Cl. G09B 19/00; G09B 5/00

(52) U.S. Cl. CPC G09B 19/00; G09B 5/00

(57) ABSTRACT

Methods of promoting reasoning ability in a subject by performing a local or a non-local compression of a provided letters sequence when removing one or more contiguous letters located in between the two letters of an assigned open proto-bigram recognized by the subject in the provided letters sequence, and by performing an alphabetic expansion of an assigned open proto-bigram term by explicitly actualizing a collective critical space of the assigned open proto-bigram term by inserting the corresponding incomplete alphabetic letters sequence in between the two letters of an assigned open proto-bigram.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential statistical and combinatorial properties of alphanumerical series of symbols (e.g., in alphabetical series, letter sequences and series of numbers). These statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling some transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by principally focusing on the root base component of language, its alphabet, organizing its constituent parts, namely its letters and letter sequences (chunks) in novel ways to create rich and increasingly new complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical and combinatorial properties, including non-word letter patterns), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the broad concepts covered by the specific non-limiting exercises put forth in Examples 1 and 2 disclosed herein.

FIGS. 2A-2E depict a non-limiting example of the exercises for promoting reasoning in a subject to perform a compression of a provided letters sequence by removing one or more contiguous letters held in between two of the letters forming one of the open proto-bigram terms assigned in the ruler. FIG. 2A shows a selected direct alphabetical letters sequence. FIG. 2B shows the assigned open proto-bigram term ‘AM’ displayed with a spatial perceptual related attribute font boldness. FIGS. 2C and 2D show the selected letters ‘A’ and ‘M’ of the assigned open proto-bigram term ‘AM’ displayed with a time perceptual related attribute red font color. FIG. 2E shows assigned open proto-bigram term ‘AM’ displayed with a time perceptual related attribute red font color in the new incomplete direct alphabetic letters sequence.

FIGS. 3A-3E depict another non-limiting example of the exercises for promoting reasoning in a subject to perform a compression of a provided letters sequence by removing one or more contiguous letters in order for the two letters of an assigned open proto-bigram term to become contiguous. FIG. 3A shows a selected inverse alphabetical letters sequence. FIG. 3B shows the assigned open proto-bigram term ‘HE’ displayed with a spatial perceptual related attribute font boldness. FIGS. 3C and 3D show the selected letters ‘H’ and ‘E’ of the assigned open proto-bigram term ‘HE’ displayed in time perceptual related attribute font blue color. FIG. 3E shows assigned open proto-bigram term ‘HE’ displayed with a time perceptual related attribute blue font color in the new incomplete inverse alphabetic letters sequence.

FIGS. 4A-4J depict a non-limiting example of the exercises for promoting reasoning in a subject to perform a compression of the provided letters sequence by removing one or more contiguous letters in order for the two letters of an assigned open proto-bigram term to become contiguous. FIG. 4A shows a selected direct alphabetical letters sequence. FIG. 4B shows the assigned open proto-bigram term ‘BE’ displayed in the ruler in a spatial perceptual related attribute small font size. FIGS. 4C and 4D show the selected letters ‘B’ and ‘E’ of the assigned open proto-bigram term ‘BE’ displayed in time perceptual related attribute font red color. FIG. 4E shows assigned open proto-bigram term ‘BE’ displayed with a time perceptual related attribute red font color in the new incomplete direct alphabetic letters sequence. FIG. 4F shows newly assigned open proto-bigram term ‘OR’ displayed in the ruler with a spatial perceptual related attribute font boldness. FIGS. 4G and 4H show the selected letters ‘O’ and ‘R’ of the assigned open proto-bigram term ‘OR’ displayed in time perceptual related attribute font red color. FIG. 4I shows open proto-bigram term ‘OR’ displayed with time perceptual related attribute font red color in the ruler. FIG. 4J shows all of the revealed open proto-bigram terms displayed with time perceptual related attribute font red color in the final obtained direct incomplete alphabetical letters sequence.

FIGS. 5A-5J depict another non-limiting example of the exercises for promoting reasoning in a subject to perform a compression of the provided letters sequence by removing one or more contiguous letters to form an open proto-bigram term. FIG. 5A shows a selected inverse alphabetical letters sequence. FIG. 5B shows the assigned open proto-bigram term ‘SO’ displayed in the ruler with spatial perceptual related attribute font boldness. FIGS. 5C and 5D show the selected letters ‘S’ and ‘O’ of the assigned open proto-bigram term ‘SO’ displayed in time perceptual related attribute font blue color. FIG. 5E shows assigned open proto-bigram term ‘SO’ displayed with time perceptual related attribute blue font color in the new incomplete inverse alphabetic letters sequence. FIG. 5F shows newly assigned open proto-bigram term ‘IF’ displayed in the ruler in a spatial perceptual related attribute large font size. FIGS. 5G and 5H show the selected letters ‘I’ and ‘F’ of the assigned open proto-bigram term ‘IF’ displayed in time perceptual related attribute font blue color. FIG. 5I shows open proto-bigram term ‘IF’ displayed with time perceptual related attribute font blue color in the ruler FIG. 5J shows all of the revealed open proto-bigram terms displayed with time perceptual related attribute font blue color in the final obtained inverse incomplete alphabetical letters sequence.

FIGS. 6A-6N depict a non-limiting example of the exercises for promoting reasoning in a subject to perform a compression of the provided letters sequence by removing one or more contiguous letters to form an open proto-bigram term. FIG. 6A shows a complete non-alphabetical letters sequence and complete open proto-bigrams sequence displayed in the ruler. FIG. 6B shows the first assigned open proto-bigram term ‘AM’ displayed with spatial perceptual related attribute font boldness. FIGS. 6C and 6D show the selected letters ‘A’ and ‘M’ displayed with time perceptual related attribute font boldness. FIG. 6E shows assigned open proto-bigram term ‘AM’ displayed with time perceptual related attribute font boldness in the new incomplete non-alphabetic letters sequence. Similarly, FIGS. 6F-61 show another compression of the letters sequence for the second assigned open proto-bigram term ‘ON’ displayed with a spatial perceptual related attribute larger font size. FIGS. 6J-6M show a third transformation of the provided letters sequence for the last assigned open proto-bigram term ‘AT’ displayed with a time perceptual related attribute font red color. FIG. 6N shows the last revealed open proto-bigram term ‘AT’ displayed with time perceptual related attribute font red color in the final obtained incomplete non-alphabetical letters sequence.

FIGS. 7A-7Q depict a non-limiting example of the exercises for promoting reasoning in a subject to perform a compression of the provided letters sequence by removing one or more contiguous letters to form an open proto-bigram term. FIG. 7A shows a complete non-alphabetical letters sequence and complete open proto-bigrams sequence displayed in the ruler. FIG. 7B shows the first assigned open proto-bigram term ‘ON’ displayed with a spatial perceptual related attribute font type. FIGS. 7C and 7D show the selected letters ‘O’ and ‘N’ displayed with spatial perceptual related attribute font type. FIG. 7E shows assigned open proto-bigram term ‘ON’ displayed with spatial perceptual related attribute font type in the new incomplete non-alphabetic letters sequence. FIGS. 7F-7I show another compression of the letters sequence for the second assigned open proto-bigram term ‘AS’ displayed with a spatial perceptual related attribute font boldness. Similarly, FIGS. 7J-7M show a third compression of the letters sequence for the assigned open proto-bigram term ‘SO’ displayed with a time perceptual related attribute font blue color. FIGS. 7N-7Q show a final compression of the letters sequence for the last assigned open proto-bigram term ‘AT’ displayed with a time perceptual related attribute font red color. FIG. 7Q shows the last revealed open proto-bigram term ‘AT’ displayed with time perceptual related attribute font red color in the final obtained incomplete non-alphabetical letters sequence.

FIGS. 8A-8N depict a non-limiting example of the exercises for promoting reasoning in a subject to perform a compression of the provided letters sequence by removing one or more contiguous letters to form an open proto-bigram term. FIG. 8A shows a complete non-alphabetical letters sequence and complete open proto-bigrams sequence displayed in the ruler. FIG. 8B shows the assigned open proto-bigram term ‘BE’ displayed in a time perceptual related attribute font red color. FIGS. 8C and 8D show the selected letters ‘B’ and ‘E’ displayed with time perceptual related attribute font red color. FIG. 8E shows the assigned open proto-bigram term ‘BE’ displayed with time perceptual related attribute font red color in the new incomplete non-alphabetic letters sequence. FIGS. 8F-8I show another compression of the letters sequence for second assigned open proto-bigram term ‘IF’ displayed with spatial perceptual related attribute font boldness. FIG. 8I shows revealed open proto-bigram term ‘IF’ displayed with spatial perceptual related attribute font boldness in the second new incomplete non-alphabetic letters sequence. FIGS. 8J-M shows a third compression of the letters sequence for the third open proto-bigram term ‘OR’ displayed with spatial perceptual related attribute larger font size. FIG. 8M shows revealed open proto-bigram term ‘OR’ displayed in spatial perceptual related attribute larger font size in the third new incomplete non-alphabetic letters sequence. FIG. 8N shows all of the revealed open proto-bigram terms ‘BE’, ‘IF’, and ‘OR’ displayed with their respective spatial and time perceptual related attributes in the final obtained incomplete non-alphabetical letters sequence.

FIGS. 9A-9F depict a non-limiting example of the exercises for promoting reasoning in a subject to perform a non-local compression of the provided letters sequence by removing more than two contiguous letters to form an open proto-bigram term. This example shows an extraordinary non-local compression. FIG. 9A shows a complete non-alphabetical different letters sequence and complete open proto-bigrams sequence displayed in the ruler. FIG. 9B shows the assigned open proto-bigram term ‘BE’ displayed in the ruler with time perceptual related attribute font red color. FIGS. 9C and 9D show the selected letters ‘B’ and ‘E’ displayed in time perceptual related attribute font red color. FIG. 9E shows assigned open proto-bigram term ‘BE’ displayed with spatial perceptual related attribute red font color in the obtained non-alphabetical different letters sequence and in the ruler. In FIG. 9F, open proto-bigram term ‘BE’ is displayed with spatial perceptual related attribute red font color only in the obtained non-alphabetical different letters sequence.

FIGS. 10A-10DD depict a non-limiting example of the exercises for promoting reasoning in a subject to perform a transpositional compression of the provided letters sequence by removing one or more contiguous letters to form an open proto-bigram term. FIG. 10A shows a complete non-alphabetical same letters sequence and complete open proto-bigrams sequence displayed in the ruler. FIG. 10B shows the first assigned open proto-bigram term ‘AT’ displayed with spatial perceptual related attribute font type. FIGS. 10C and 10D show the selected letters ‘A’ and ‘T’ displayed with spatial perceptual related attribute font type. In FIG. 10E, the assigned open proto-bigram term ‘AT’ is displayed with spatial perceptual related attribute font type in the new incomplete non-alphabetic letters sequence.

FIGS. 10E-10I show a second compression of the letters sequence for the assigned open proto-bigram term ‘ME’ displayed with spatial perceptual related attribute small font size. FIG. 10I shows revealed open proto-bigram term ‘ME’ displayed with spatial perceptual related attribute small font size in the second new incomplete non-alphabetic letters sequence.

FIGS. 10J-10M show a third compression of the letters sequence for the third open proto-bigram term ‘IN’ displayed with a spatial perceptual related attribute font boldness. FIG. 10M shows revealed open proto-bigram term ‘IN’ displayed with spatial perceptual related attribute font boldness in the third new incomplete non-alphabetic letters sequence.

FIGS. 10N-10Q shows a fourth compression of the letters sequence for the assigned open proto-bigram term ‘NO’ displayed with time perceptual related attribute font blue color. FIG. 10Q shows revealed open proto-bigram term ‘NO’ displayed with time perceptual related attribute font blue color in the fourth new incomplete non-alphabetic letters sequence.

FIGS. 10R-10U shows a fifth compression of the letters sequence for the assigned open proto-bigram term ‘OF’ displayed with time perceptual related attribute font red color. FIG. 10U shows revealed open proto-bigram term ‘OF’ displayed with time perceptual related attribute font red color in the fifth new incomplete non-alphabetic letters sequence.

FIGS. 10V-10Y show a sixth compression of the letters sequence for the assigned open proto-bigram term ‘IF’ displayed with a spatial perceptual related attribute larger font size. FIG. 10Y shows revealed open proto-bigram term ‘IF’ displayed with spatial perceptual related attribute larger font size in the sixth new incomplete non-alphabetic letters sequence.

FIGS. 10Z-10CC show a final compression of the letters sequence for the seventh assigned open proto-bigram term ‘HE’ displayed with time perceptual related attribute font red color. FIG. 10DD shows revealed open proto-bigram term ‘HE’ displayed with time perceptual related attribute font red color in the seventh new incomplete non-alphabetic letters sequence.

FIG. 10DD shows assigned open proto-bigram terms ‘AT’, ‘HE’, and ‘IF’ displayed in their respective spatial or time perceptual related attributes only in the final obtained non-alphabetical same letters sequence.

FIGS. 11A-11F depict a non-limiting example of the exercises for promoting reasoning in a subject to perform an extraordinary non-local compression of the provided letters sequence by removing more than two contiguous letters to form an open proto-bigram term. FIG. 11A shows a complete non-alphabetical same letters sequence and complete open proto-bigrams sequence displayed in the ruler. FIG. 11B shows the assigned open proto-bigram term ‘OF’ displayed with spatial perceptual related attribute font boldness. FIGS. 11C and 11D show the selected letters ‘O’ and ‘F’ displayed in spatial perceptual related attribute font boldness FIG. 11E shows assigned open proto-bigram term ‘OF’ displayed with spatial perceptual related attribute font boldness in the obtained non-alphabetical same letters sequence and in the ruler. In FIG. 11F, open proto-bigram term ‘OF’ is displayed with spatial perceptual related attribute font boldness only in the obtained non-alphabetical same letters sequence.

FIG. 12 is a flow chart setting forth the broad concepts covered by the specific non-limiting exercises put forth in Example 3 disclosed herein.

FIGS. 13A-H depict a non-limiting example of the exercises for promoting reasoning in a subject to perform an expansion of one or more contiguous letters in between an open proto-bigram term to form an incomplete letters sequence. FIG. 13A shows a direct alphabetical letters sequence and FIG. 13B shows the selected open proto-bigram term ‘GO.’ FIGS. 13C-H show the correctly expanded letters sequence for each single letter selection in the sequence.

FIGS. 14A-F depict another non-limiting example of the exercises for promoting reasoning in a subject to perform an expansion of one or more contiguous letters in between an open proto-bigram term to form an incomplete letters sequence. FIG. 14A shows an inverse alphabetical letters sequence and FIG. 14B shows selected open proto-bigram term ‘TO.’ FIGS. 14C-F show the correctly expanded letters sequence for each single letter selection in the sequence.

FIGS. 15A-D depict a non-limiting example of the exercises for promoting reasoning in a subject to perform an expansion of one or more contiguous letters in between a selected open proto-bigram term to form an incomplete letters sequence. FIG. 15A shows a randomized serial order of an alphabetic set array and a ruler having a direct alphabetic set array. FIG. 15B shows selected open proto-bigram term ‘BE’ displayed. FIG. 15C shows correctly inserted letter ‘C’ in time perceptual related attribute font red color in the selected open proto-bigram term. FIG. 15D shows final letter ‘D’ correctly inserted between the selected open proto-bigram term in time perceptual related attribute font red color.

FIGS. 16A-16V depict a non-limiting example of the exercises for promoting reasoning in a subject to perform an expansion of one or more contiguous letters in between an open proto-bigram term to form an incomplete letters sequence. FIG. 16A shows a direct alphabetical letters sequence and a ruler displaying a direct open proto-bigrams sequence. FIG. 16B shows assigned open proto-bigram term ‘AM’ displayed with spatial perceptual related attribute font boldness. FIGS. 16C and 16D show the selected letters ‘A’ and ‘M’ displayed with spatial perceptual related attribute font boldness. In FIG. 16E, the subject is prompted to select each letter between the two selected letters of the assigned open proto-bigram term to reveal the incomplete direct alphabetical letters sequence there between. FIGS. 16F-16P show the revealed incomplete letters sequence for each single letter selection between the selected letters of the assigned open proto-bigram term ‘AM’ with time perceptual related attribute font red color.

FIG. 16Q shows assigned open proto-bigram term ‘OR’ displayed with spatial perceptual related attribute font boldness. FIGS. 16R and 16S show the selected letters ‘O’ and ‘R’ displayed with spatial perceptual related attribute font boldness. In FIG. 16T, the subject is prompted to select each letter between the ‘O’ and the ‘R’ of the assigned open proto-bigram term to reveal the incomplete direct letters sequence there between. FIGS. 16U and 16V show the revealed incomplete direct letter sequence for each single letter selection between the selected letters of the assigned open proto-bigram term ‘OR’ with time perceptual related attribute font red color.

FIGS. 17A-17U depict a non-limiting example of the exercises for promoting reasoning in a subject to perform an expansion of one or more contiguous letters in between an assigned open proto-bigram term to form an incomplete direct letters sequence. FIG. 17A shows a direct alphabetical letters sequence and a ruler displaying a direct open proto-bigrams sequence. FIG. 17B shows assigned open proto-bigram term ‘BE’ displayed with spatial perceptual related attribute larger font size. FIGS. 17C and 17D show the selected letters ‘B’ and ‘E’ displayed with spatial perceptual related attribute font boldness. In FIG. 17E, the subject is prompted to select each letter between the two selected letters of the assigned open proto-bigram term. FIGS. 17F and 17G show the selected letters between the assigned open proto-bigram term ‘BE’ with spatial perceptual related attribute smaller font size.

FIGS. 17H-17O show a second expansion of the provided letters sequence for assigned open proto-bigram term ‘IN’ displayed with spatial perceptual related attribute larger font size. FIG. 17O shows selected open proto-bigram term ‘IN’ expanded to reveal the incomplete direct alphabetical letters sequence there between.

Similarly, FIGS. 17P-17U show a third expansion of the provided letters sequence for the assigned open proto-bigram term ‘OR’ displayed with spatial perceptual related attribute larger font size. FIG. 17U shows selected open proto-bigram term ‘OR’ fully expanded to reveal the incomplete direct alphabetical letters sequence there between.

FIGS. 18A-18U depict another non-limiting example of the exercises for promoting reasoning in a subject to perform an expansion of one or more contiguous letters in between an assigned open proto-bigram term to form an incomplete inverse letters sequence. FIG. 18A shows an inverse alphabetical letters sequence and a ruler displaying an inverse open proto-bigrams sequence. FIG. 18B shows assigned open proto-bigram term ‘OF’ displayed with spatial perceptual related attribute font type. FIGS. 18C and 18D show the selected letters ‘O’ and ‘F’ displayed with spatial perceptual related attribute font type. In FIG. 18E, the subject is prompted to select each letter between the two selected letters of the assigned open proto-bigram term. FIGS. 18F-18M show the selected letters between the assigned open proto-bigram term ‘OF’ expanded to reveal the incomplete inverse alphabetical letters sequence there between.

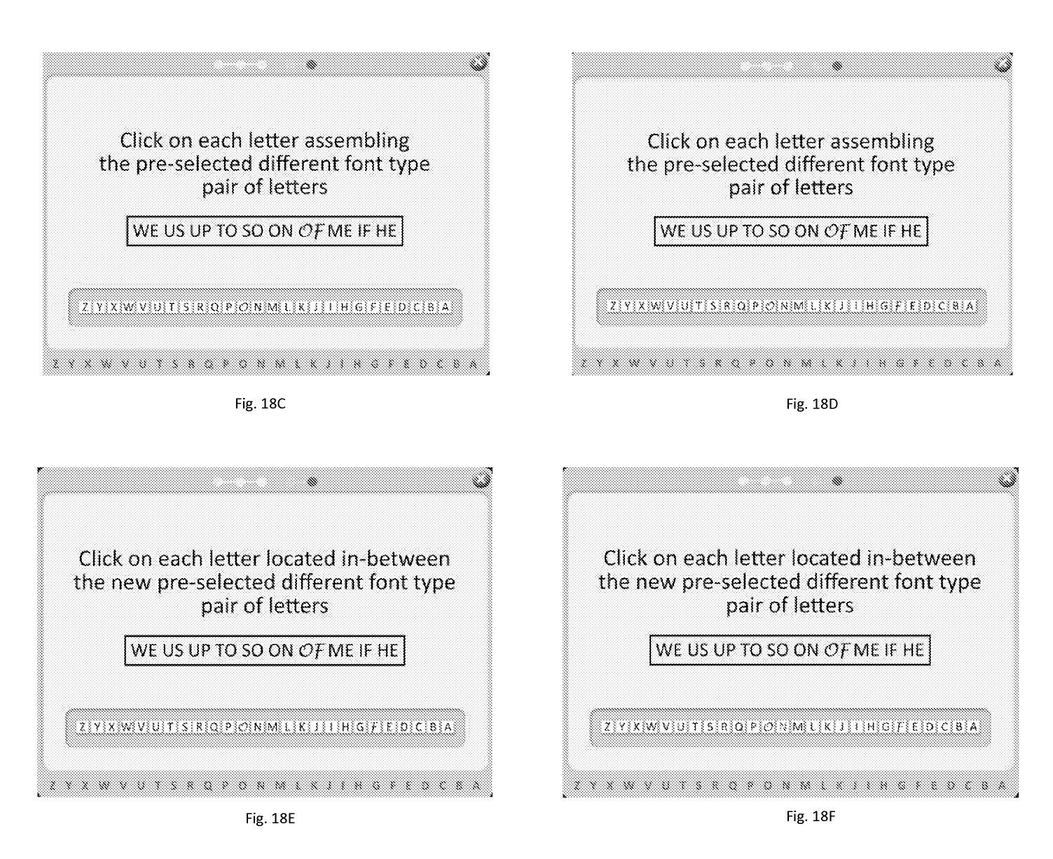

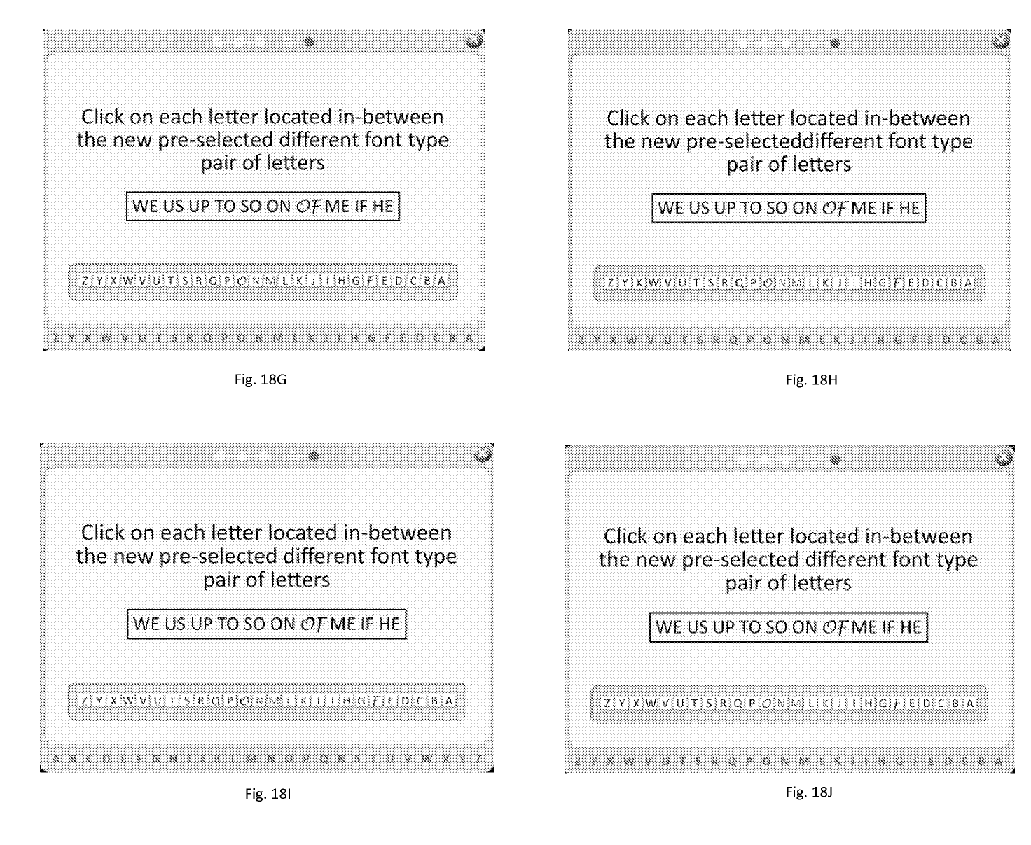

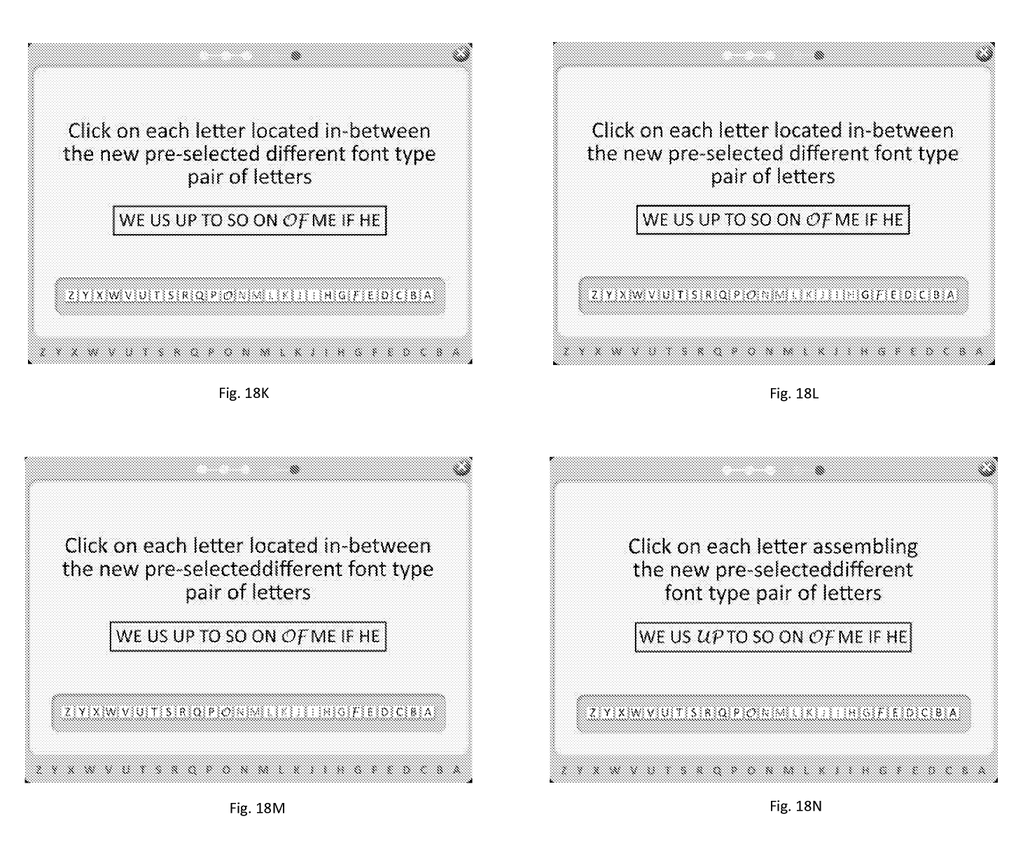

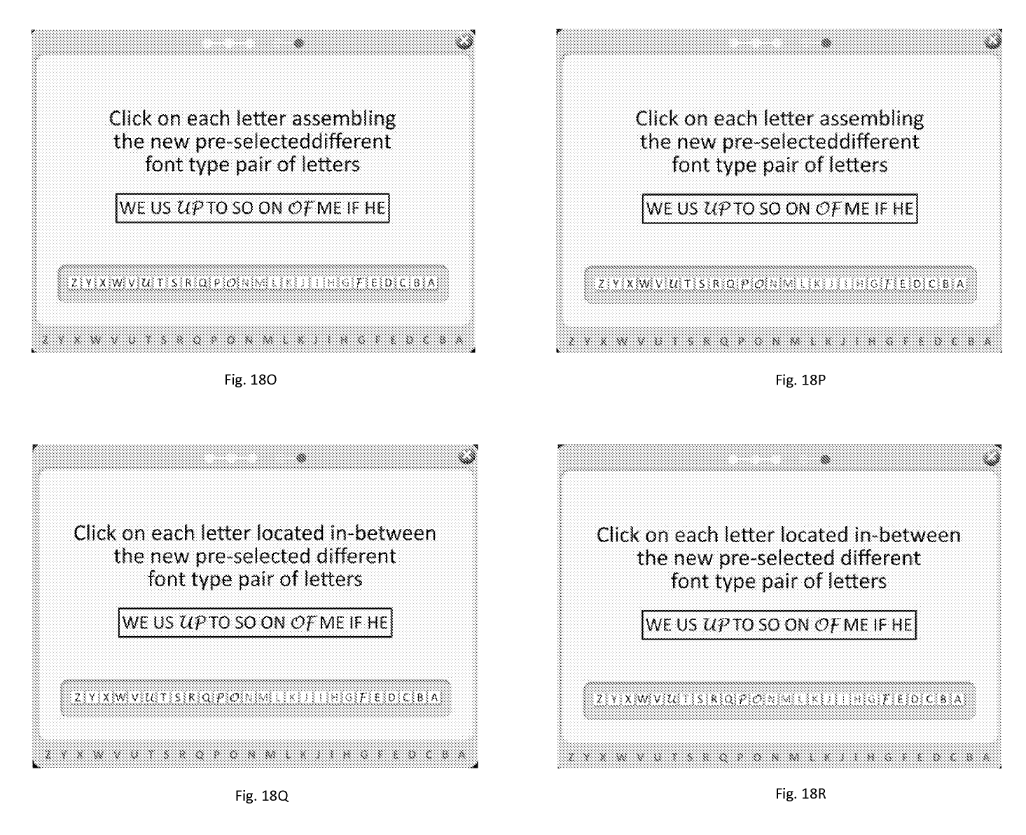

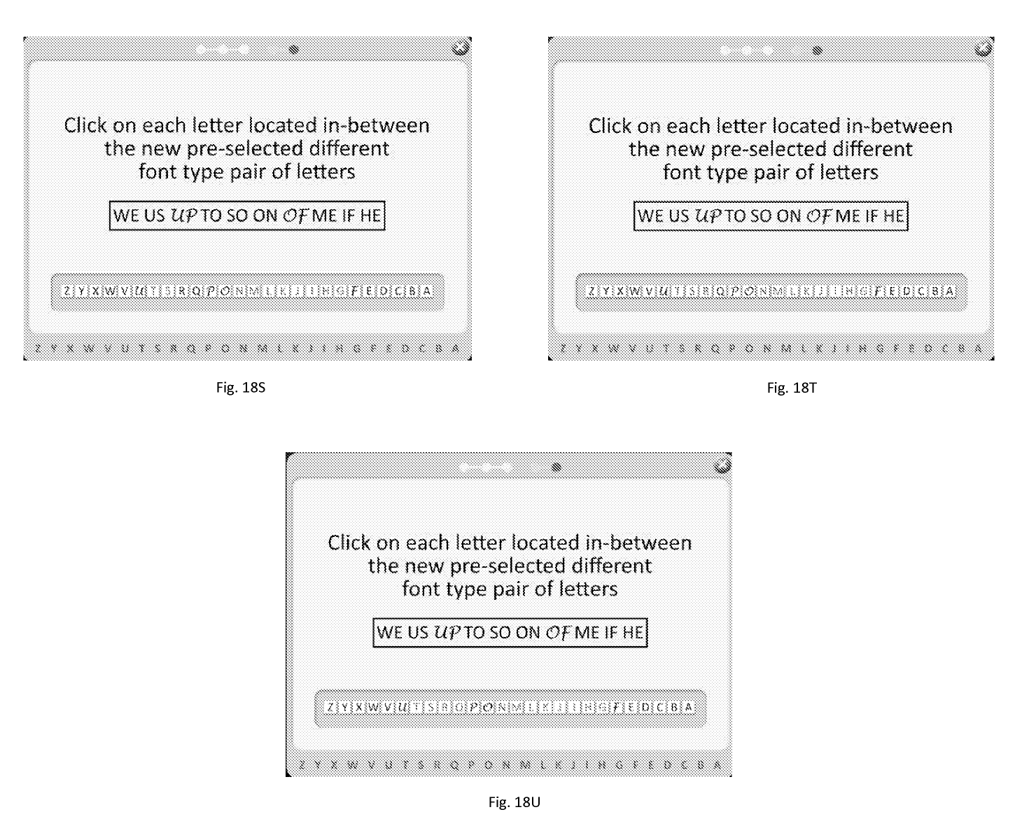

Likewise, FIG. 18N-18U shows a second expansion of the provided inverse letters sequence for the assigned open proto-bigram term ‘UP’ displayed with spatial perceptual related attribute font type. FIG. 18U shows selected open proto-bigram term ‘UP’ fully expanded to reveal the incomplete inverse alphabetical letters sequence there between.

### DETAILED DESCRIPTION

### Introduction

It is generally assumed that individual letters and the mechanism responsible for coding the positions of these letters in a string are the key elements for orthographic processing and determining the nature of the orthographic code. To expand the understanding of the mechanisms that interact, inhibit and modulate orthographic processing, there should also be an acknowledgement of the ubiquitous influence of phonology in reading comprehension. There is a growing consensus that reading involves multiple processing routes, namely the lexical and sub-lexical routes. In the lexical route, a string directly accesses lexical representations. When a visual image first arrives at a subject's cortex, it is in the form of a retinotopic encoding. If the visual stimulus is a letter string, an encoding of the constituent letter identities and positions takes place to provide a suitable representation for lexical access. In the sub-lexical route, a string is transformed into a phonological representation, which then contacts lexical representations.

Indeed, there is growing consensus that orthographic processing must connect with phonological processing quite early on during the process of visual word recognition, and that phonological representations constrain orthographic processing (Frost, R. (1998) Toward a strong phonological theory of visual word recognition: True issues and false trails, Psychological Bulletin, 123, 71_{—}99; Van Orden, G. C. (1987) A ROWS is a ROSE: Spelling, sound, and reading, Memory and Cognition, 15(3), 181-1987; and Ziegler, J. C., & Jacobs, A. M. (1995), Phonological information provides early sources of constraint in the processing of letter strings, Journal of Memory and Language, 34, 567-593).

Another major step forward in orthographic processing research concerning visual word recognition has taken into consideration the anatomical constraints of the brain to its function. Hunter and Brysbaert describe this anatomical constraint in terms of interhemispheric transfer cost (Hunter, Z. R., & Brysbaert, M. (2008), Theoretical analysis of interhemispheric transfer costs in visual word recognition, Language and Cognitive Processes, 23, 165-182). The assumption is that information falling to the right and left of fixation, even within the fovea, is sent to area V1 in the contralateral hemisphere. This implies that information to the left of fixation (LVF), which is processed initially by the right hemisphere of the brain, must be redirected to the left hemisphere (collosal transfer) in order for word recognition to proceed intact.

Still, another general constraint to orthographic processing is the fact that written words are perceived as visual objects before attaining the status of linguistic objects. Research has revealed that there seems to be a pre-emption of visual object processing mechanisms during the process of learning to read (McCandliss, B., Cohen, L., & Dehaene, S. (2003), The visual word form area: Expertise for reading in the fusiform gyrus, Trends in Cognitive Sciences, 13, 293-299). For example, the alphabetic array proposed by Grainger and van Heuven is one such mechanism, described as a specialized system developed specifically for the processing of strings of alphanumeric stimuli (but not for symbols) (Grainger, J., & van Heuven, W. (2003), Modeling letter position coding in printed word perception, In P. Bonin (Ed.), The mental lexicon (pp. 1-23), New York: Nova Science).

### Transposed Letter (TL) Priming

The effects of letter order on visual word recognition have a long research history. Early on during word recognition, letter positions are not accurately coded. Evidence of this comes from transposed-letter (TL) priming effects, in which letter strings generated by transposing two adjacent letters (e.g., “jugde” instead of “judge”) produce large priming effects, more than the priming effect with the letters replaced by different letters in the corresponding position (e.g., “junpe” instead of “judge”). Yet, the clearest evidence for TL priming effects was obtained from experiments using non-word anagrams formed by transposing two letters in a real word (e.g., “mohter” instead of “mother”) and comparing performance with matched non-anagram non-words (Andrews, S. (1996), Lexical retrieval and selection processes: Effects of transposed letter confusability, Journal of Memory and Language, 35, 775-800; Bruner, J. S., & O'Dowd, D. (1958), A note on the informativeness of parts of words, Language and Speech, 1, 98-101; Chambers, S. M. (1979), Letter and order information in lexical access, Journal of Verbal Learning and Behavior, 18, 225-241; O'Connor, R. E., & Forster, K. I. (1981), Criterion bias and search sequence bias in word recognition, Memory and Cognition, 9, 78-92; and Perea, M., Rosa, E., & Gomez, C. (2005), The frequency effect for pseudowords in the lexical decision task, Perception and Psychophysics, 67, 301-314). These experiments show that TL non-word anagrams are more often misperceived as a real word or misclassified as a real word in a lexical decision task than the non-anagram controls.

Other experiments that focused on the role of letter order in the perceptual matching task in which subjects had to classify two strings of letters as being either the same or different exhibited a diversity of responses depending on the number of shared letters and the degree to which the shared letters match in ordinal position (Krueger, L. E. (1978), A theory of perceptual matching, Psychological Review, 85, 278-304; Proctor, R. W., & Healy, A. F. (1985), Order-relevant and order-irrelevant decision rules in multiletter matching, Journal of Experimental Psychology: Learning, Memory, and Cognition, 11, 519-537; and Ratcliff, R. (1981), A theory of order relations in perceptual matching, Psychological Review, 88, 552-572). Observed priming effects were ruled by the number of letters shared across prime and target and the degree of positional match. Still, Schoonbaert and Grainger found that the size of TL-priming effects might depend on word length, with larger priming effects for 7-letter words as compared with 5-letter words (Schoonbaert, S., & Grainger, J. (2004), Letter position coding in printed word perception: Effects of repeated and transposed letters, Language and Cognitive Processes, 19, 333-367). More so, Guerrera and Foster found robust TL-priming effects in 8-letter words with rather extreme TL operations involving three transpositions e.g., 13254768-12345678 (Guerrera, C., & Forster, K. I. (2008), Masked form priming with extreme transposition, Language and Cognitive Processes, 23, 117-142). In short, target word length and/or target neighborhood density strongly determines the size of TL-priming effects.

Of equal importance, TL priming effects can also be obtained with the transposition of non-adjacent letters. The robust effects of non-adjacent TL primes were reported by Perea and Lupker with 6-10 letter long Spanish words (Perea, M., & Lupker, S. J. (2004), Can CANISO activate CASINO? Transposed-letter similarity effects with nonadjacent letter positions, Journal of Memory and Language, 51(2), 231-246). Same TL primes effects were reported in English words by Lupker, Perea, and Davis (Lupker, S. J., Perea, M., & Davis, C. J. (2008), Transposed-letter effects: Consonants, vowels, and letter frequency, Language and Cognitive Processes, 23, (1), 93-116). Additionally, Guerrera and Foster have shown that priming effects can be obtained when primes include multiple adjacent transpositions e.g., 12436587-12345678 (Guerrera, C., & Forster, K. I. (2008), Masked form priming with extreme transposition, Language and Cognitive Processes, 23, 117-142).

Past research regarding a possible influence of letter position (inner versus outer letters) in TL priming has shown that non-words formed by transposing two inner letters are harder to respond to in a lexical decision task than non-words formed by transposing the two first or the two last letters (Chambers, S. M. (1979), Letter and order information in lexical access, Journal of Verbal Learning and Behavior, 18, 225-241). Still, Schoonbaert and Grainger provided evidence that TL primes involving an outer letter (the first or the last letter of a word) are less effective than TL primes involving two inner letters (Schoonbaert, S., & Grainger, J. (2004), Letter position coding in printed word perception: Effects of repeated and transposed letters, Language and Cognitive Processes, 19, 333-367). Guerrera and Foster also suggested a special role of a word's outer letters (Guerrera, C., & Forster, K. I. (2008), Masked form priming with extreme transposition, Language and Cognitive Processes, 23, 117-142; and Jordan, T. R., Thomas, S. M., Patching, G. R., & Scott-Brown, K. C. (2003), Assessing the importance of letter pairs in initial, exterior, and interior positions in reading, Journal of Experimental Psychology: Learning, Memory, and Cognition, 29, 883-893).

In all of the above-mentioned studies, the TL priming contained all of the target's letters. When primes do not contain the entire target's letters, TL priming effects diminish substantially and tend to vanish (Humphreys, G. W., Evett, L. J., & Quinlan, P. T. (1990), Orthographic processing in visual word identification, Cognitive Psychology, 22, 517-560; and Peressotti, F., & Grainger, J. (1999), The role of letter identity and letter position in orthographic priming, Perception and Psychophysics, 61, 691-706).

### Relative-Position (RP) Priming

Relative-position (RP) priming involves a change in length across the prime and target such that shared letters can have the same order without being matched in terms of absolute length-dependent positions. RP priming can be achieved by removing some of the target's letters to form the prime stimulus (subset priming) or by adding letters to the target (superset priming). Primes and targets differing in length are obtained so that absolute position information changes while the relative order of letters is preserved. For example, for a 5-letter target e.g., 12345, a 5-letter substitution prime such as 12d45 contains letters that have the same absolute position in the prime and the target, while a 4-letter subset prime such as 1245 contains letters that preserve their relative order in the prime and the target but not their precise length-dependent position. Humphreys et al. reported significant priming for primes sharing four out of five of the target's letters in the same relative position (1245) compared to both a TL prime condition (1435) and an outer-letter only condition ldd5 (Humphreys, G. W., Evett, L. J., & Quinlan, P. T. (1990), Orthographic processing in visual word identification, Cognitive Psychology, 22, 517-560).

Peressotti and Grainger provided further evidence for the effects of RL priming using the Foster and Davis masked priming technique. They reported that, with 6-letter target words, RP primes (1346) produced a significant priming effect compared with unrelated primes (dddd). Meanwhile, violation of the relative position of letters across the prime and the target e.g., 1436, 6341 cancelled priming effects relative to all different letter primes e.g., dddd (Peressotti, F., & Grainger, J. (1999), The role of letter identity and letter position in orthographic priming, Perception and Psychophysics, 61, 691-706). Grainger et al., reported small advantages for beginning-letter primes e.g., 1234/12345 compared with end-letter primes e.g., 4567/6789 (Grainger, J., Granier, J. P., Farioli, F., Van Assche, E., & van Heuven, W. (2006a), Letter position information and printed word perception: The relative position priming constraint, Journal of Experimental Psychology: Human Perception and Performance, 32, 865-884). Likewise, an advantage for completely contiguous primes e.g., 1234/12345-34567/56789 is explained in terms of a phonological overlap in the contiguous condition compared with non-contiguous primes e.g., 1357/13457/1469/14569 (Frankish, C., & Turner, E. (2007), SIHGT and SUNOD: The role of orthography and phonology in the perception of transposed letter anagrams, Journal of Memory and Language, 56, 189-211). Further, Schoonbaert and Grainger utilize 7-letter target words containing a non-adjacent repeated letter such as “balance” and form prime stimuli “balnce” or “balace”. They reported priming effects were not influenced by the presence or absence of a letter repetition in the formed prime stimulus. On the other hand, performance to target stimuli independently of prime condition was adversely affected by the presence of a repeated letter, and this was true for both the word and non-word targets (Schoonbaert, S., & Grainger, J. (2004), Letter position coding in printed word perception: Effects of repeated and transposed letters, Language and Cognitive Processes, 19, 333-367).

### Letter Position Serial Encoding: The SERIOL Model

The SERIOL model (Sequential Encoding Regulated by Inputs to Oscillations within Letter units) is a theoretical framework that provides a comprehensive account of string processing in the proficient reader. It offers a computational theory of how a retinotopic representation is converted into an abstract representation of letter order. The model mainly focuses on bottom-up processing, but this is not meant to rule out top-down interactions.

The SERIOL model is comprised of five layers: 1) edges, 2) features, 3) letters, 4) open-bigrams, and 5) words. Each layer is comprised of processing units called nodes, which represent groups of neurons. The first two layers are retinotopic, while the latter three layers are abstract. For the retinotopic layers, the activation level denotes the total amount of neural activity across all nodes devoted to representing a letter within a given layer. A letter's activation level increases with the number of neurons representing that letter and their firing rate. For the abstract layers, the activation denotes the activity level of a representational letter unit in a given layer. In essence, the SERIOL model is the only one that specifies an abstract representation of individual letters. Such a letter unit can represent that letter in any retinal location, wherein timing firing binds positional information in the string to letter identity.

The edge layer models early visual cortical areas V1/V2. The edge layer is retinotopically organized and is split along the vertical meridian corresponding to the two cerebral hemispheres. In these early visual cortical areas, the rate of spatial sampling (acuity) is known to sharply decrease with increasing eccentricity. This is modelled by the assumption that activation level decreases as distance from fixation increases. This pattern is termed the ‘acuity gradient’. In short, the activation pattern at the lowest level of the model, the edge layer, corresponds to visual acuity.

The feature layer models V4. The feature layer is also retinotopically organized and split across the hemispheres. Based on learned hemisphere-specific processing, the acuity gradient of the edge layer is converted to a monotonically decreasing activation gradient (called the locational gradient) in the feature layer. The activation level is highest for the first letter and decreases across the string. Hemisphere-specific processing is necessary because the acuity gradient does not match the locational gradient in the first half of a fixated word (i.e., acuity increases from the first letter to the fixated letter and the locational gradient decreases across the string), whereas the acuity gradient and locational gradient match in the second half of the word (i.e., both decreasing). Strong directional lateral inhibition is required in the hemisphere (for left-to-right languages—Right Hemisphere [RH]) contralateral to the first half of the word (for left-to-right languages—Left Visual Field [LVF]), in order to invert the acuity gradient.

At the letter layer, corresponding to the posterior fusiform gyrus, letter units fire serially due to the interaction of the activation gradient with oscillatory letter nodes (see above feature layer). That is, the letter unit encoding the first letter fires, then the unit encoding the second letter fires, etc. This mechanism is based on the general proposal that item order is encoded in successive gamma cycles 60 Hz of a theta cycle 5 Hz (Lisman, J. E., & Idiart, M. A. P. (1995), Storage of 7±2 short-term memories in oscillatory subcycles, Science, 267, 1512-1515). Lisman and Idiart have proposed related mechanisms for precisely controlling spike timing, in which nodes undergo synchronous, sub-threshold oscillations of excitability. The amount of input to these nodes then determines the timing of firing with respect to this oscillatory cycle. That is, each activated letter unit fires in a burst for about 15 ms (one gamma cycle), and bursting repeats every 200 ms (one theta cycle). Activated letter units burst slightly out of phase with each other, such that they fire in a rapid sequence. This firing rapid sequence encoding (seriality) is the key point of abstraction.

In the present SERIOL model, the retinotopic presentation is mapped onto a temporal representation (space is mapped onto time) to create an abstract, invariant representation that provides a location-invariant representation of letter order. This abstract serial encoding provides input to both the lexical and sub-lexical routes. It is assumed that the sub-lexical route parses and translates the sequence of letters into a grapho-phonological encoding (Whitney, C., & Cornelissen, P. (2005), Letter-position encoding and dyslexia, Journal of Research in Reading, 28, 274-301). The resulting representation encodes syllabic structure and records which graphemes generated which phonemes. The remaining layers of the model address processing that is specific to the lexical route.

At the open-bigram layer, corresponding to the left middle fusiform, letter units recognize pairs of letter units that fire in a particular order (Grainger, J., & Whitney, C. (2004), Does the huamn mnid raed wrods as a whole?, Trends in Cognitive Sciences, 8, 58-59). For example, open-bigram unit XY is activated when letter unit X fires before Y, where the letters x and y were not necessarily contiguous in the string. The activation of an open-bigram unit decreases with increasing time between the firing of the constituent letter units. Thus, the activation of open-bigram XY is highest when triggered by contiguous letters, and decreases as the number of intervening letters increases. Priming data indicates that the maximum separation is likely to be two letters (Schoonbaert, S., & Grainger, J. (2004), Letter position coding in printed word perception: Effects of repeated and transposed letters, Language and Cognitive Processes, 19, 333-367). Open-bigram activations depend only on the distance between the constituent letters (Whitney, C. (2004a), Investigations into the neural basis of structured representations, Doctoral Dissertation. University of Maryland).

Still, following the evidence for a special role for external letters, the string is anchored to those endpoints via edge open-bigrams; whereby edge units explicitly encode the first and last letters (Humphreys, G. W., Evett, L. J., & Quinlan, P. T. (1990), Orthographic processing in visual word identification, Cognitive Psychology, 22, 517-560). For example, the encoding of the stimulus CART would be *C (open-bigram *C is activated when letter C is preceded by a space), CA, AR, CR, RT, AT, CT, and T* (open-bigram *T is activated when letter T is followed by a space), where * represents an edge or space. In contrast to other open-bigrams inside the string, an edge open-bigram cannot become partially activated (e.g., by the second or next-to-last letter).

At the word layer, the open-bigram units attach via weighted connections. The input to a word unit is represented by the dot-product of its respective number of open-bigram unit activations and the weighted connections to those open-bigrams units. Stated another way, it is the dot-product of the open-bigram unit's activation vector and the connection of the open-bigrams unit's weight vector. Commonly in neural networks models, the normalization of vector connection weights is assumed such that open-bigrams making up shorter words have higher connections weights than open-bigrams making up longer words. For example, the connection weights from CA, AN, and CN to the word-unit CAN are larger than the connections weights to the word-unit CANON. Hence, the stimulus can/would activate CAN more than CANON.

### Visual Perceptual Patterns

The SERIOL model assumes that the feature layer is comprised of features that are specific to alphanumeric-string serial processing. A stimulus would activate both alphanumeric-specific and general features. Alphanumeric-specific features would be subject to the locational gradient, while general features would reflect acuity. Alphanumeric-specific-features that activate alphanumeric representations would show the effects of string-specific serial processing. In particular, there will be an advantage if the letter or number character is the initial or last character of a string. However, if the symbol is not a letter or a number character, the alphanumeric-specific features will not activate an alphanumeric representation and there will be no alphanumeric-specific effects. Rather, the symbol will be recognized via the general visual features, where the effect of acuity predominates. An initial or last symbol in the string will be at a disadvantage because its acuity is lower than the acuity for the internal symbols in the string.

Two studies have examined visual perceptual patterns for letters versus non-alphanumeric characters in strings of centrally presented stimuli, using a between-subjects design for the different stimulus types (Hammond, E. J., & Green, D. W. (1982), Detecting targets in letter and non-letter arrays, Canadian Journal of Psychology, 36, 67-82). Both studies found an external-character advantage for letters. Specifically, the first and last letter characters were processed more efficiently than the internal letters characters. Mason also showed an external-character advantage for number strings (Mason, M. (1982), Recognition time for letters and non-letters: Effects of serial position, array size, and processing order, Journal of Experimental Psychology: Human Perception and Performance, 8, 724-738). However, both studies found that the advantage was absent for non-alphanumeric characters. The first and last symbol in a string were processed the least well in line with their lower acuity.

Using fixated strings containing both letters and non-alphanumeric characters, Tydgat and Grainger showed that an initial letter character in a string had a visual recognition advantage while an initial symbol (non-alphanumeric character) in the string did not. Thus, symbols that do not normally occur in strings show a different visual perceptual pattern than alphanumeric characters (Tydgat, I., and Grainger, J. (2009), Serial position effects in the identification of letters, digits, and symbols, J. Exp. Psychol. Hum. Percept. Perform. 35, 480-498). As described in more detail by Whitney & Cornelissen, the SERIOL model explains these visual perceptual patterns (Whitney, C., & Cornelissen, P. (2005), Letter-position encoding and dyslexia, Journal of Research in Reading, 28, 274-301; Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., & Cornelissen, P. (2005), Letter-position encoding and dyslexia, Journal of Research in Reading, 28, 274-301).

The external letter character advantage arises as follows. An advantage for the initial letter character in a string comes from the directional inhibition at the (retinotopic) feature level, because the initial letter character is the only letter character that does not receive lateral inhibition. An advantage for the final letter character arises at the (abstract) letter layer level, because the firing of the last letter character in a string is not terminated by a subsequent letter character. This serial positioning processing is specific to alphanumeric strings, thus explaining the lack of external character visual perceptual advantage for non-alphanumeric characters.

### Letter Position Parallel Encoding: The Grainger & van Heuven Model

According to the Grainger and van Heuven model, parallel mapping of visual feature information at a specific location along the horizontal meridian with respect to eye fixation is mapped onto abstract letter representations that code for the presence of a given letter identity at that particular location (Grainger, J., & van Heuven, W. J. B. (2003), Modeling letter position coding in printed word perception, In P. Bonin (Ed.), Mental lexicon: “Some words to talk about words” (pp. 1-24). New York, N.Y.: Nova Science). In other words, this model proposes an “alphabetic array” retinotopic encoding consisting in a hypothesized bank of letter detectors that perform parallel, independent letter identification (any given letter has a separate representation for each retinal location). Grainger and van Heuven further proposed that these letters detectors are assumed to be invariant to the physical characteristics of letters and that these abstract letter representations are thought to be activated equally well by the same letter written in different case, in a different font, or a different size, but not invariant to position.

The next stage of processing, referred to as the “relative-position map”, is thought to code for the relative (within-stimulus) position of letters identities independently of their shape and their size, and independently of the location of the stimulus word (location invariance). This location-specific coding of letter identities is then transformed into a location invariant pre-lexical orthographic code (the relative-position map) before matching this information with whole-word orthographic representations in long-term memory. In essence, the relative-position map abstracts away from absolute letter position and focuses instead on relationships between letters. Therefore, in this model, the retinotopic alphabetic array is converted in parallel into an abstract open-bigram encoding that brings into play implicit relationships between letters. Specifically, this is achieved by open-bigram units that receive activation from the alphabetic array such that a given letter order D-E that is realized at any possible combinations of location in the retinotopic alphabetic array, activates the corresponding abstract open bigram for that sequence. Still, abstract open bigrams are activated by letter pairs that have up to two intervening letters. The abstract open-bigrams units then connect to word units. A key distinguishing virtue of this specific approach to letter position encoding rests on the assumption/claim that flexible orthographic coding is achieved by coding for ordered combinations of contiguous and non-contiguous letters pairs.

### Relationships Between Letters in a String—Coding Non-Contiguous Letter Combinations

Currently, there is a general consensus that the literate brain executes some form of word-centered, location-independent, orthographic coding such that letter identities are abstractly coded for their position in the word independent of their position on the retina (at least for words that require a single fixation for processing). This consensus also holds true for within-word position coding of letters identities to be flexible and approximate. In other words, letter identities are not rigidly allocated to a specific position. The corroboration for such flexibility and approximate orthographic encoding has been mainly classically obtained by utilizing the masked priming paradigm: for a given number of letters shared by the prime and target, priming effects are not affected by small changes of letter order (flexible and approximate letter position encoding)—transposed letter (TL) priming (Perea, M., and Lupker, S. J. (2004), Can CANISO activate CASINO? Transposed-letter similarity effects with nonadjacent letter positions, J. Mem. Lang. 51, 231-246; and Schoonbaert, S., and Grainger, J. (2004), Letter position coding in printed word perception: effects of repeated and transposed letters, Lang. Cogn. Process. 19, 333-367), and length-dependent letter position—relative-position priming (Peressotti, F., and Grainger, J. (1999), The role of letter identity and letter position in orthographic priming, Percept. Psychophys. 61, 691-706; and Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884).

Yet, the claim for a flexible and approximate orthographic encoding has extended to be also achieved by coding for letter combinations (Whitney, C., and Berndt, R. S. (1999), A new model of letter string encoding: simulating right neglect dyslexia, in Progress in Brain Research, eds J. A. Reggia, E. Ruppin, and D. Glanzman (Amsterdam: Elsevier), 143-163; Whitney, C. (2001), How the brain encodes the order of letters in a printed word: the SERIOL model and selective literature review, Psychon. Bull. Rev. 8, 221-243; Grainger, J., and van Heuven, W. J. B. (2003), Modeling letter position coding in printed word perception, in The Mental Lexicon, ed. P. Bonin (New York: Nova Science Publishers), 1-23; Dehaene, S., Cohen, L., Sigman, M., and Vinckier, F. (2005), The neural code for written words: a proposal, Trends Cogn. Sci. (Regul. Ed.) 9, 335-341). Letter combinations are classically and exclusively demonstrated by the use of contiguous letter combinations in n-gram coding and in particular by the use of non-contiguous letter combinations in n-gram coding. Dehaene has proposed that the coding of non-contiguous letter combinations arises as an artifact because of noisy erratic position retinotopic coding in location-specific letters detectors (Dehaene, S., Cohen, L., Sigman, M., and Vinckier, F. (2005), The neural code for written words: a proposal, Trends Cogn. Sci. (Regul. Ed.) 9, 335-341). In this scheme, the additional flexibility in orthographic encoding arises by accident, but the resulting flexibility is utilized to capture key data patterns.

In contrast, Dandurant has taken a different perspective, proposing that the coding of non-contiguous letter combinations is deliberate, and not the result of inaccurate location-specific letter coding (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In other words, non-contiguous letter combinations are coded because they are beneficial with respect to the overall goal of mapping letters onto meaning, not because the system is intrinsically noisy and therefore imprecise to determine the exact location of letters in a string. Dandurant et al., have examined two kinds of constrains that a reader should take into consideration when optimally processing orthographic information: 1) variations in letter visibility across the different letters of a word during a single fixation and 2) varying amount of information carried by the different letters in the word (e.g., consonants versus vowels letters). More specifically, they have hypothesized that this orthographic processing optimization would involve coding of non-contiguous letters combinations.

The reason for optimal processing of non-contiguous letter combinations can be explained on the following basis: 1) when selecting an ordered subset of letters which are critical to the identification of a word (e.g., the word “fatigue” can be uniquely identified by ordered letters substrings “ftge” and “atge” which result from dropping non-essential letters that bear little information), about half of the letters in the resulting subset are non-contiguous letters; and 2) the most informative pair of letters in a word is a non-contiguous pair of letters combination in 83% of 5-7 letter words (having no letter repetition) in English, and 78% in French and Spanish (the number of words included in the test set were 5838 in French, 8412 in English, and 4750 in Spanish) (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In summary, they concluded that an optimal and rational agent learning to read corpuses of real words should deliberately code for non-contiguous pair of letters (open-bigrams) based on informational content and given letters visibility constrains (e.g., initial, middle and last letters in an string of letters are more visually perceptually visible).

### Different Serial Position Effects in the Identification of Letters, Digits, and Symbols

In languages that use alphabetical orthographies, the very first stage of the reading process involves mapping visual features onto representations of the component letters of the currently fixated word (Grainger, J., Tydgat, I., and Isselé, J. (2010), Crowding affects letters and symbols differently, J. Exp. Psychol. Hum. Percept. Perform. 36, 673-688). Comparison of serial position functions using the target search task for letter stimuli versus symbol stimuli or simple shapes showed that search times for a target letter in a string of letters are represented by an approximate M-shape serial position function, where the shortest reaction times (RTs) were recorded for the first, third and fifth positions of a five-letter string (Estes, W. K., Allmeyer, D. H., & Reder, S. M. (1976), Serial position functions for letter identification at brief and extended exposure durations, Perception & Psychophysics, 19, 1-15). In contrast, a 5-symbol string (e.g., $, %, &) and shape stimuli shows a U-shape function with shortest RTs for targets at the central position on fixation that increase as a function of eccentricity (Hammond, E. J., & Green, D. W. (1982), Detecting targets in letter and non-letter arrays, Canadian Journal of Psychology, 36, 67-82).

A definitive interpretation of the different effect serial position has on letters and symbols is that it reflects the combination of two factors: 1) the drop of acuity from fixation to the periphery, and 2) less crowding on the first and last letter of the string because these letters are flanked by only one other letter (Bouma, H. (1973), Visual interference in the parafoveal recognition of initial and final letters of word, Vision Research, 13, 762-82). Specifically expanding on the second factor, Tydgat and Grainger proposed that crowding effects may be more limited in spatial extent for letter and number stimuli compared with symbol stimuli, such that a single flanking stimulus would suffice to generate almost maximum interference for symbols, but not for letters and numbers (Tydgat, I., and Grainger, J. (2009), Serial position effects in the identification of letters, digits, and symbols, J. Exp. Psychol. Hum. Percept. Perform. 35, 480-498). According to the Tydgat and Grainger interpretation of the different serial position functions for letters and symbols, one should be able to observe differential crowding effects for letters and symbols in terms of a superior performance at the first and last positions for letter stimuli but not for symbols or shapes stimuli. In a number of experiments they tested the hypothesis that a reduction in size of integration fields at the retinotopic layer, specific to stimuli that typically appear in strings (letters and digits), results in less crowding for such stimuli compared with other types of visual stimuli such as symbols and geometric shapes. In other words, the larger the integration field involved in identifying a given target at a given location, the greater the number of features from neighboring stimuli that can interfere in target identification. Stated another way, letter and digit stimuli benefit from a greater release from crowding effects (flanking letters or digits) at the outer positions than do symbol and geometric shape stimuli.

Still, critical spacing was found to be smaller for letters than for other symbols, with letter targets being identified more accurately than symbol targets at the lowest levels of inter-character spacing (manipulation of target-flankers spacing showed that symbols required a greater degree of separation [larger critical spacing] than letters in order to reach a criterion level of identification) (See experiment 5, Grainger, J., Tydgat, I., and Issele, J. (2010), Crowding affects letters and symbols differently, J. Exp. Psychol. Hum. Percept. Perform. 36, 673-688). Most importantly, differential serial position crowding effects are of great importance given the fact that performance in the Two-Alternative Forced-Choice Procedure of isolated symbols and letters was very similar (Grainger, J., Tydgat, I., and Issele, J. (2010), Crowding affects letters and symbols differently, J. Exp. Psychol. Hum. Percept. Perform. 36, 673-688).

Concerning the potential mechanism of crowding effects, Grainger et al. proposed bottom-up mechanisms whose operation can vary as a function of stimulus type via off-line as opposed to on-line influences. These off-line influences of stimulus type involved differences in perceptual learning driven by differential exposure to the different types of stimuli. Further, they proposed that when children learn to read, a specialized system develops in the visual cortex to optimize processing in the extremely crowded conditions that arise with printed words and numeric strings (e.g., in a two-stage retinotopic processing model: in the first-stage there is a detection of simple features in receptive fields of V1-0.1 ø and in a second-stage there is integration/interpretation in receptive fields of V4-0.5 ø [neurons in V4 are modulated by attention]) (See Levi, D. M., (2008), Crowding—An essential bottleneck for object recognition: A mini-review, Vision Research, 48, 635-654).

The central tenant here is that receptive field size of retinotopic letter and digit detectors has adapted to the need to optimize processing of strings of letters and digits and that the smaller the receptive field size of these detectors, the less interference there is from neighboring characters. One way to attain such processing optimization is being explained as a reduction in the size and shape of “integration fields.” The “integration field” is equivalent to a second-stage receptive field that combines the features by the earlier stage into an (object) alphanumeric character associated with location-specific letter detectors, “the alphabetic array”, that perform parallel letter identification compared with other visual objects that do not typically occur in such a cluttered environment (Dehaene, S., Cohen, L., Sigman, M., and Vinckier, F. (2005), The neural code for written words: a proposal, Trends Cogn. Sci. (Regul. Ed.) 9, 335-341; Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884; and Grainger, J., and van Heuven, W. J. B. (2003), Modeling letter position coding in printed word perception, in The Mental Lexicon, ed. P. Bonin (New York: Nova Science Publishers), 1-23).

Ktori, Grainger, Dufau provided further evidence on differential effects between letters and symbols stimuli (Maria Ktori, Jonathan Grainger & Stéphane Dufau (2012), Letter string processing and visual short-term memory, The Quarterly Journal of Experimental Psychology, 65:3, 465-473). They study how expertise affects visual short-term memory (VSTM) item storage capacity and item encoding accuracy. VSTM is recognized as an important component of perceptual and cognitive processing in tasks that rest on visual input (Prime, D., & Jolicoeur, P. (2010), Mental rotation requires visual short-term memory: Evidence from human electric cortical activity, Journal of Cognitive Neuroscience, 22, 2437-2446). Specifically, Prime and Jolicoeur investigated whether the spatial layout of letters making up a string affects the accuracy with which a group of proficient adult readers performed a change-detection task (Luck, S. J. (2008), Visual short-term memory, In S. J. Luck & A. Hollingworth (Eds.), Visual memory (pp. 43-85). New York, N.Y.: Oxford University Press), item arrays that varied in terms of character type (letters or symbols), number of items (3, 5, and 7), and type of display (horizontal, vertical and circular) are used. Study results revealed an effect of stimulus familiarity significantly noticeable in more accurate change-detection responses for letters than for symbols. In line with the hypothesized experimental goals in the study, they found evidence that supports that highly familiar items, such as arrays of letters, are more accurately encoded in VSTM than unfamiliar items, such as arrays of symbols. More so, their study results provided additional evidence that expertise is a key factor influencing the accuracy with which representations are stored in VSTM. This was revealed by the selective advantage shown for letter over symbol stimuli when presented in horizontal compared to vertical or circular displays formats. The observed selective advantage of letters over symbols can be the result of years of reading that leads to expertise in processing horizontally aligned strings of letters so as to form word units in alphabetic languages such as English, French and Spanish.

In summary, the study findings support the argument that letter string processing is significantly influenced by the spatial layout of letters in strings in perfect agreement with other studies findings conducted by Grainger & van Heuven (Grainger, J., & van Heuven, W. J. B. (2003), Modeling letter position coding in printed word perception, In P. Bonin (Ed,), Mental lexicon: “Some words to talk about words”. New York, N.Y.: Nova Science Publishers and Tydgat, L, & Grainger, J. (2009), Serial position effects in the identification of letters, digits and symbols, Journal of Experimental Psychology: Human Perception and Performance, 480-498).

Open Proto-Bigrams Embedded within Words (Subset Words) and as Standalone Connecting Word in-Between Words

A number of computational models have postulated open-bigrams as best means to substantiate a flexible orthographic encoding capable of explaining TL and RP priming effects. In the Grainger & van Heuven model the retinotopic alphabetic array is converted in parallel into an abstract open-bigram encoding that brings into play implicit relationships between letters (e.g., contiguous and non-contiguous) (Grainger, J., & van Heaven, W. J. B. (2003), Modeling letter position coding in printed word perception, In P. Bonin (Ed.), Mental lexicon: “Some words to talk about words”. New York, N.Y.: Nova Science Publishers). In the SERIOL model retinotopic visual stimuli presentation is mapped onto a temporal one where letter units recognize pairs of letter units (an open-bigram) that fire in a particular serial order; namely, space is mapped onto time to create an abstract invariant representation providing a location-invariant representation of letter order in a string (Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., and Cornelis sen, P. (2005), Letter-position encoding and dyslexia, J. Res. Read. 28, 274-301). In these models, open-bigrams represent an abstract intermediary layer between letters and word units.

A key distinguishing virtue of this specific approach to letter position encoding rests on that flexible orthographic coding is achieved by coding for ordered combinations of contiguous and non-contiguous letters pairs, namely open-bigrams. For example, in the English language there are 676 pairs of letters combinations or open-bigrams (see Table 1 below). In addition to studies that have shown open-bigrams information processing differences between pair of letters entailing CC, VV, VC or CV, we introduce herein an additional open-bigrams novel property that should be interpreted as causing an automatic direct cascaded spread activation effect from orthography to semantics. Specifically, an open-bigram of the form VC or CV that is also a word carrying a semantic meaning such as for example: AM, AN, AS, AT, BE, BY, DO, GO, HE, IF, IN, IS, IT, ME, MY, NO, OF, ON, OR, SO, TO, UP, US, WE, is herein dubbed “open proto-bigram”. Still, these 24 open proto-bigrams that are also words represent 3.55% of all open-bigrams obtained from the English Language alphabet (see Table 1 below). Open proto-bigrams that are a subset word e.g., “BE” embedded in a word e.g., “BELOW” or are a subset word “HE” embedded in a superset word e.g., “SHE” or “THE” would not only indicate that the orthographic or phonological forms of the subset open proto-bigram word “HE” in the superset word “SHE” or “THE” or the subset open proto-bigram word “BE” in the word “BELOW” were activated in parallel, but also that these co-activated word forms triggered automatically and directly their corresponding semantic representations during the course of identifying the orthographic form of the word.

Based on the herein presented literature and novel teachings of the present subject matter, it is further assumed that this automatic bottom-up-top-down orthographic parallel-serial informational processing handshake, manifests in a direct cascade effect providing a number of advantages, thus facilitating the following perceptual-cognitive process: 1) fast lexical-sub-lexical recognition, 2) maximal chunking (data compression) of number of items in VSTM, 3) fast processing, 4) solid consolidation encoding in short-term memory (STM) and long-term memory (LTM), 5) fast semantic track for extraction/retrieval of word literal meaning, 6) less attentional cognitive taxing, 7) most effective activation of neighboring word forms, including multi-letter graphemes (e.g., th, ch) and morphemes (e.g., ing, er), 8) direct fast word recall that strongly inhibits competing or non-congruent distracting word forms; and 9) for a proficient reader, when open proto-bigrams are a standalone connecting a word unit in between words in a sentence, there is no need for (open proto-bigram) orthographic lexical pattern recognition and retrieval of their corresponding semantic literal information due to their super-efficient maximal chunking (data compression) and robust consolidation in STM-LTM. Namely, standalone open proto-bigrams connecting words in between words in sentences are automatically known implicitly. Thus, a proficient reader may also not consciously and explicitly pay attention to them and will therefore remain minimally aroused to their visual appearance.

TABLE 1
Open-Bigrams of the English Language

| | | | | | | | | | | | | | | | | | | | | | | | | | |
|---|---|---|---|---|---|---|---|---|---|---|---|---|---|---|---|---|---|---|---|---|---|---|---|---|---|
| aa | ab | ac | ad | ae | af | ag | ah | ai | aj | ak | al | am | an | ao | ap | aq | ar | as | at | au | av | aw | ax | ay | az |
| ba | bb | bc | bd | [symbol] | bf | bg | bh | bi | bj | bk | bl | bm | bn | bo | bp | bq | br | bs | bt | bu | bv | bw | bx | by | bz |
| ca | cb | cc | cd | ce | cf | cg | ch | ci | cj | ck | cl | cm | cn | co | cp | cq | cr | cs | ct | cu | cv | cw | cx | cy | cz |
| da | db | dc | dd | de | df | dg | dh | di | dj | dk | dl | dm | dn | do | dp | dq | dr | ds | dt | du | dv | dw | dx | dy | dz |
| ea | eb | ec | ed | ee | ef | eg | eh | ei | ej | jk | el | em | en | eo | ep | eq | er | es | et | eu | ev | ew | ex | ey | ez |
| fa | fb | fc | fd | fe | ff | fg | fh | fi | fj | fk | fl | fm | fn | fo | fp | fq | fr | fs | ft | fu | fv | fw | fx | fy | fz |
| ga | gb | gc | gd | ge | gf | gg | gh | gi | gj | gk | gl | gm | gn | go | gp | gq | gr | gs | gt | gu | gv | gw | gx | gy | gz |
| ha | hb | hc | hd | he | hf | hg | hh | hi | hj | hk | hl | hm | hn | no | hp | hq | hr | hs | ht | hu | hv | hw | hx | hy | hz |
| ia | ib | ic | id | ie | if | ig | ih | ii | ij | ik | il | im | in | io | ip | iq | ir | is | it | iu | iv | iw | ix | iy | iz |
| ja | jb | jc | jd | je | jf | jg | ih | ji | jj | jk | jl | jm | jn | jo | jp | jq | jr | js | jt | ju | jv | jw | jx | jy | jz |
| ka | kb | kc | kd | ke | kf | kg | kh | ki | kj | kk | kl | km | kn | ko | kp | kq | kr | ks | kt | ku | kv | kw | kx | ky | kz |
| la | lb | lc | ld | le | lf | lg | lh | li | lj | lk | ll | lm | ln | lo | lp | lq | lr | ls | lt | lu | lv | lw | lx | ly | lz |
| ma | bb | mc | md | me | mf | mg | mh | mi | mj | mk | ml | mm | mn | mo | mp | mq | mr | ms | mt | mu | mv | mw | mx | my | mz |
| na | nb | nc | nd | ne | nf | ng | nh | ni | nj | nk | nl | nm | nn | no | np | nq | nr | ns | nt | nu | ny | nw | nx | ny | nz |
| oa | ob | oc | od | oe | of | og | oh | oi | oj | ok | ol | om | on | oo | op | oq | or | os | ot | ou | ov | ow | ox | oy | oz |
| pa | pb | pc | pd | pe | pf | pg | ph | pi | pj | pk | pl | pm | pn | po | pp | pq | pr | ps | pt | pu | pv | pw | px | py | pz |
| qa | qb | qc | qd | qe | qf | qg | qh | qi | qj | qk | ql | qm | qn | qo | qp | qq | qr | qs | qt | qu | qv | qw | qx | qy | qz |
| ra | rb | rc | rd | re | rf | rg | rh | ri | rj | rk | rl | rm | rn | ro | rp | rq | rr | rs | rt | ru | rv | rw | rx | ry | rz |
| sa | sb | sc | sd | se | sf | sg | sh | si | sj | sk | sl | sm | sn | so | sp | sq | sr | ss | st | su | sv | sw | sx | sy | sz |
| ta | tb | tc | td | te | tf | tg | th | ti | tj | tk | tl | tm | tn | to | tp | tq | tr | ts | tt | tu | tv | tw | tx | ty | tz |
| ua | ub | uc | ud | ue | uf | ug | uh | ui | uj | uk | ul | um | un | uo | up | uq | ur | us | ut | uu | uv | uw | ux | uy | uz |
| va | vb | vc | vd | ve | vf | vg | vh | vi | vj | vk | vl | vm | vn | vo | vp | vq | vr | vs | vt | vu | vv | vw | vx | vy | vz |
| wa | wb | wc | wd | we | wf | wg | wh | wi | wj | wk | wl | wm | wn | wo | wp | wq | wr | ws | wt | wu | wv | ww | wx | wy | wz |
| xa | xb | xc | xd | xe | xf | xg | xh | xi | xj | xk | xl | xm | xn | xo | xp | xq | xr | xs | xt | xu | xv | xw | xx | xy | xz |
| ya | yb | yc | yd | ye | yf | yg | yh | yi | yj | yk | yl | ym | yn | yo | yp | yq | yr | ys | yt | yu | yv | yw | yx | yy | yz |
| za | zb | zc | zd | ze | zf | zg | zh | zi | zj | zk | zl | zm | zn | zo | zp | zq | zr | zs | zt | zu | zv | zw | zx | zy | zz |

[symbol]

indicates data missing or illegible when filed

### Open Proto-Bigrams Words as Standalone Function Words in Between Words in Alphabetic Languages

Open-bigrams that are words (herein termed “open proto-bigrams), as for example: AM, AN, AS, AT, BE, BY, DO, GO, HE, IF, IN, IS, IT, ME, MY, NO, OF, ON, OR, SO, TO, UP, US, WE, belong to a linguistic class named ‘function words’. Function words either have reduced lexical or ambiguous meaning. They signal the structural grammatical relationship that words have to one another and are the glue that holds sentences together. Function words also specify the attitude or mood of the speaker. They are resistant to change and are always relatively few (in comparison to ‘content words’). Accordingly, open proto-bigrams (and other n-grams e.g. “THE”) words may belong to one or more of the following function words classes: articles, pronouns, adpositions, conjunctions, auxiliary verbs, interjections, particles, expletives and pro-sentences. Still, open proto-bigrams that are function words are traditionally categorized across alphabetic languages as belonging to a class named ‘common words’. In the English language, there are about 350 common words which stand for about 65-75% of the words used when speaking, reading and writing. These 350 common words satisfy the following criteria: 1) they are the most frequent/basic words of an alphabetic language; 2) they are the shortest words—up to 7 letters per word; and 3) they cannot be perceptually identified (access to their semantic meaning) by the way they sound; they must be recognized visually, and therefore are also named ‘sight words’.

Frequency Effects in Alphabetical Languages for: 1) Open Bigrams and 2) Open Proto-Bigrams Function Words as: A) Standalone Function Words in Between Words and b) as Subset Function Words Embedded within Words

Fifty to 75% of the words displayed on a page or articulated in a conversation are frequent repetitions of most common words. Just 100 different most common words in the English language (see Table 2 below) account for a remarkable 50% of any written text. Further, it is noteworthy that 22 of the above-mentioned open proto-bigrams function words are also most common words that appear within the 100 most common words, meaning that on average one in any two spoken or written words would be one of these 100 most common words. Similarly, the 350 most common words account for 65% to 75% of everything written or spoken, and 90% of any average written text or conversation will only need a vocabulary of common 7,000 words from the existing 1,000,000 words in the English language.

TABLE 2
Most Frequently Used Words Oxford Dictionary 11^{Th} Edition

| | |
|---|---|
| 1. | the |
| 2. | be |
| 3. | to |
| 4. | of |
| 5. | and |
| 6. | a |
| 7. | in |
| 8. | that |
| 9. | have |
| 10. | I |
| 11. | it |
| 12. | for |
| 13. | not |
| 14. | on |
| 15. | with |
| 16. | he |
| 17. | as |
| 18. | you |
| 19. | do |
| 20. | at |
| 21. | this |
| 22. | but |
| 23. | his |
| 24. | by |
| 25. | from |
| 26. | they |
| 27. | we |
| 28. | say |
| 29. | her |
| 30. | she |
| 31. | or |
| 32. | an |
| 33. | will |
| 34. | my |
| 35. | one |
| 36. | all |
| 37. | would |
| 38. | there |
| 39. | their |
| 40. | what |
| 41. | so |
| 42. | up |
| 43. | out |
| 44. | if |
| 45. | about |
| 46. | who |
| 47. | get |
| 48. | which |
| 49. | go |
| 50. | me |
| 51. | when |
| 52. | make |
| 53. | can |
| 54. | like |
| 55. | time |
| 56. | no |
| 57. | just |
| 58. | him |
| 59. | know |
| 60. | take |
| 61. | person |
| 62. | into |
| 63. | year |
| 64. | your |
| 65. | good |
| 66. | some |
| 67. | could |
| 68. | them |
| 69. | see |
| 70. | other |
| 71. | than |
| 72. | then |
| 73. | now |
| 74. | look |
| 75. | only |
| 76. | come |
| 77. | its |
| 78. | over |
| 79. | think |
| 80. | also |
| 81. | back |
| 82. | after |
| 83. | use |
| 84. | two |
| 85. | how |
| 86. | our |
| 87. | work |
| 88. | first |
| 89. | well |
| 90. | way |
| 91. | even |
| 92. | new |
| 93. | want |
| 94. | because |
| 95. | any |
| 96. | these |
| 97. | give |
| 98. | day |
| 99. | most |
| 100. | us |

Most Frequently Used Words Oxford Dictionary 11^{th} Edition

Still, it is noteworthy that a large number of these 350 most common words entail 1 or 2 open pro-bigrams function words as embedded subset words within the most common word unit (see Table 3 below).

TABLE 3
Common Service and Nouns Words List
By: Edward William Dolch - Problems in Reading 1948
Dolch Word List Sorted Alphabetically by Grade with Nouns

| Pre-primer | Primer | First | Second | Third | Nouns | Nouns |
|---|---|---|---|---|---|---|
| a | all | after | always | about | apple | home |
| and | am | again | around | better | baby | horse |
| away | are | an | because | bring | back | house |
| big | at | any | been | carry | ball | kitty |
| blue | ate | as | before | clean | bear | leg |
| can | be | ask | best | cut | bed | letter |
| come | black | by | both | done | bell | man |
| down | brown | could | buy | draw | bird | men |
| find | but | every | call | drink | birthday | milk |
| for | came | fly | cold | eight | boat | money |
| funny | did | from | does | fall | box | morning |
| go | do | give | don't | far | boy | mother |
| help | eat | going | fast | full | bread | name |
| here | four | had | first | got | brother | nest |
| I | get | has | five | grow | cake | night |
| in | good | her | found | hold | car | paper |
| is | have | him | gave | hot | cat | party |
| it | he | his | goes | hurt | chair | picture |
| jump | into | how | green | if | chicken | pig |
| little | like | just | its | keep | children | rabbit |
| look | must | know | made | kind | Christmas | rain |

The teachings of the present subject matter are in perfect agreement with the fact that the brain's anatomical architecture constrains its perceptual-cognitive functional abilities and that some of these abilities become non-stable, decaying or atrophying with age. Indeed, slow processing speed, limited memory storage capacity, lack of sensory-motor inhibition and short attentional span and/or inattention, to mention a few, impose degrees of constrains upon the ability to visually, phonologically and sensory-motor implicitly pick-up, explicitly learn and execute the orthographic code. However, there are a number of mechanisms at play that develop in order to impose a number of constrains to compensate for limited motor-perceptual-cognitive resources. As previously mentioned, written words are visual objects before attaining the status of linguistic objects as has been proposed by McCandliss, Cohen, & Dehaene (McCandliss, B., Cohen, L., & Dehaene, S. (2003), The visual word form area: Expertise for reading in the fusiform gyrus, Trends in Cognitive Sciences, 13, 293-299) and there is pre-emption of visual object processing mechanisms during the process of learning to read (See also Dehaene et al., Local Combination Detector (LCD) model, Dehaene, S., Cohen, L., Sigman, M., and Vinckier, F. (2005), The neural code for written words: a proposal, Trends Cogn. Sci. (Regul. Ed.) 9, 335-341). In line with the latter, Grainger and van Heuven's alphabetic array is one such mechanism, described as a specialized system developed specifically for the processing of strings of alphanumeric stimuli (Grainger, J., & van Heuven, W. J. B, (2003), Modeling letter position coding in primed word perception, In P. Bonin (Ed.), Mental lexicon: “Some words to talk about words”. New York, N.Y.: Nova Science Publishers).

Another such mechanism at work is the high lexical-phonological information redundancies conveyed in speech and also found in the lexical components of an alphabetic language orthographic code. For example, relationships among letter combinations within a string and in between strings reflect strong letter combinations redundancies. Thus, the component units of the orthographic code implement frequent repetitions of some open bigrams in general and of all open proto-bigrams (that are words) in particular. In general, lexical and phonological redundancies in speech production and lexical redundancies in writing as reflected in frequent repetitions of some open bigrams and all open proto-bigrams within a string (a word) and among strings (words) in sentences reduces content errors in sender production of written-spoken messages making the spoken phonological-lexical message or orthographic code message resistant to noise or irrelevant contextual production substitutions, thereby increasing the interpretational semantic probability to comprehending the received message in its optimal context by the receiver.

Despite the above-mentioned brain anatomical constrains on function and related limited motor-perceptual-cognitive resources and how these constrains impact the handling of orthographic information, the co-occurrence of some open-bigrams and all open proto-bigrams in alphabetic languages renders alongside other developed compensatory specialized mechanisms at work (e.g. alphabetic array) an offset strategy that implements age-related, fast, coarse-lexical pattern recognition, maximal chunking (data compression) and optimal manipulation of alphanumeric-items in working memory-short-term memory (WM-STM), direct and fast access from lexical to semantics, robust semantic word encoding in STM-LTM and fast (non-aware) semantic word retrieval from LTM. On the other hand, the low co-occurrence of some open-bigrams in a word represent rare (low probability) letter combination events, and therefore are more informative concerning the specific word identity than frequent (predictable) occurring open-bigrams letter combination events in a word (Shannon, C. E. (1948), A mathematical theory of communication, Bell Syst. Tech. J. 27, 379-423). In brief, the low co-occurrence of some open-bigrams conveys most information that determines word identity (diagnostic feature).

Grainger and Ziegler explained that both types of constraints are driven by the frequency with which different combinations of letters occur in printed words. On one hand, frequency of occurrence determines the probability with which a given combination of letters belongs to the word being read. Letter combinations that are encountered less often in other words are more diagnostic (an informational feature that renders ‘word identity’) than the identity of the word being processed. In the extreme, a combination of letters that only occurs in a single word in the language, and is therefore a rarely occurring combination of letters event when considering the language as a whole, is highly informative with respect to word identity. On the other hand, the co-occurrence (high frequency of occurrence) enables the formation of higher-order representations (maximal chunking) in order to diminish the amount of information that is processed via data compression. Letter combinations (e.g., open-bigrams and trigrams) that often occur together can be usefully grouped to form higher-level orthographic representations such as multi-letter graphemes (th, ch) and morphemes (ing, er), thus providing a link with pre-existing phonological and morphological representations during reading acquisition (Grainger, J., & Ziegler, J. C. (2011), A dual-route approach to orthographic processing, Frontiers in Psychology, 2(54), 1-13).

The teachings of the present invention claim that open proto-bigram words are a special class/kind of coarse-grained orthographic code that computes (at the same time/in parallel) occurrences of contiguous and non-contiguous letters combinations (conditional probabilities of one or more subsets of open proto-bigram word(s)) within words and in between words (standalone open proto-bigram word) in order to rapidly hone in on a unique informational word identity alongside the corresponding semantic related representations, namely the fast lexical track to semantics (and correlated mental sensory-motor representation-simulation that grounds the specific semantic (word) meaning to the appropriate action).

### Aging and Language

Early research on cognitive aging has pointed out that language processing was spared in old age, in contradistinction to the decline in “fluid” (e.g. reasoning) intellectual abilities, such as remembering new information and in (sensory-motor) retrieving orthographic-phonologic knowledge (Botwinick, J. (1984), Aging and Behavior. New York: Springer). Still, research in this field strongly supports a general asymmetry in the effects of aging on language perception-comprehension versus production (input versus output processes). Older adults exhibit clear deficits in retrieval of phonological and lexical information from speech alongside retrieval of orthographic information from written language, with no corresponding deficits in language perception and comprehension, independent of sensory and new learning deficits. The input side of language includes visual perception of the letters and corresponding speech sounds that make up words and retrieval of semantic and syntactic information about words and sentences. These input-side language processes are commonly referred to as “language comprehension,” and they remain remarkably stable in old age, independent of age-linked declines in sensory abilities (Madden, D. J. (1988), Adult age differences in the effects of sentence context and stimulus degradation during visual word recognition, Psychology and Aging, 3, 167-172) and memory for new information (Light, L., & Burke, D. (1988), Patterns of language and memory in old age, In L. Light, & D. Burke, (Eds.), Language, memory and aging (pp. 244-271). New York: Cambridge University Press; Kemper, S. (1992b), Language and aging, In F. I. M. Craik & T. A. Salthouse (Eds.) The handbook of aging and cognition (pp. 213-270). Hillsdale, N.J.: Lawrence Erlbaum Associates; and Tun, P. A., & Wingfield, A. (1993), Is speech special? Perception and recall of spoken language in complex environments, In J. Cerella, W. Hoyer, J. Rybash, & M. L. Commons (Eds.) Adult information processing: Limits on loss (pp. 425-457) San Diego: Academic Press).

Tasks highlighting language comprehension processes, such as general knowledge and vocabulary scores in tests such as the Wechsler Adult Intelligence Scale, remain stable or improve with aging and provided much of the data for earlier conclusions about age constancy in language perception-comprehension processes. (Botwinick, J. (1984), Aging and Behavior, New York: Springer; Kramer, N. A., & Jarvik, L. F. (1979), Assessment of intellectual changes in the elderly, In A. Raskin & L. F. Jarvik (Eds.), Psychiatric symptoms and cognitive loss in the elderly (pp. 221-271). Washington, D.C.: Hemisphere Publishing; and Verhaeghen, P. (2003), Aging and vocabulary scores: A meta-analysis, Psychology and Aging, 18, 332-339). The output side of language involves retrieval of lexical and phonological information during everyday language production and retrieval of orthographic information such as unit components of words, during every day sensory-motor writing and typing activities. These output-side language processes, commonly termed “language production,” do exhibit age-related dramatic performance declines.

Aging has little effect on the representation of semantic knowledge as revealed, for example, by word associations (Burke, D., & Peters, L. (1986), Word associations in old age: Evidence for consistency in semantic encoding during adulthood, Psychology and Aging, 4, 283-292), script generation (Light, L. L., & Anderson, P. A. (1983), Memory for scripts in young and older adults, Memory and Cognition, 11, 435-444), and the structure of taxonomic categories (Howard, D. V. (1980), Category norms: A comparison of the Battig and Montague (1960) norms with the responses of adults between the ages of 20 and 80, Journal of Gerontology, 35, 225-231; and Mueller, J. H., Kausler, D. H., Faherty, A., & Oliveri, M. (1980), Reaction time as a function of age, anxiety, and typicality, Bulletin of the Psychonomic Society, 16, 473-476). Because comprehension involves mapping language onto existing knowledge structures, age constancy in the nature of these structures is important for maintaining language comprehension in old age. There is no age decrement in semantic processes in comprehension for both off-line and online measures of word comprehension in sentences (Speranza, F., Daneman, M., & Schneider, B. A. (2000) How aging affects reading of words in noisy backgrounds, Psychology and Aging, 15, 253-258). For example, the comprehension of isolated words in the semantic priming paradigm, particularly, the reduction in the time required to identify a target word (TEACHER) when it follows a semantically related word, (STUDENT) rather than a semantically unrelated word (GARDEN); here, perception of STUDENT primes semantically related information, automatically speeding recognition of TEACHER; and such semantic priming effects are at least as large in older adults as they are in young adults (Balota, D. A, Black, S., & Cheney, M. (1992), Automatic and attentional priming in young and older adults: Reevaluation of the two process model, Journal of Experimental Psychology: Human Perception and Performance, 18, 489-502; Burke, D., White, H., & Diaz, D. (1987), Semantic priming in young and older adults: Evidence for age-constancy in automatic and attentional processes, Journal of Experimental Psychology: Human Perception and Performance, 13, 79-88; Myerson, J. Ferraro, F. R., Hale, S., & Lima, S. D. (1992), General slowing in semantic priming and word recognition, Psychology and Aging, 7, 257-270; and Laver, G. D., & Burke, D. M. (1993), Why do semantic priming effects increase in old age? A meta-analysis, Psychology and Aging, 8, 34-43). Similarly, sentence context also primes comprehension of word meanings to an equivalent extent for young and older adults (Burke, D. M., & Yee, P. L. (1984), Semantic priming during sentence processing by young and older adults, Developmental Psychology, 20, 903-910; and Stine, E. A. L., & Wingfield, A. (1994), Older adults can inhibit high-probability competitors in speech recognition, Aging and Cognition, 1, 152-157).

By contrast to the age constancy in comprehending semantic word meaning, extensive experimental research shows age-related declines in retrieving a name (less accurate and slower) corresponding to definitions, pictures or actions (Au, R., Joung, P., Nicholas, M., Obler, L. K., Kass, R. & Albert, M. L. (1995), Naming ability across the adult life span, Aging and Cognition, 2, 300-311; Bowles, N. L., & Poon, L. W. (1985), Aging and retrieval of words in semantic memory, Journal of Gerontology, 40, 71-77; Nicholas, M., Obler, L., Albert, M., & Goodglass, H. (1985), Lexical retrieval in healthy aging, Cortex, 21, 595-606; and Goulet, P., Ska, B., & Kahn, H. J. (1994), Is there a decline in picture naming with advancing age?, Journal of Speech and Hearing Research, 37, 629-644) and in the production of a target word given its definition and initial letter, or given its initial letter and general semantic category (McCrae, R. R., Arenberg, D., & Costa, P. T. (1987), Declines in divergent thinking with age: Cross-sectional, longitudinal, and cross-sequential analyses, Psychology and Aging, 2, 130-137).

Older adults rated word finding failures and tip of the tongue experiences (TOTs) as cognitive problems that are both most severe and most affected by aging (Rabbitt, P., Maylor, E., McInnes, L., Bent, N., & Moore, B. (1995), What goods can self-assessment questionnaires deliver for cognitive gerontology?, Applied Cognitive Psychology, 9, S127-S152; Ryan, E. B., See, S. K., Meneer, W. B., & Trovato, D. (1994), Age-based perceptions of conversational skills among younger and older adults, In M. L. Hummert, J. M. Wiemann, & J. N. Nussbaum (Eds.) Interpersonal communication in older adulthood (pp. 15-39). Thousand Oaks, Calif.: Sage Publications; and Sunderland, A., Watts, K., Baddeley, A. D., & Harris, J. E. (1986), Subjective memory assessment and test performance in the elderly, Journal of Gerontology, 41, 376-384). Older adults rated retrieval failures for proper names as especially common (Cohen, G., & Faulkner, D. (1984), Memory in old age: “good in parts” New Scientist, 11, 49-51; Martin, M. (1986); Ageing and patterns of change in everyday memory and cognition, Human Learning, 5, 63-74; and Ryan, E. B. (1992), Beliefs about memory changes across the adult life span, Journal of Gerontology: Psychological Sciences, 47, P41-P46) and the most annoying, embarrassing and irritating of their memory problems (Lovelace, E. A., & Twohig, P. T. (1990), Healthy older adults' perceptions of their memory functioning and use of mnemonics, Bulletin of the Psychonomic Society, 28, 115-118). They also produce more ambiguous references and pronouns in their speech, apparently because of an inability to retrieve the appropriate nouns (Cooper, P. V. (1990), Discourse production and normal aging: Performance on oral picture description tasks, Journal of Gerontology: Psychological Sciences, 45, P210-214; and Heller, R. B., & Dobbs, A. R. (1993), Age differences in word finding in discourse and nondiscourse situations, Psychology and Aging, 8, 443-450). Speech disfluencies, such as filled pauses and hesitations, increase with age and may likewise reflect word retrieval difficulties (Cooper, P. V. (1990), Discourse production and normal aging: Performance on oral picture description tasks, Journal of Gerontology: Psychological Sciences, 45, P210-214; and Kemper, S. (1992a), Adults' sentence fragments: Who, what, when, where, and why, Communication Research, 19, 444-458).

Further, TOT states increase with aging, accounting for one of the most dramatic instances of word finding difficulty in which a person is unable to produce a word although absolutely certain that they know it. Both naturally occurring TOTs (Burke, D. M., MacKay, D. G., Worthley, J. S., & Wade, E. (1991), On the tip of the tongue: What causes word finding failures in young and older adults, Journal of Memory and Language, 30, 542-579) and experimentally induced TOTs increase with aging (Burke, D. M., MacKay, D. G., Worthley, J. S., & Wade, E. (1991), On the tip of the tongue: What causes word finding failures in young and older adults, Journal of Memory and Language, 30, 542-579; Brown, A. S., & Nix, L. A. (1996), Age-related changes in the tip-of-the-tongue experience, American Journal of Psychology, 109, 79-91; James, L. E., & Burke, D. M. (2000), Phonological priming effects on word retrieval and tip-of-the-tongue experiences in young and older adults, Journal of Experimental Psychology: Learning. Memory, and Cognition, 26, 1378-1391; Maylor, E. A. (1990b), Recognizing and naming faces: Aging, memory retrieval and the tip of the tongue state, Journal of Gerontology: Psychological Sciences, 45, P215-P225; and Rastle, K. G., & Burke, D. M. (1996), Priming the tip of the tongue: Effects of prior processing on word retrieval in young and older adults, Journal of Memory and Language, 35, 586-605).

Still, word retrieval failures in young and especially older adults appear to reflect declines in access to phonological representations. Evidence for age-linked declines in language production has come almost exclusively from studies of word retrieval. MacKay and Abrams reported that older adults made certain types of spelling errors more frequently than young adults in written production, a sub-lexical retrieval deficit involving orthographic units (MacKay, D. G., Abrams, L., & Pedroza, M. J. (1999), Aging on the input versus output side: Theoretical implications of age-linked asymmetries between detecting versus retrieving orthographic information, Psychology and Aging, 14, 3-17). This decline occurred despite age equivalence in the ability to detect spelling errors and despite the higher vocabulary and education levels of older adults. The phonological/orthographic knowledge retrieval problem in old age is not due to deficits in formulating the idea to be expressed, but rather it appears to reflect an inability to map a well-defined idea or lexical concept onto its phonological and orthographic unit forms. Thus, unlike semantic comprehension of word meaning, which seems to be well-preserved in old age, sensory-motor retrieval of phonological and orthographic representations declines with aging.

### Language Production Deficits in Normal Aging and Open-Bigrams and Open Proto-Bigrams Priming

The teachings of the present invention are in agreement with some of the mechanisms and predictions of the transmission deficit hypothesis (TDH) computational model (Burke, D. M., Mackay, D. G., & James L. E. (2000), Theoretical approaches to language and aging, In T. J. Perfect & E. A. Maylor (Eds.), Models of cognitive aging (pp. 204-237). Oxford, England: Oxford University Press; and MacKay, D. G., & Burke, D. M. (1990), Cognition and aging: A theory of new learning and the use of old connections, In T. M. Hess (Ed.), Aging and cognition: Knowledge organization and utilization (pp. 213-263). Amsterdam: North Holland). Briefly, under the TDH, verbal information is represented in a network of interconnected units or nodes organized into a semantic system representing lexical and propositional meaning and a phonological system representing sounds. In addition to these nodes, there is a system of orthographic nodes with direct links to lexical nodes and also lateral links to corresponding phonological nodes (necessary for the production of novel words and pseudowords). In the TDH, language word comprehension (input) versus word production (output) differences arise from an asymmetrical structure of top-down versus bottom-up priming connections to the respective nodes.

In general, the present invention stipulates that normal aging weakens the priming effects of open-bigrams in words, particularly open proto-bigrams inside words and in between words in a sentence or fluent speech. This weakening priming effect of open proto-bigrams negatively impacts the direct lexical to semantics access route for automatically knowing the most common words in a language, and in particular, causes slow, non-accurate (spelling mistakes) recognition and retrieval of the orthographic code via writing and typing as well as slow, non-accurate (errors) or TOT of phonological and lexical information concerning particular types of naming word retrievals from speech. It is worth noticing that with aging, this priming weakening effect of open-bigrams and open proto-bigrams greatly diminishes the benefits of possessing a language with a high lexical-phonological information and lexical orthographic code representation redundancy. Therefore, it is to be expected that older individuals will increase content production errors in written-spoken messages, making phonological and lexical information via speech naming retrieval, and/or lexical orthographic production via writing, less resistant to noise. In other words, the early language advantage resting upon a flexible orthographic code and a flexible lexical-phonological informational encoding of speech becomes a disadvantage with aging since the orthographic or lexical-phonological code will become too flexible and prompt too many production errors.

The teachings of the present invention point out that language production deficits, particularly negatively affecting open-bigrams and open proto-bigrams when aging normally, promote an inefficient and noisy sensory-motor grounding of cognitive (top-down) fluent reasoning/intellectual abilities reflected in slow, non-accurate or wrong substitutions of ‘naming meaning’ in specific domains (e.g., names of people, places, dates, definitions, etc.) The teachings of the present invention further hypothesize that in a mild to severe progression Alzheimer's or dementia individual, language production deficits worsen and expand to also embrace wrong or non-sensory-motor grounding of cognitive (top-down) fluent reasoning/intellectual abilities thus causing a partial or complete informational disconnect/paralysis between object naming retrieval and the respective action-use domain of the retrieved object.

### A Novel Neuro-Performance Non-Pharmacological Alphabetic Language Based Technology

Without limiting the scope of the present invention, the teachings of the present invention disclose a non-pharmacological technology aiming to promote novel exercising of alphanumeric symbolic information. The present invention aims for a subject to problem solve and perform a broad spectrum of relationships among alphanumeric characters. For that purpose, direct and inverse alphabetical strings are herein presented comprising a constrained serial positioning order among the letter characters as well as randomized alphabetical strings comprising a non-constrained alphabetical serial positioning order among the letter characters. The herein presented novel exercises involve visual and/or auditory searching, identifying/recognizing, sensory-motor selecting and organizing of one or more open-bigrams and/or open proto-bigrams in order to promote fluid reasoning ability in a subject manifested in an effortless, fast and efficient problem solving of particular letter characters relationships in direct-inverse alphabetical and/or randomized alphabetical sequences. Still, the herein non-pharmacological technology, consist of novel exercising of open-bigrams and open proto-bigrams to promote: a) a strong grounding of lexical-phonological cognitive information in spoken language and of lexical orthographic unit components in writing language, b) a language neuro-prophylactic shielding against language production processing deficits in normal aging population, c) a language neuro-prophylactic shielding against language production processing deficits in MCI people, and d) a language neuro-prophylactic shielding against language production processing deficits capable of slowing down (or reversing) early mild neural degeneration cognitive adversities in Alzheimer's and dementia individuals.

Orthographic Sequential Encoded Regulated by Inputs to Oscillations within Letter Units (‘SERIOL’) Processing Model:

According to the SERIOL processing model, orthographic processing occurs at two levels—the neuronal level, and the abstract level. At the neuronal level, orthographic processing occurs progressively beginning from retinal coding (e.g., string position of letters within a string), followed by feature coding (e.g., lines, angles, curves), and finally letter coding (coding for letter nodes according to temporal neuronal firing.) At the abstract level, the coding hierarchy is (open) bigram coding (i.e., sequential ordered pairs of letters—correlated to neuronal firings according to letter nodes) followed by word coding (coding by: context units—words represented by visual factors—serial proximity of constituent letters). ((Whitney, C. (2001a), How the brain encodes the order of letters in a printed word: The SERIOL model and selective literature review, Psychonomic Bulletin and Review, 8, 221-243).

Some Statistical Aspects of Sequential Order of Letters and Letter Strings:

In the English language, in a college graduate vocabulary of about 20,000 letter strings (words), there are about only 50-60 words which obey a direct A-Z or indirect Z-A sequential incomplete alphabetical different letters serial order (e.g., direct A-Z “below” and inverse Z-A “the”). More so, about 40% of everything said, read or written in the English language consists of frequent repetitions of open proto-bigrams (e.g., is, no, if, or etc.) words in between words in written sentences or uttered words in between uttered words in a conversation. In the English language, letter trigrams frequent repetitions (e.g. “the”, ‘can’, ‘his’, ‘her’, ‘its’, etc.) constitute more than 10% of everything said, read or written.

### Methods

The definition given to the terms below is in the context of their meaning when used in the body of this application and in its claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

A “series” is defined as an orderly sequence of terms

“Serial terms” are defined as the individual components of a series.

A “serial order” is defined as a sequence of terms characterized by: (a) the relative ordinal spatial position of each term and the relative ordinal spatial positions of those terms following and/or preceding it; (b) its sequential structure: an “indefinite serial order,” is defined as a serial order where no first neither last term are predefined; an “open serial order.” is defined as a serial order where only the first term is predefined; a “closed serial order,” is defined as a serial order where only the first and last terms are predefined; and (c) its number of terms, as only predefined in ‘a closed serial order’.

“Terms” are represented by one or more symbols or letters, or numbers or alphanumeric symbols.

“Arrays” are defined as the indefinite serial order of terms. By default, the total number and kind of terms are undefined.

“Terms arrays” are defined as open serial orders of terms. By default, the total number and kind of terms are undefined.

“Set arrays” are defined as closed serial orders of terms, wherein each term is intrinsically a different member of the set and where the kinds of terms, if not specified in advance, are undefined. If, by default, the total number of terms is not predefined by the method(s) herein, the total number of terms is undefined.

“Letter set arrays” are defined as closed serial orders of letters, wherein same letters may be repeated.

An “alphabetic set array” is a closed serial order of letters, wherein all the letters are predefined to be different (not repeated). Still, each letter member of an alphabetic set array has a predefined different ordinal position in the alphabetic set array. An alphabetic set array is herein considered to be a Complete Non-Randomized alphabetical letters sequence. Letter symbol members are herein only graphically represented with capital letters. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, Q, K, P, L, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “open bigram,” if not specified otherwise, is herein defined as a closed serial order formed by any two contiguous or non-contiguous letters of the above alphabetic set arrays. Under the provisions set forth above, an “open bigram” may also refer to pairs of numerical or alpha-numerical symbols.

For Alphabetic Set Arrays where the Members are Defined as Open Bigrams, the Following 3 Direct and 3 Inverse Alphabetic Open Bigrams Set Arrays are Herein Defined

Direct alphabetic open bigram set array: AB, CD, EF, GH, U, KL, MN, OP, QR, ST, UV, WX, YZ.

Inverse alphabetic open bigram set array: ZY, XW, VU, TS, RQ, PO, NM, LK, JI, HG, FE, DC, BA.

Direct alphabetic type open bigram set array: AZ, BY, CX, DW, EV, FU, GT, HS, IR, JQ, KP, LO, MN.

Inverse alphabetic type open bigram set array: ZA, YB, XC, WD, VE, UF, TG, SH, RI, QJ, PK, OL, NM.

Central alphabetic type open bigram set array: AN, BO, CP, DQ, ER, FS, GT, HU, IV, JW, KX, LY, MZ.

Inverse alphabetic central type open bigram set array: NA, OB, PC, QD, RE, SF, TG, UH, VI, WJ, XK, YL, ZM.

An “open bigram term” is a lexical orthographic unit characterized by a pair of letters (n-gram) depicting a minimal sequential order consisting of two letters. The open bigram class to which an open bigram term belongs may or may not convey an automatic direct access to semantic meaning in an alphabetic language to a reader.

An “open bigram term sequence” is a letters symbol sequence, where two letter symbols are presented as letter pairs representing a term in the sequence, instead of an individual letter symbol representing a term in the sequence.

There are 4 classes of Open Bigram terms, there being a total of 676 different open bigram terms in the English alphabetical language

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms wherein 2 open bigram terms are also open bigram terms members of Class I.

Class III—Within the context of the present subject matter, Class III entails the vast majority of open bigram terms in the English alphabetical language except for all open bigram terms members of Classes I, II, and IV. Specifically, Class III comprises a total of 550 open bigram terms.

Class IV—Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

An “open proto-bigram sequence type” is herein defined as a complete alphabetic open proto-bigram sequence characterized by the pairs of letters comprising each open proto-bigram term in a way that the serial distribution of such open proto-bigram terms establishes a sequence of open proto-bigram terms type that follows a direct or an inverse alphabetic set array order. In summary, there are two complete alphabetic open proto-bigram sequence types.

Types of Open Proto-Bigram Sequences:

Direct type open proto-bigram sequence: AM, AN, AS, AT, BE, BY, DO, GO, IN, IS, IT, MY, NO, OR

Inverse type open proto-bigram sequence: WE, US, UP, TO, SO, ON, OF, ME, IF, HE.

“Complete alphabetic open proto-bigram sequence groups” within the context of the present subject matter, Class I open-proto bigram terms, are further grouped in three sequence groups:

Open Proto-Bigram Sequence Groups:

Left Group: AM, BE, HE, IF, ME

Central Group: AN, AS, AT, BY, DO, GO, IN, IS, IT, MY, OF, WE

Right Group: NO, ON, OR, SO, TO, UP, US

The term “collective critical space” is defined as the alphabetic space in between two non-contiguous ordinal positions of a direct or inverse alphabetic set array. A “collective critical space” further corresponds to any two non-contiguous letters which form an open proto-bigram term. The postulation of a “collective critical space” is herein contingent to any pair of non-contiguous letter symbols in a direct or inverse alphabetic set array, where their orthographic form directly and automatically conveys a semantic meaning to the subject.

The term “virtual sequential state” is herein defined as an implicit incomplete alphabetic sequence made-up of the letters corresponding to the ordinal positions entailed in a “collective critical space”. There is at least one implicit incomplete alphabetic sequence entailed per each open proto-bigram term. These implicit incomplete alphabetic sequences are herein conceptualized to exist in a virtual perceptual-cognitive mental state of the subject. Every time that this virtual perceptual-cognitive mental state is grounded by means of a programmed goal oriented sensory-motor activity in the subject, his/her reasoning and mental cognitive ability is enhanced.

From the above definitions, it follows that a letters sequence, which at least entails two non-contiguous letters forming an open proto-bigram term, will possess a “collective critical spatial perceptual related attribute” as a direct consequence of the implicit perceptual condition of the at least one incomplete alphabetic sequence arising from the “virtual sequential state” in correspondence with the open proto-bigram term This virtual/abstract serial state becomes concrete every time a subject is required to reason and perform goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing a data “compression” of a selected letters sequence or by performing a data “expansion” of a selected letters sequence in accordance with the definitions of the terms given below.

Moreover, as already indicated above for a general form of these definitions, for a predefined Complete Numerical Set Array and a predefined Complete Alphanumeric Set Array, the “collective critical space”, “virtual sequential state” and “collective critical spatial perceptual related attribute” for alphabetic series can also be extended to include numerical and alphanumerical series.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ) Therefore, the 26 different letter terms of the English alphabet will have 26 different ordinal positions which, in the case of the direct alphabetic set array (see above), ordinal position #1 will correspond to the letter “A”, and ordinal position #26 will correspond to the letter “Z”.

An “alphabetic letter sequence,” unless otherwise specified, is herein one or more complete alphabetic letter sequences from the group comprising: Direct alphabetic set array, Inverse alphabetic set array, Direct open bigram set array, Inverse open bigram set array, Direct open proto-bigram sequence, and Inverse open proto-bigram sequence.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to alphabetic set arrays, because they are defined as complete closed serial orders of terms (see above). For example, in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign/representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign/representation depicting a particular letter term, are phonologically uttered with the same sound(s) (like “a” and “A”).

An “attribute” of a term (alphanumeric symbol, letter, or number) is defined as a spatial distinctive related perceptual feature and/or time distinctive related perceptual feature. An attribute of a term can also be understood as a related on-line perceptual representation carried through a mental simulation that effects the off-line conception of what it's been perceived. (Louise Connell, Dermot Lynott. Principles of Representation: Why You Can't Represent the Same Concept Twice. Topics in Cognitive Science (2014) 1-17)

A “spatial related perceptual attribute” is defined as a characteristically spatial related perceptual feature of a term, which can be discriminated by sensorial perception. There are two kinds of spatial related perceptual attributes.

An “individual spatial related attribute” is defined as a spatial related perceptual attribute that pertains to a particular term. Individual spatial related perceptual attributes include, e.g., symbol case; symbol size; symbol font; symbol boldness; symbol tilted angle in relation to a horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related attribute” is defined as a spatial related perceptual attribute that pertains to the relative location of a particular term in relation to the other terms in a letter set array, an alphabetic set array, or an alphabetic letter symbol sequence. Collective spatial related attributes (e.g. in a set array) include a symbol ordinal position, the physical space occupied by a symbol font, the distance between the physical spaces occupied by the fonts of two consecutive symbols/terms when represented in orthographical form, and left or right relative edge position of a term/symbol font in a set array. Even if triggering a sensorial perceptual relation with the reasoning subject, a “collective spatial related perceptual attribute” is not related to the semantic meaning of the one or more letter symbols possessing this spatial perceptual related attribute. In contrast, the “collective critical space” is contingent on the generation of a semantic meaning in a subject by the pair of non-contiguous letter symbols implicitly entailing this collective critical space.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is quantified as: 1/t, where t is in the order of seconds of time; c) particular sound frequencies by which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is herein considered to take place along a horizontal axis, in a spatial direction to be predefined. If the visual perception of constant motion is implemented on a computer screen, the value of V to be assigned is given in pixels per second at a predefined screen resolution.

It has been empirically observed that when the first and last letter symbols of a word are maintained, the reader's semantic meaning of the word may not be altered or lost by removing one or more letters in between them. This orthographic transformation is named data “compression”. Consistent with this empirical observation, the notion of data “compression” is herein extended into the following definitions:

If a “symbols sequence is subject to compression” which is characterized by the removal of one or more contiguous symbols located in between two predefined symbols in the sequence of symbols, the two predefined symbols may, at the end of the compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the compression of a letter sequence is considered to take place at two sequential levels, “local” and “non-local”, and the non-local sequential level comprises an “extraordinary sequential compression case.”

A “local open proto-bigram term compression” is characterized by the omission or removal of one or two contiguous letters in a sequence of letters lying in between the two letters that form/assemble an open proto-bigram term, by which the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term, by which the two letters of the open proto-bigram term become contiguous letters in the letters sequence.

An “extraordinary non-local open proto-bigram compression” is a particular case of a non-local open proto-bigram term compression, which occurs in a letters sequence comprising N letters when the first and last letters in the letters sequence are the two selected letters forming/assembling an open proto-bigram term, and the N−2 letters lying in between are omitted or removed, by which the remaining two letters forming/assembling the open proto-bigram term become contiguous letters.

An “alphabetic expansion” of an open proto-bigram term is defined as the orthographic separation of its two (alphabetical non-contiguous letters) letters by the serial sensory motor insertion of the corresponding incomplete alphabetic sequence directly related to its collective critical space according to predefined timings. This sensory motor ‘alphabetic expansion’ will explicitly make the particular related virtual sequential state entailed in the collective critical space of this open proto-bigram term concrete.

“Orthographic letters contiguity” is defined as the contiguity of letters symbols in a written form by which words are represented in most written alphabetical languages.

For “alphabetic contiguity,” a visual recognition facilitation effect occurs for a pair of letters forming any open bigram term, even when 1 or 2 letters in orthographic contiguity lying in between these two (now) edge letters form the open bigram term. It has been empirically confirmed that up to 2 letters located contiguously in between the open bigram term do not interfere with the visual identity and resulting perceptual recognition process of the pair of letters making-up the open bigram term. In other words, the visual perceptual identity of an open bigram term (letter pair) remains intact even in the case of up two letters held in between these two edge letters forming the open bigram term.

However, in the particular case where open bigram terms orthographically directly convey/communicate a semantic meaning in a language (e.g., open proto-bigrams), it is herein considered that the visual perceptual identity of open proto-bigram terms remains intact even when more than 2 letters are held in between the now edge letters forming the open proto-bigram term. This particular visual perceptual recognition effect is considered as an expression of: 1) a Local Alphabetic Contiguity effect—empirically manifested when up to two letters are held in between (LAC) for open bigrams and open proto-bigrams terms and 2) a Non-Local Alphabetic Contiguity (NLAC) effect—empirically manifested when more than two letters are held in between, an effect which only take place in open proto-bigrams terms.

Both LAC and NLAC are part of a herein novel methodology aiming to advance a flexible orthographic decoding and processing view concerning sensory motor grounding of perceptual-cognitive alphabetical, numerical, and alphanumeric information/knowledge. LAC correlates to the already known priming transposition of letters phenomena, and NLAC is a new proposition concerning the visual perceptual recognition property particularly possessed only by open proto-bigrams terms which is enhanced by the performance of the herein proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and autonomously causes arousal inhibition in the visual perception process for detecting, processing, and encoding the N letters held in between the 2 edge letters forming an open proto-bigram term, thus resulting in maximal data compression of the letters sequence. As a consequence of the alphabetic contiguity orthographic phenomena, the space held in between any 2 non-contiguous letters forming an open proto-bigram term in the alphabet is of a critical perceptual related nature, herein designated as a ‘Collective Critical Space Perceptual Related Attribute’ (CCSPRA) of the open proto-bigram term, wherein the letters sequence which is attentionally ignored-inhibited, should be conceptualized as if existing in a virtual mental kind of state. This virtual mental kind of state will remain effective even if the 2 letters making-up the open proto-bigram term will be in orthographic contiguity (maximal serial data compression).

When the 2 letters forming an open proto-bigram term hold in between a number of N letters and when the serial ordinal position of these two letters are the serial position of the edge letters of a letters sequence (meaning that there are no additional letters on either side of these two edge letters), the alphabetic contiguity property will only pertain to these 2 edge letters forming the open proto-bigram term. In brief, this particular case discloses the strongest manifestation of the alphabetic contiguity property, where one of the letters making up an open proto-bigram term is the head and the other letter is the tail of a letters sequence. This particular case is herein designated as Extraordinary NLAC.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods—one method wherein the number of terms is generated in a predefined quantity; and another method wherein the number of terms is generated by a quasi-random method.

It is important to point out/consider that, in the above method of promoting reasoning abilities and in the following exercises and examples implementing the method, the subject is performing the discrimination of open bigrams or open proto-bigram terms in an array/series of open bigrams and/or open proto-bigram sequences without invoking explicit conscious awareness concerning underlying implicit governing rules or abstract concepts/interrelationships, characterized by relations or correlations or cross-correlations among the searched, discriminated and sensory motor manipulated open bigrams and open proto-bigrams terms by the subject. In other words, the subject is performing the search and discrimination without overtly thinking or strategizing about the necessary actions to effectively accomplish the sensory motor manipulation of the open bigrams and open proto-bigram terms.

As mentioned in connection with the general form of the above definitions, the herein presented suite of exercises can make use of not only letters but also numbers and alphanumeric symbols relationships. These relationships include correlations and cross-correlations among open bigrams and/or open proto-bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, pattern and irregularities recognition, identifying relations, correlations and cross-correlations among sequential orders of symbols comprehending implications, extrapolating, transforming information and abstract concept thinking.

As mentioned earlier, it is also important to consider that the methods described herein are not limited to only alphabetic symbols. It is also contemplated that the methods of the present subject can involve numeric serial orders and/or alpha-numeric serial orders to be used within the exercises. In other words, while the specific examples set forth employ serial orders of letter symbols, alphabetic open bigram terms and alphabetic open proto-bigram terms, it is contemplated that serial orders comprising numbers and/or alpha-numeric symbols can be used.

The library of complete open proto-bigram sequences comprises a predefined number of set arrays (closed serial orders of terms: symbols/letters/numbers), which may include alphabetic set arrays. Alphabetic set arrays are characterized by comprising a predefined number of different letter terms, each letter term having a predefined unique ordinal position in the closed set array, and none of said different letter terms are repeated within this predefined unique serial order of letter terms. A non-limiting example of a unique set array is the English alphabet, in which there are 13 predefined different open bigram terms where each open bigram term has a predefined consecutive ordinal position of a unique closed serial order among 13 different members of a set array only comprising 13 members.

In one aspect of the present subject matter, a predefined library of complete open-bigrams sequences is considered, which may comprise set arrays. The English alphabet is herein considered as only one unique serial order of open-bigram terms among the at least six different unique serial orders of the same open-bigram terms. The English alphabet is a particular alphabetic set array herein denominated: direct alphabetic open-bigram set array. The other five different orders of the same open-bigram terms are also unique alphabetic open-bigram set arrays, which are herein denominated: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or comprise more different set arrays.

In an aspect of the present methods, the at least one unique serial order comprises a sequence of open-bigram terms. In this aspect of the present subject matter, the predefined library of set arrays may comprise the following set arrays sequential orders of open-bigrams terms, where each open-bigram term is a different member of the set array having a predefined unique ordinal position within the set: direct open-bigram set array, inverse open-bigram set array, direct type open-bigram set array, inverse type open-bigram set array, central type open-bigram set array, and inverse central type set array. It is understood that the above predefined library of set arrays sequences may contain additional or fewer set arrays sequences than those listed above.

### Example 1

### Reasoning to Perform a Compression of a Given Letters Sequence, Wherein the Removed Letters are Those Contained in Between Two Non-Consecutive Letters, which are Recognized as the Letters Pair of a Shown Open Proto-Bigram

A goal of the presented Example 1 is to promote a subject's cognitive fluid reasoning ability to problem solve a serial order of letters by visually searching, recognizing, and performing a local or non-local compression of a selected letter sequence by removing one or more contiguous letters located in between a recognized pair of letters of an open proto-bigram in the selected letters sequence. This specific cognitive reasoning problem solving activity brings forth a mental simulation process centered in perceptual inhibition that results in attentional ignoring of one or more contiguous letters held in between a recognized pair of letters of an assigned open proto-bigram term. Example 1 promotes fluid reasoning ability for the problem solving of a selected serial orders of letters, by exercising the sensory-motor competencies of a subject to explicitly expose one or more assigned open proto-bigrams terms embedded in the provided letter sequences.

This method aiming to enhance fluid reasoning ability requires the subject to problem solve particular serial orders of designed letters sequence exercises. The subject is required to mentally simulate the removal (aided by attentional ignoring) of one or more contiguous letters located in between a pair of letters of an assigned open proto-bigram which he/she has previously visually recognized inside the selected letters sequence. The subject's cognitive fluid reasoning performance of compressing the letters sequence is immediately followed by the subject's sensory motor selection-recognition (e.g. mouse-clicking) on each single letter (one letter at a time) of the pair of letters in the assigned visually recognized open proto-bigram term. The sensory motor mouse clicking of the second letter from the pair of letters specifically causes a predefined process of compression, which can vary among exercises, to expose a specifically assigned or a visually recognized open proto-bigram term among a number of presented open proto-bigram term options.

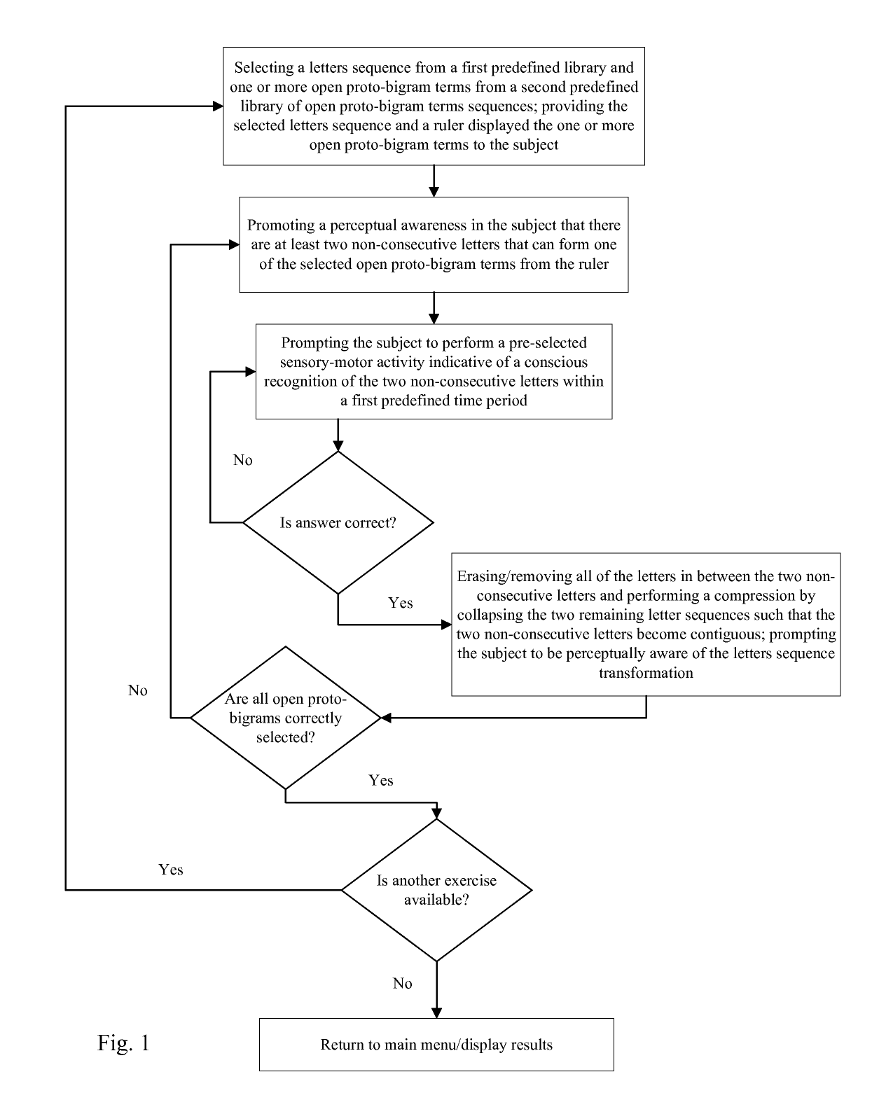

FIG. 1 is a flow chart setting forth the broad concepts covered by the specific non-limiting exercises put forth in the Examples below. As can be seen in FIG. 1, the method of promoting reasoning ability in a subject by performing a compression of a provided letters sequence by removing one or more contiguous letters located in between a recognized pair of letters of an assigned open proto-bigram term comprises selecting a letters sequence from a first predefined library of letters sequences and one or more open proto-bigram terms from a second predefined library of open proto-bigram terms sequences, and providing the selected letters sequence along with a ruler displaying the selected one or more open proto-bigram terms to the subject; and promoting a perceptual awareness in the subject indicative of there being at least two non-consecutive letters in the provided letters sequence, which form one of the selected open proto-bigram terms displayed in the ruler. The subject is then prompted to perform a pre-selected sensory-motor activity indicative of a conscious explicit recognition of the two non-consecutive letters forming a selected open proto-bigram term from the provided letters sequence within a first predefined time period.

If the subject made a correct conscious explicit recognition, then removing all of the letters in the selected letters sequence between the two non-consecutive letters forming the selected open proto-bigram term thereby creating two remaining letters sections, compressing the two remaining letters sections together such that the two non-consecutive letters are serially contiguous with each other thus transforming the letters sequence to obtain a shorter length letters sequence. The subject is then prompted to be perceptually aware of the letters sequence transformation. However, if the conscious explicit visual recognition made by the subject is incorrect, then the subject is returned to the prior step of being prompted to perform a pre-selected sensory-motor activity indicative of a conscious explicit visual recognition of the two non-consecutive letters forming a selected open proto-bigram term.

The above steps in the method are repeated for a predetermined number of times for each letters sequence selected from the first predefined library where each repetition is separated by a second predefined time period. The method steps are also repeated for a predetermined number of iterations and each iteration is separated by a third predefined time period, and upon completion of the predefined number of iterations, the results of each iteration are provided to the subject. The predetermined number of iterations can be any number needed to establish that a proficient reasoning performance concerning the particular task at hand is being promoted within the subject. Non-limiting examples of number of iterations include 1, 2, 3, 4, 5, 6, and 7.

In another aspect of the present examples, the method of promoting reasoning ability in a subject in order to perform a compression of a provided letters sequence by removing one or more contiguous letters located in between a visually recognized pair of letters of an assigned open proto-bigram term is implemented through a computer program product. Particularly, there is included a computer program product for promoting reasoning ability in a subject in order to perform a compression of a provided letters sequence by removing one or more contiguous letters located in between a visually recognized pair of letters of an open proto-bigram term, stored on a non-transitory computer-readable medium which when executed causes a computer system to perform a method. The method executed by the computer program on the non-transitory computer readable medium comprises selecting a letters sequence from a first predefined library of letters sequences and one or more open proto-bigram terms from a second predefined library of open proto-bigram terms sequences. In addition to the selected letters sequence, the subject is provided with a ruler displaying the selected one or more open proto-bigram terms. A perceptual awareness is promoted in the subject indicative of the presence of at least two non-consecutive letters in the letters sequence, which form one of the selected open proto-bigram terms displayed in the ruler. The subject is then prompted to perform a pre-selected sensory-motor activity (e.g., mouse clicking) indicative of a conscious explicit visual recognition of the two non-consecutive letters forming a selected open proto-bigram term within a first predefined time period. An incorrect visual recognition of the two non-consecutive letters forming a selected open proto-bigram term returns the subject to the prior step of being prompted to perform a pre-selected sensory-motor activity (e.g., mouse clicking) indicative of a conscious explicit recognition of the two non-consecutive letters forming a selected open proto-bigram term. For a correct explicit visual recognition, all of the letters in the selected letters sequence located in between the two non-consecutive letters forming the one open proto-bigram term are then erased or removed to create two remaining letters sections, the two remaining letters sections are compressed together such that the two non-consecutive letters are serially contiguous with each other, and then the subject is prompted to be perceptually explicitly aware of the letters sequence transformation, namely that a shorter letters sequence has been obtained.

The above steps in the method are repeated for a predetermined number of times for each letters sequence selected from the first predefined library where each repetition is separated by a second predefined time period. The method steps are also repeated for a predetermined number of iterations, each iteration being separated by a third predefined time period, and upon completion of the predefined number of iterations, the results of each iteration are provided to the subject.

In a further aspect of the present examples, the method of promoting reasoning ability in a subject in order to perform a compression of a provided letters sequence by removing one or more contiguous letters located in between a visually recognized pair of letters of an open proto-bigram term is implemented through a system. The system for promoting reasoning ability in a subject in order to perform a compression of a provided letters sequence by removing one or more contiguous letters located in between a visually recognized pair of letters of an assigned open proto-bigram term comprises: a computer system comprising a processor, memory, and a graphical user interface (GUI), the processor containing instructions for: selecting a letters sequence from a first predefined library of letters sequences and one or more open proto-bigram terms from a second predefined library of open proto-bigram terms sequences and providing the selected letters sequence along with a ruler displaying the selected one or more open proto-bigram terms to the subject on the GUI; promoting a perceptual awareness in the subject indicative of there being at least two non-consecutive letters in the provided letters sequence, which form one of the selected open proto-bigram terms displayed in the ruler; prompting the subject on the GUI to perform a pre-selected sensory-motor activity (e.g., mouse clicking) indicative of a conscious explicit visual recognition of the at least two non-consecutive letters forming the one open proto-bigram term from the provided letters sequence within a first predefined time period; determining if the subject correctly consciously explicitly visually recognized the two non-consecutive letters; if the conscious explicit visual recognition performed by the subject is an incorrect visual recognition, then returning to the step of prompting the subject to perform a pre-selected sensory-motor activity (e.g., mouse clicking) indicative of a conscious explicit visual recognition of the two non-consecutive letters forming a selected open proto-bigram term; if the conscious explicit visual recognition performed by the subject is a correct visual recognition of the two letters forming a selected open proto-bigram term, then removing all of the letters in the selected letters sequence located in between the two non-consecutive letters forming the selected open proto-bigram term to create two remaining letters sections, compressing the two remaining letters sections together such that the two non-consecutive letters forming the selected open proto-bigram term are serially contiguous with each other to transform the length of the letters sequence, and prompting the subject to be perceptually aware of the letters sequence transformation on the GUI; repeating the above steps for each letters sequence selected from the first predefined library, each repetition separated by a second predefined time period; repeating the above steps for a predefined number of iterations, each separated by a third predefined time period; and presenting the subject with results from each iteration at the end of the predefined number of iterations on the GUI.

In one aspect of the present Example 1, a single letters sequence is selected from the following types of letters sequences: 1) a direct alphabetic set array; 2) an inverse alphabetic set array; 3) non-alphabetic array; 4) incomplete alphabetic set array; 5) a complete non-alphabetical serial order of different letters sequence; or 6) an incomplete non-alphabetical serial order of same letters sequence. Further, the number of iterations may have a predefined order for the subject to perform the selected letters sequences in a given exercise.

In another aspect of the present Example 1, the selected letters sequences (e.g., a non-alphabetic letters sequence) may be provided to the subject in the form of a letters matrix. For any given letters matrix, the letters may be arranged in a predefined number of rows each having a predefined number of letters per row. There is no particular limitation as to how the number of rows can be organized in the letters matrix.

In an aspect of the methods of Example 1, a perceptual awareness is promoted in the subject. Particularly, this promotion of perceptual awareness in a subject may be achieved by providing the subject with one or more kinds of perceptual stimuli to facilitate the subject's discrimination of the two single letters forming an assigned open proto-bigram term. Kinds of perceptual stimuli may include one or more of visual, auditory, and tactile stimuli. In a non-limiting example, visual stimuli may be provided to the subject in the form of a ruler which distinctively displays an assigned open proto-bigram term to be consciously explicitly visually recognized by the subject in a selected letters sequence. Furthermore, the ruler may be considered to distinctively show an assigned open proto-bigram term through one or more spatial and/or time perceptual related attribute changes of the assigned open proto-bigram term, which differ from the spatial and/or time perceptual related attributes of the other open proto-bigram terms in the ruler and/or the letters in the selected letters sequence.

In a further aspect of the present Example 1, the sensory-motor activity required to be performed by the subject to indicate conscious explicit recognition of the two letters forming an assigned open proto-bigram term for a selected letters sequence may include: mouse clicking on each letter; pointing at a single letter at a time with a finger while touching a screen where the selected letters sequence is displayed at the specific serial location where each letter is found; and spelling the name of each letter aloud, one at a time.

In the context of the present Example 1, the subject uses fluid reasoning ability to problem solve and perform a selected serial order of symbols in a presented letters sequence, by first being required to mentally simulate (aid by attentional inhibition-ignoring) the removal one or more letters located in between two non-contiguous letters of the presented letters sequence that he/she was asked to visually explicitly recognize. This fluid reasoning aptitude refers specifically to a method of reasoning that focuses on sequential fractions of letters sequences embedded in a larger selected letters sequence. Specifically, the subject will further reason in order to successfully compress the two remaining fractions of letters sequences to obtain the assigned pair of letters that were originally asked to be visually recognized, thus becoming two contiguous letters and forming/assembling the assigned open proto-bigram term aimed to be explicitly exposed.

For example, in a presented complete direct alphabetical letters sequence ‘ABCDEFGHIJKLMNOPQRSTUVWXYZ’, the subject is asked to visually recognize the two letters of the assigned open proto-bigram term “BE”. After visually recognizing the location of the two letters in the presented sequence, removing the in between and contiguous letters ‘C’ and ‘D’, and compressing the two remaining letters sequences, the assigned open proto-bigram term ‘BE’ will be formed. Similarly, the incomplete direct letters sequence ‘OPQRS’ yields the open proto-bigram term ‘OR’ after removing the ‘P’ and ‘Q’ letters and then compressing the remaining letters. From the complete inverse alphabetical letters sequence ‘ZYXWVUTSROPONMLKJIHGFEDCBA’, the obtained incomplete inverse alphabetical letters sequence ‘UTS’ yields the open proto-bigram term ‘US’ by removing the contiguous single letter ‘T’ and compressing the remaining letters. Likewise, for the incomplete inverse alphabetical letters sequence ‘IHGF’, by removing the ‘H’ and ‘G’ single letters, the user can form the open proto-bigram term ‘IF.’

An open proto-bigram ‘identity’ will still be herein considered valid/true even if the two single letters forming an assigned open proto-bigram are separated from each other by one, two or more contiguous letters in a given letters sequence. In contrast, the identity of an open-bigram is conserved if the separation between the two letters forming the open-bigram does not exceed more than two letters located in between these two letters.

In another example, for the presented direct alphabetical letters sequence ‘ABCDEFGHIJKLMNOPQRSTUVWXYZ’, a direct incomplete letters sequence ‘AMNOPQRSTUVWXYZ’ is obtained by first removing the contiguous located in between single letters ‘B’, ‘C’, ‘D’, ‘E’, ‘F’, ‘G’, ‘H’, ‘I’, ‘J’, ‘K’ and ‘L’, and then compressing the remaining two letters sequences ‘A’ and ‘MNOPQRSTUVWXYZ’ to form the assigned open proto-bigram term ‘AM’. Likewise, for the inverse complete alphabetical letters' sequence ‘ZYXWVUTSROPONMLKJIHGFEDCBA’, another incomplete inverse alphabetical letters sequence ‘SRQPO’ yields the open proto-bigram term ‘SO’ after removing the contiguous single letters ‘R’, ‘Q’, and ‘P.’, and then compressing the remaining two letters sequences.

Compression after the removal of up until two contiguous letters is herein denominated a “local compression”, and after removal of more than two contiguous letters is herein denominated “non-local compression. Nevertheless, it should be understood that the removed letters are those lying in between the two explicitly visually recognized letters of an assigned open proto-bigram term. In all open bigrams which are not of the open proto-bigram class, only a local compression is possible.

In the present Example 1, there are 4 consecutive block exercises for a subject to perform. Block exercises #1 and #2 each have 2 trial exercises that display either a single direct or inverse selected alphabetic letters sequence. In block exercises #3 and #4, only a single trial exercise is provided per block exercise, each displaying only one selected non-alphabetical serial order of different or same letters sequence. The letters sequences displayed in each trial exercise are selected from two libraries of letters sequences: one comprising alphabetical and non-alphabetical serial order letters sequences and the other comprising open proto-bigrams sequences. Further, there are time periods between performing each block exercise. Let Δ₁ herein represent a time period between the performances of each block exercise, where Δ₁ is herein defined to be 8 seconds. There are also a time periods between performing each trial exercise. Let Δ₂ herein represent a time period between the performances of each trial exercise, where Δ₂ is herein defined to be 4 seconds.

For all trial exercises of Example 1, let time interval tₒ herein represent a time interval where all open proto-bigram terms displayed in any alphabetical or non-alphabetical serial order letters sequence and in any open proto-bigrams sequence displayed in the ruler appear in their respective default spatial or time perceptual related attribute condition. Time interval tₒ is herein 3 seconds. Still, let time intervals T_{red} and T_{blue} herein respectively represent a time interval at the end of each trial exercise, where the obtained incomplete direct or inverse alphabetical and different or same non-alphabetical serial order letters sequences will reveal all or some of the assigned open proto-bigram terms to be displayed in time perceptual related attribute red color or blue color. Time intervals T_{red} and T_{blue} are herein 6 seconds each.

For block exercises #3 and #4, let time intervals T_{size}, T_{type} and T_{bold} (it is also possible to implement time perceptual related attribute T_{flickering}) each respectively represent, a time interval at the end of a trial exercise, where all obtained incomplete different and same non-alphabetical serial order letters sequences, explicitly display all or some of the exposed assigned open proto-bigram terms in a spatial perceptual related attribute such as: font size, font type, and/or font boldness. Time intervals T_{size}, T_{type} and T_{bold} are herein 6 seconds each.

The exercises of present Example 1 provide the subject with a complete direct or inverse open proto-bigrams sequence graphically shown as a ruler. The visual presence of the ruler has a dual perceptual role: 1) perceptually indicates/signals the subject to the assigned open proto-bigram term via effecting changes in its spatial or time perceptual related attribute, and 2) displays a number of letter pairs all forming open proto-bigram terms, to facilitate the ability of the subject to concentrate and visually recognize the assigned open proto-bigram term(s) from a direct or inverse alphabetical or non-alphabetical serial order of letters sequence. The presence of a ruler also informs the subject of the kind and amount of open proto-bigram terms potentially available to be exposed. Further, the ruler comprises one of a plurality of open proto-bigrams sequences from a library of open proto-bigrams sequences including at least: complete open proto-bigrams sequence, direct open proto-bigrams sequences, and inverse open proto-bigrams sequences.

In an aspect of the present exercises, each open proto-bigram term aimed to be exposed from a provided letters sequence observes a change in one of its default spatial or time perceptual related attributes of its two letters, immediately after being revealed from the letters sequence. The spatial or time perceptual related attributes that may change include: 1) font type, 2) font size 3) font boldness, and 4) font flickering. In a non-limiting example, ‘font color’ of an open proto-bigram term may be selected from 1) font red color and 2) font blue color.

As a general rule influencing the behavior of the entire block exercises in the presented Example 1, as the user continues to remove letters and then compresses the remaining letters sequences, the length of each obtained new incomplete letters sequence will necessarily keep shortening. It should be also obvious that the sequence shortening taking place will reach a letters sequence length limit where it will no longer be possible to continue exposing additional open proto-bigram terms. It is further noted that the removal of all of the letters from any letters sequence may be performed at once or after a predefined time interval. In the particular case where letters are removed individually, one at time, each letter removal time span may be implemented by a first predefined time interval. Thereafter, the compression of the entire letters sequence is then executed during a second predefined time interval.

In a particular embodiment, the subject is given a first predefined time period perform a sensory motor activity indicative of a conscious recognition of the presence of the at least two non-consecutive letters forming the one selected open proto-bigram. The first predefined time period may be within a range of 10 to 20 seconds. The subject is then required to remove all of the letters between a selected open proto-bigram that has been consciously recognized during a second predefined time period that ranges between 1 and 5 seconds for each letter to be removed. Further, a third predefined time interval between the removal of each individual letter in between the recognized open proto-bigram term may be between 1 and 3 seconds per letter. Thereafter, the fourth predefined time interval during which the two remaining letters sequences are compressed may range from 1 to 3 seconds.

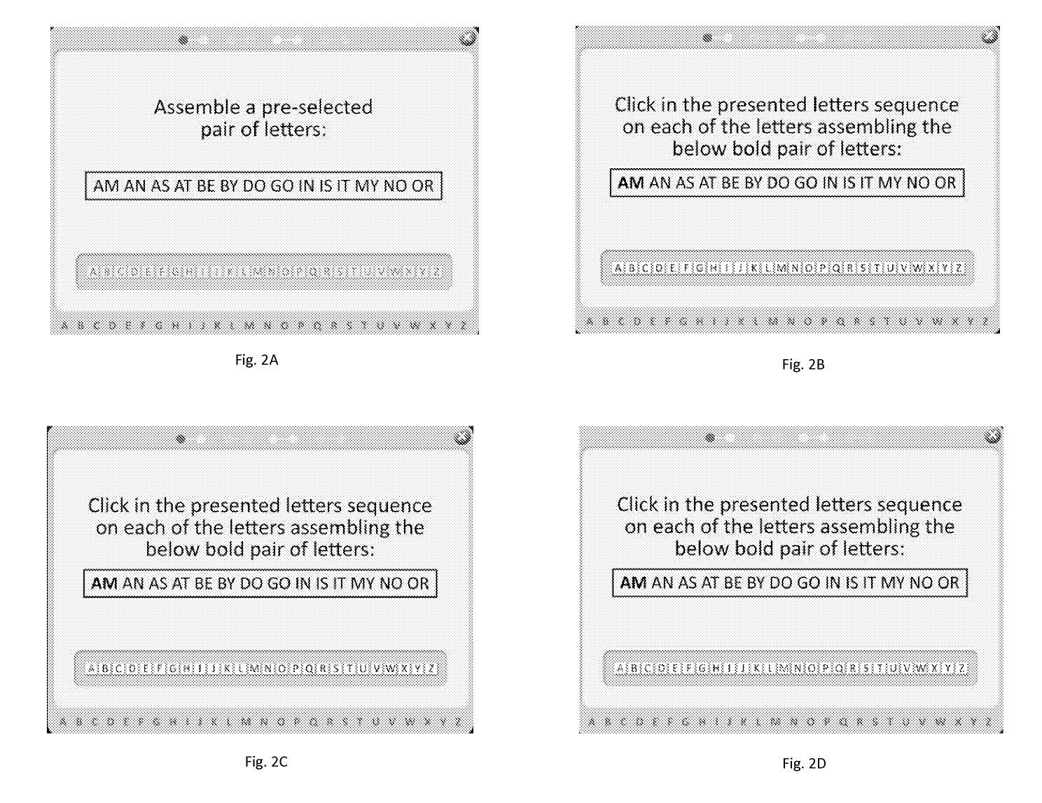

In block exercise 1, the subject is required to reason in order to mentally simulate the removal of one or more contiguous letters (aided by attentional inhibition-ignoring) located in between the two visually recognized letters forming an assigned open proto-bigram term which the subject must subsequently sensory motor select (mouse click). As shown in FIG. 2A, the subject is provided with a direct alphabetical letters sequence to rapidly visually search, and expose an assigned open proto-bigram. In FIG. 2B, the assigned open proto-bigram term ‘AM’ is displayed in spatial perceptual related attribute font boldness in the direct open proto-bigrams sequence shown in the ruler. The subject is required to reason and visually recognize the designated pair of letters ‘A’ and ‘M’. To remove the one or more contiguous letters located in between letters ‘A’ and ‘M’, the subject should sensory motor click with the mouse-device on the first valid letter of the pair of letters forming the assigned open proto-bigram term and without delay proceed to sensory motor select (e.g., mouse click) on the second valid letter of the pair. In FIGS. 2C and 2D, the selected letters ‘A’ and ‘M’ of the assigned open proto-bigram term are displayed with time perceptual related attribute font red color. In FIG. 2E, the assigned open proto-bigram term ‘AM’ is displayed with time perceptual related attribute font red color in the new obtained incomplete direct alphabetical letters sequence as well as in the direct open proto-bigrams sequence in the ruler.

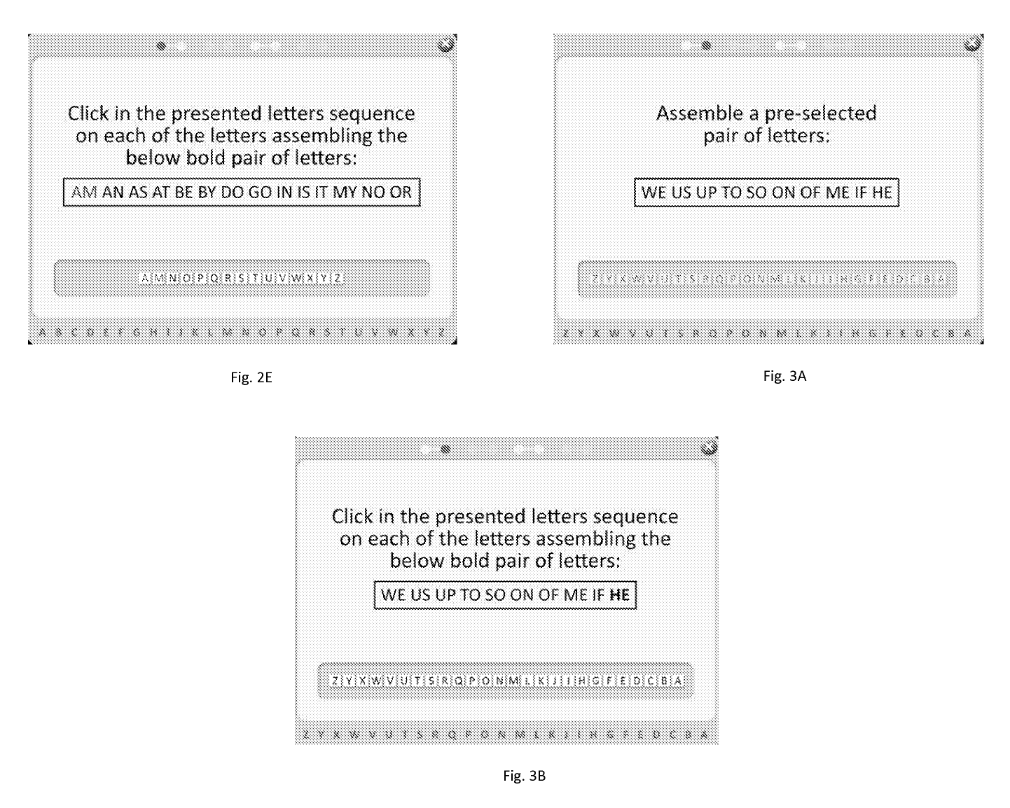

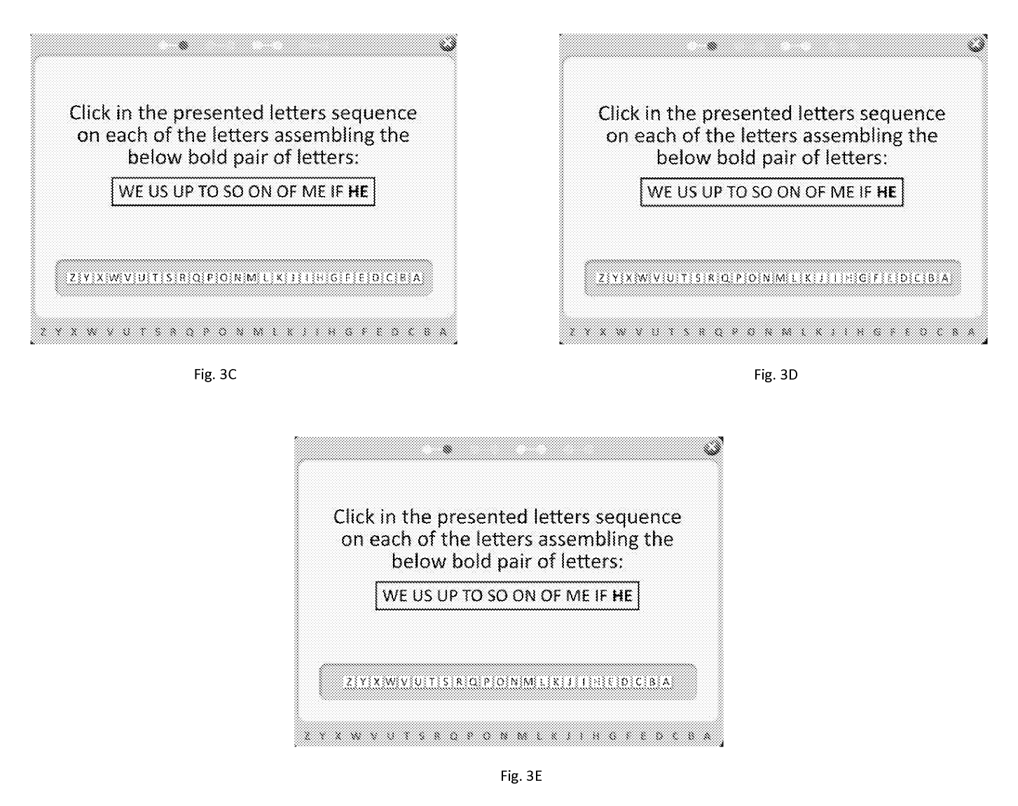

In another example, the subject is provided with an inverse alphabetical letters sequence, like that shown in FIG. 3A, to rapidly visually search and explicitly recognize the letters of an assigned open proto-bigram term. In FIG. 3B, the assigned open proto-bigram term ‘HE’ is displayed in spatial perceptual related attribute font boldness in the inverse open proto-bigrams sequence shown in the ruler. The subject is required to reason, visually recognize and sensory motor select the designated pair of letters ‘H’ and ‘E’. In FIGS. 3C and 3D, the selected letters ‘H’ and ‘E’ of the assigned open proto-bigram term ‘HE’ are displayed with time perceptual related attribute blue font color. FIG. 3E shows the assigned open proto-bigram term ‘HE’ displayed with time perceptual related attribute font blue color in the new obtained incomplete inverse alphabetical letters sequence as well as in the inverse open proto-bigrams sequence in the ruler. The remaining letters sequences ‘ZYXWVUTSRQPONMLKJI’ and ‘DCBA’ are displayed with the revealed open proto-bigram term ‘HE’.

In block exercise 2, the subject is again required to reason, visually explicitly recognize, and sensory motor select (e.g., mouse clicking) one or more assigned open proto-bigram terms. For each trial exercise, a number of assigned open proto-bigrams for the subject to expose will be selected. In a non-limiting example, the number of assigned open proto-bigram terms is 2 or 3.

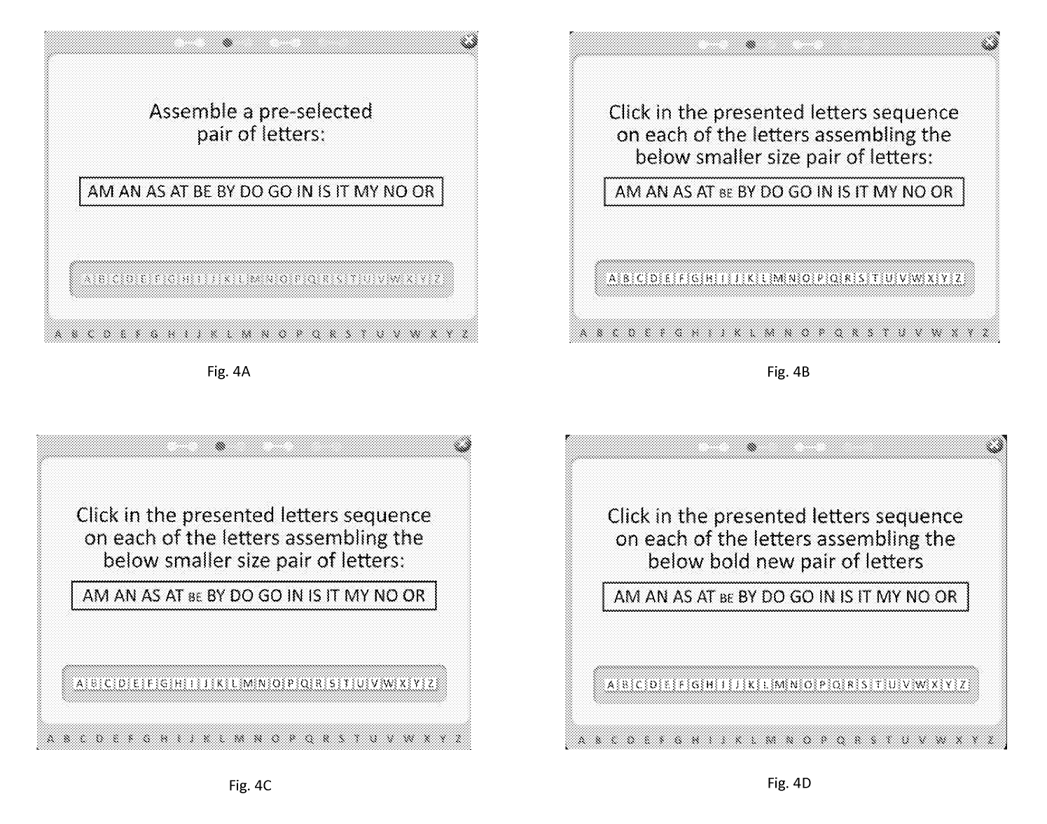

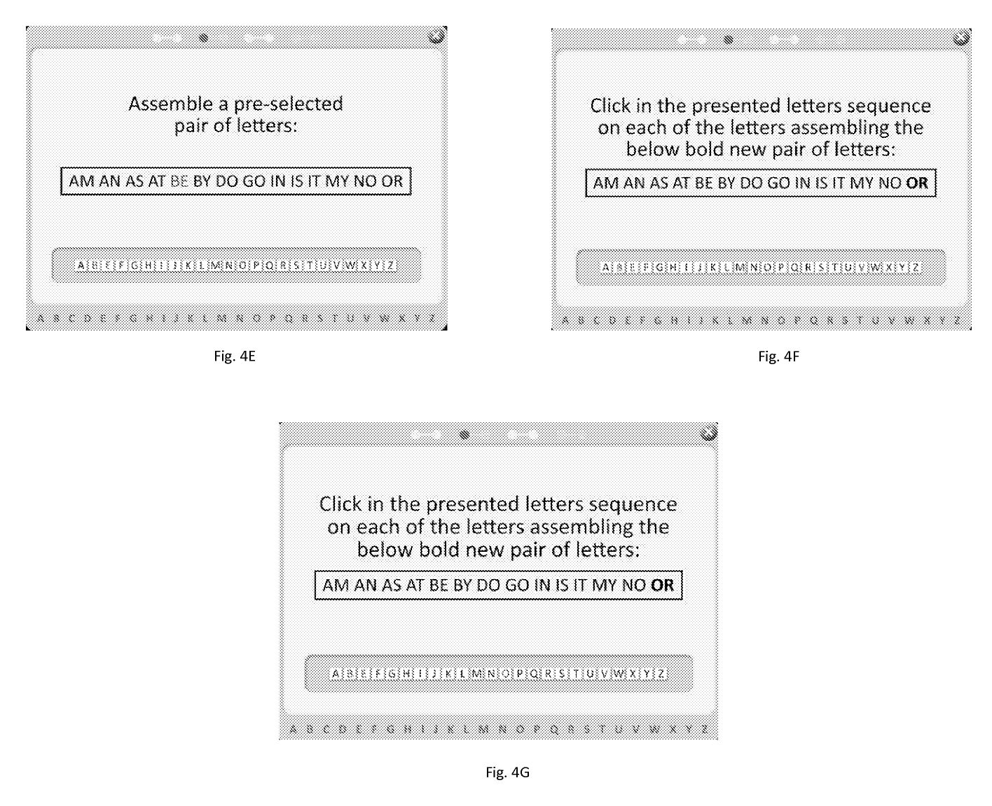

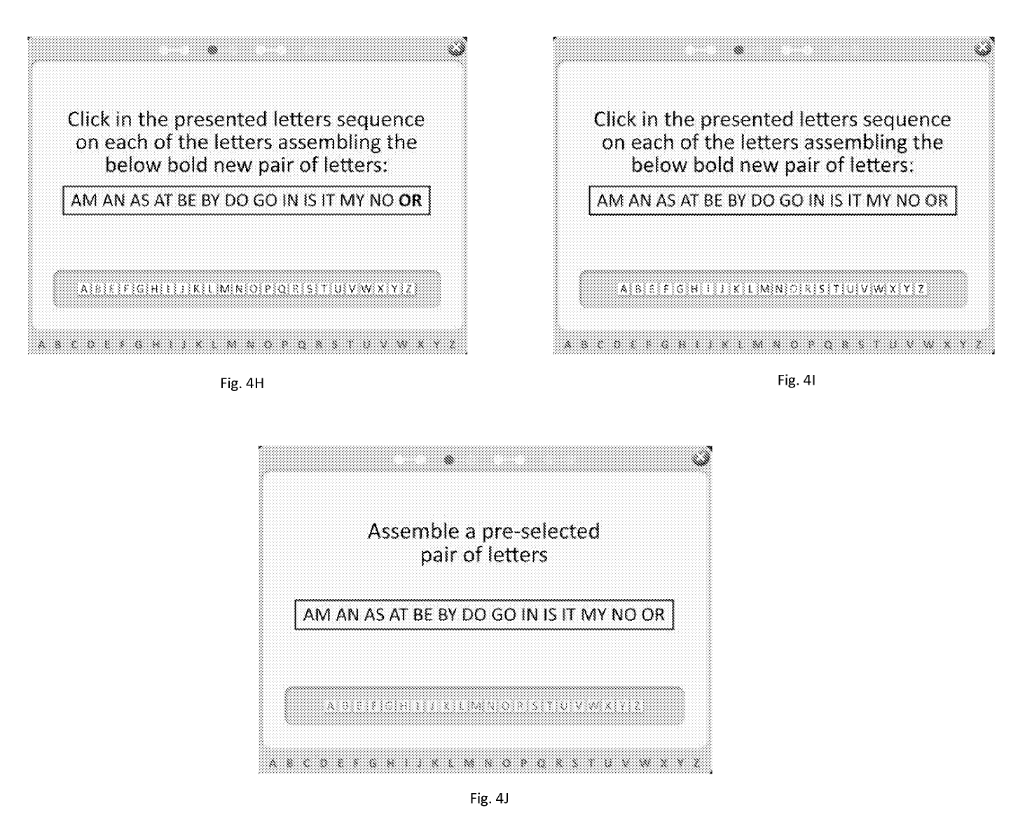

As shown in FIG. 4A, the subject is presented with a direct alphabetical letters sequence to rapidly visually search, explicitly recognize, and sensory-motor select the letters forming an assigned open proto-bigram. In FIG. 4B, assigned open proto-bigram term ‘BE’ is displayed in a spatial perceptual related attribute (smaller) font size in the direct open proto-bigrams sequence shown in the ruler. The subject is required to sensory motor select the designated pair of letters B′ and ‘E’. To that end, the subject should sensory motor click, with the mouse-device or other preselected means, on the first valid letter of the pair of letters forming the assigned open proto-bigram term and without delay proceed to click with the mouse-device on the second valid letter of the pair of letters forming the assigned open proto-bigram term. In FIGS. 4C and 4D, the sensory motor selected letters ‘B’ and ‘E’ are displayed with time perceptual related attribute font red color. Next, FIG. 4E shows the assigned open proto-bigram term ‘BE’ displayed with time perceptual related attribute red font color in the new obtained incomplete direct alphabetical letters sequence as well as in the direct open proto-bigrams sequence in the ruler.

In FIG. 4F, the new obtained incomplete direct alphabetical letters sequence from FIG. 4E is presented to the subject along with a second assigned open proto-bigram term ‘OR’ displayed with spatial perceptual related attribute font boldness in the direct open proto-bigrams sequence shown in the ruler. The subject is again required to reason, visually explicitly recognize, and sensory motor select the designated pair of letters ‘O’ and ‘R’. In FIGS. 4G and 4H, the selected letters ‘O’ and ‘R’ of the second assigned open proto-bigram are displayed with time perceptual related attribute font red color. As shown in FIG. 4I, the revealed assigned open proto-bigram term ‘OR’ is displayed in time perceptual related attribute font red color in the new obtained incomplete direct alphabetical letters sequence as well as in the direct open proto-bigrams sequence in the ruler. It is noted that the previously revealed assigned open proto-bigram term BE′ is also displayed with time perceptual related attribute font red color. When the last assigned open proto-bigram term is selected, all of the exposed assigned open proto-bigram terms are displayed in time perceptual related attribute font red color for time interval T_{red} in the final obtained incomplete direct alphabetical letters sequence, as shown in FIG. 4J.

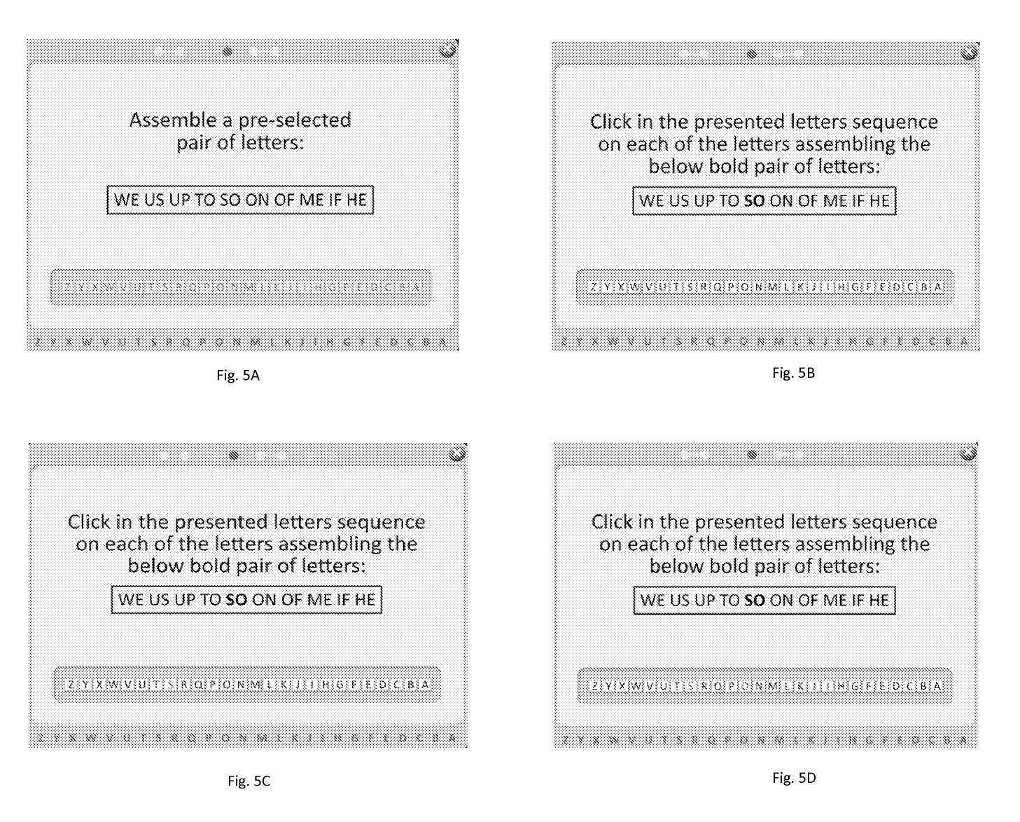

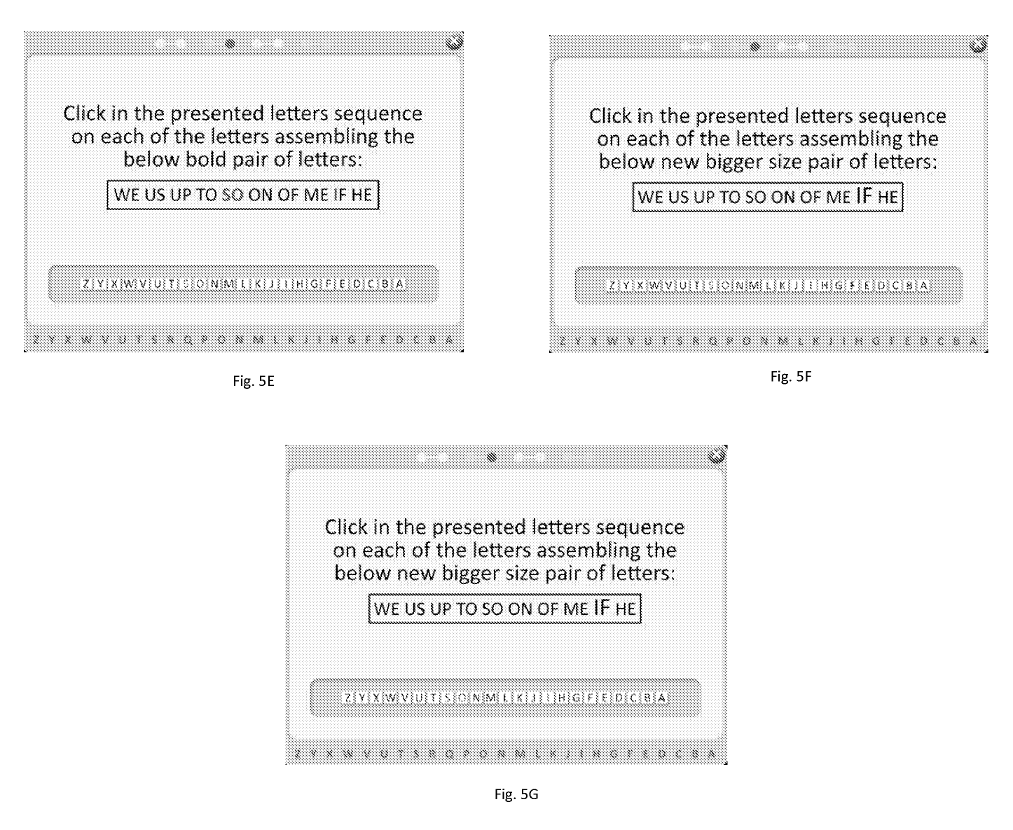

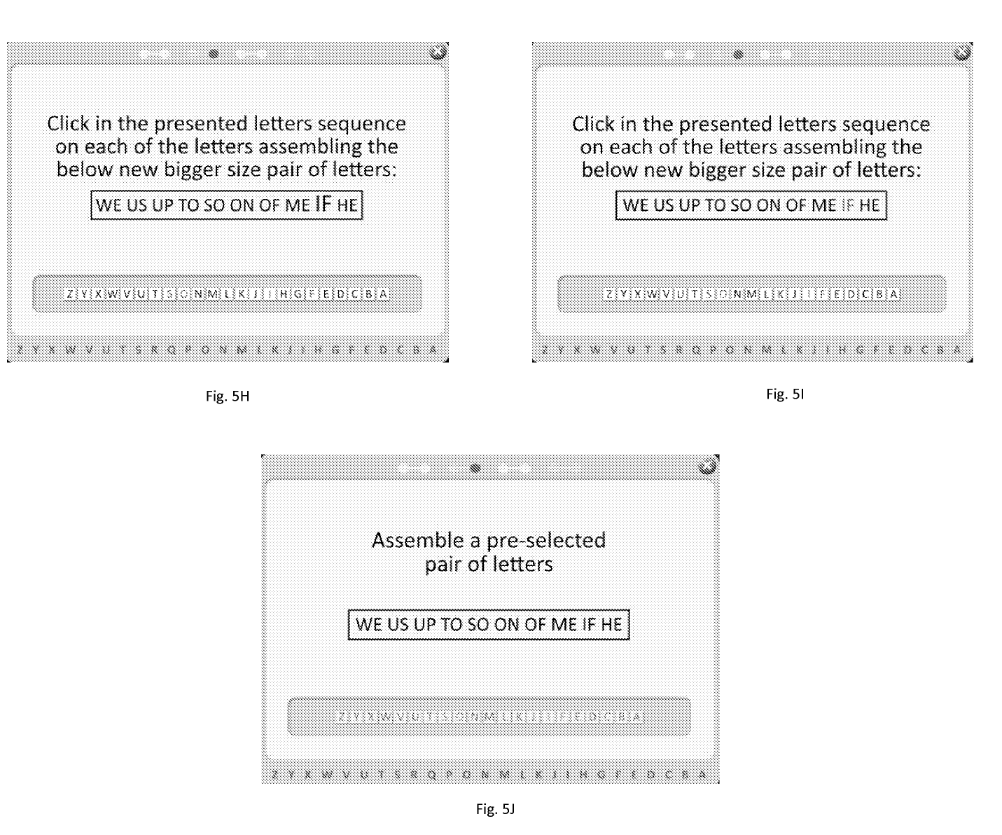

Similarly, the subject is provided with an inverse alphabetical letters sequence, like that shown in FIG. 5A, to rapidly visually search, explicitly recognize, and sensory motor select (e.g., mouse clicking) an assigned open proto-bigram of another example. In FIG. 5B, the assigned open proto-bigram term ‘SO’ is displayed with spatial perceptual related attribute font boldness in the inverse open proto-bigrams sequence shown in the ruler. In FIGS. 5C and 5D, the selected letters ‘S’ and ‘O’ are displayed with time perceptual related attribute font blue color. FIG. 5E shows revealed assigned open proto-bigram term ‘SO’ displayed in time perceptual related attribute blue font color in the new obtained incomplete inverse alphabetical letters sequence as well as in the inverse open proto-bigrams sequence in the ruler.

In FIG. 5F, a second assigned open proto-bigram term ‘IF’ is displayed with spatial perceptual related attribute font boldness in the direct open proto-bigrams sequence shown in the ruler. FIGS. 5G and 5H show the selected letters ‘I’ and ‘F’ of the assigned open proto-bigram term ‘IF’ displayed with time perceptual related attribute font blue color. Revealed open proto-bigram term ‘IF’ is displayed with time perceptual related attribute font blue color in the new obtained incomplete direct alphabetical letters sequence as well as in the direct open proto-bigrams sequence in the ruler in FIG. 5I. Once all of the assigned open proto-bigram terms have been revealed, as shown in FIG. 5J, they are displayed in time perceptual related attribute font blue color for time interval T_{blue} in the final obtained incomplete inverse alphabetical letters sequence.

In block exercise 3, the subject is required to reason, visually explicitly recognize, and sensory motor select (e.g., mouse clicking) a number of letters from a selected complete non-alphabetical serial order of different letters sequence in order to expose one or more assigned open proto-bigram terms. To that effect, a number of assigned open proto-bigram terms for the subject to expose are selected for the single trial exercise of block exercise 3. In a non-limiting example, the number of assigned open proto-bigram terms is 2 or 3.

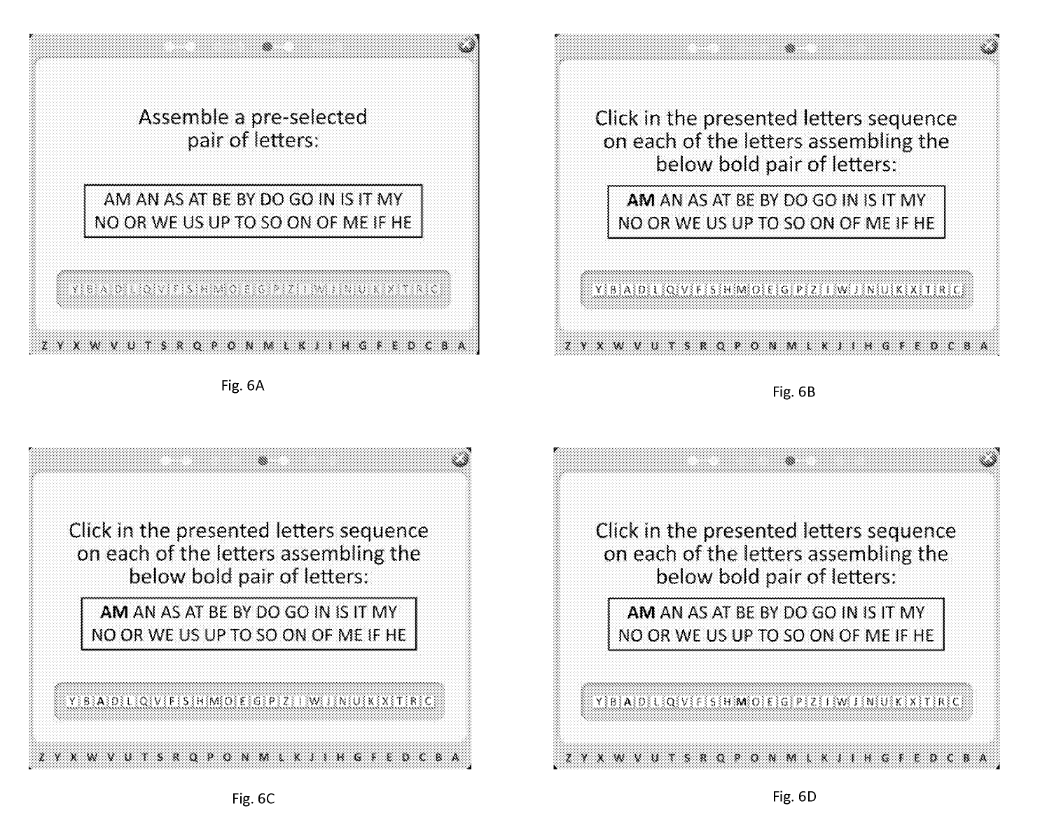

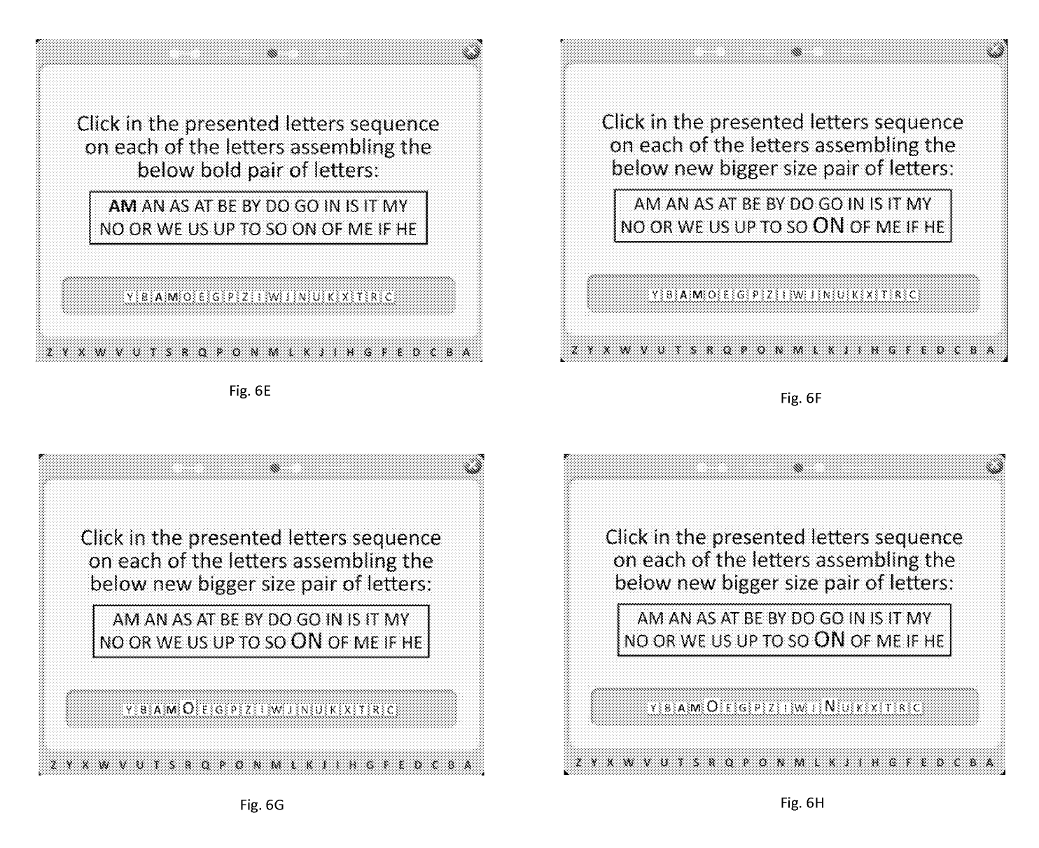

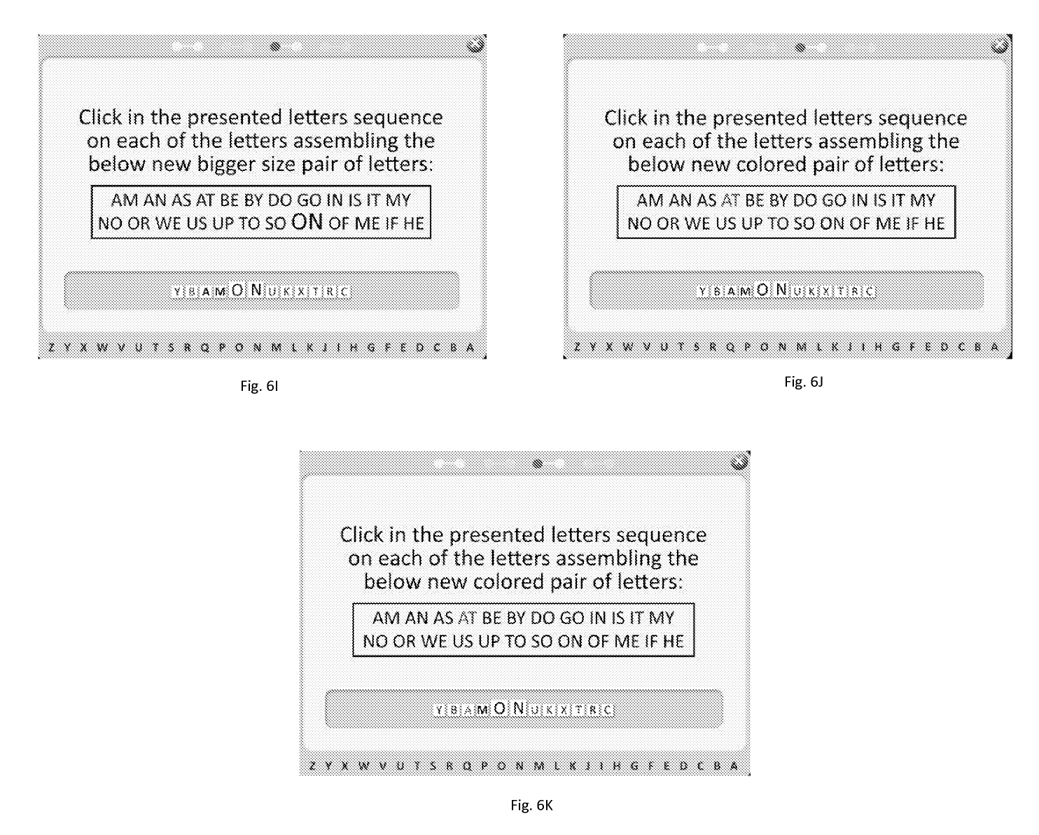

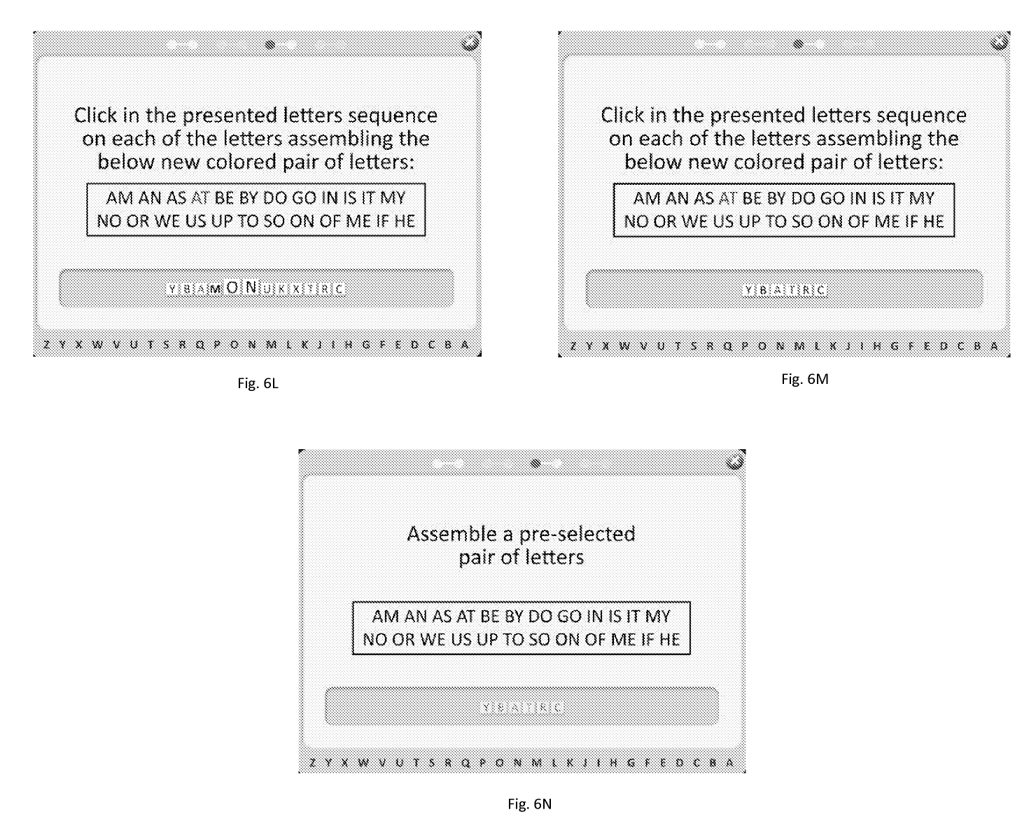

As shown in FIG. 6A, the spatial and time perceptual related attributes are set to default values for the selected complete non-alphabetical serial order of different letters sequence and the complete open proto-bigrams sequence displayed in the ruler. In FIG. 6B, the assigned open proto-bigram term ‘AM’ is displayed with spatial perceptual related attribute font boldness in the direct open proto-bigrams sequence shown in the ruler. The subject is required to reason, visually explicitly recognize, and sensory motor select the designated pair of letters ‘A’ and ‘M’. Accordingly, the subject is required to sensory motor click, with the mouse-device or with other predefined means, on the first valid letter of the pair of letters forming the assigned open proto-bigram term and without delay proceed to sensory motor click on the second valid letter of the pair. In FIGS. 6C and 6D, the selected letters ‘A’ and ‘M’ are displayed with time perceptual related attribute font boldness. FIG. 6E shows revealed assigned open proto-bigram term ‘AM’ displayed with time perceptual related attribute font boldness in the first new obtained incomplete non-alphabetical different letters sequence as well as in the direct open proto-bigrams sequence in the ruler.

In FIG. 6F, assigned open proto-bigram term ‘ON’ is displayed in a spatial perceptual related attribute larger font size in the direct open proto-bigrams sequence shown in the ruler. The subject is required to follow the same procedure as before. FIGS. 6G and 6H show the selected letters ‘O’ and ‘N’ displayed with spatial perceptual related attribute larger font size. As shown in FIG. 6I, revealed assigned open proto-bigram term ‘ON’ is displayed in spatial perceptual related attribute larger font size in the second new obtained incomplete non-alphabetical different letters sequence as well as in the direct open proto-bigrams sequence in the ruler.

In FIG. 6J, a third assigned open proto-bigram term ‘AT’ is displayed with time perceptual related attribute red color in the direct open proto-bigrams sequence shown in the ruler along with the second new obtained incomplete non-alphabetical different letters sequence displaying the previously identified assigned open proto-bigram terms ‘AM’ and ‘ON’. In FIGS. 6K and 6L, the selected letters ‘A’ and ‘T’ are displayed with time perceptual related attribute font red color. As shown in FIG. 6M, revealed assigned open proto-bigram term ‘AT’ is displayed in time perceptual related attribute font red color in the third new obtained incomplete non-alphabetical different letters sequence as well as in the direct open proto-bigrams sequence in the ruler. Once the last assigned open proto-bigram term ‘AT’ has been exposed, it is displayed in time perceptual related attribute font red color for time interval T_{red} in the final obtained incomplete non-alphabetical different letters sequence, as shown in FIG. 6N.

In block exercise 4, the subject is required to reason in order to mentally simulate the removal (aided by attentional inhibition-ignoring) of one or more serially ordered contiguous letters from a selected non-alphabetical serial order of same letters sequence to explicitly expose one or more assigned open proto-bigram terms. The selected non-alphabetical serial order of same letters sequence comprises 26 letters, but some of the letters included therein are duplicates. Stated another way, there are a number of letters that appear in the sequence repetitively. Therefore, when considering the English alphabet, some of the letters will be missing from a given non-alphabetical serial order of same letters sequence.

A number of assigned open proto-bigram terms for the subject to expose are selected for the single trial exercise of block exercise 3. In this case, the number of assigned open proto-bigram terms to be exposed is from 1 to 4. Further, a number of single letters are selected to be repeated within a selected non-alphabetical serial order of same letters sequence. Here, the number of single letters to be repeated is from 2 or 3. The kind of single letters that are allowed to be repeated in a selected non-alphabetical serial order of same letters sequence may be initially chosen by a predefined method or at random. Additionally, each chosen single letter is also repeated within a selected non-alphabetical serial order of same letters sequence a number of times. Here, the number of times each single letter is repeated for a given same letters sequence is from 1 to 3 times per letter.

Each selected non-alphabetical serial order of same letters sequence will include by default, as a minimum, a complete set of vowels: A, E, I, O and U. However, not all of the vowels will be located at their respective alphabetical serial order positioning in the selected non-alphabetical serial order of same letters sequence. In fact, the serial order positioning for most of the vowels in the selected non-alphabetical serial order of same letters sequence will be non-alphabetical.

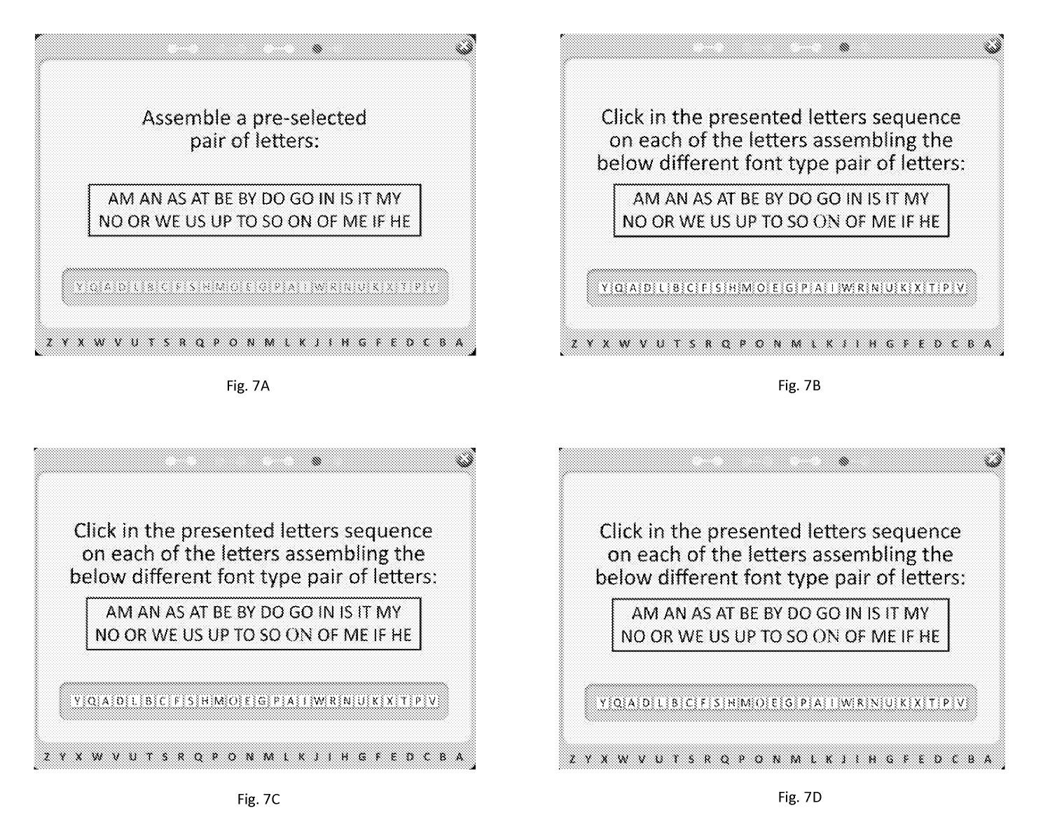

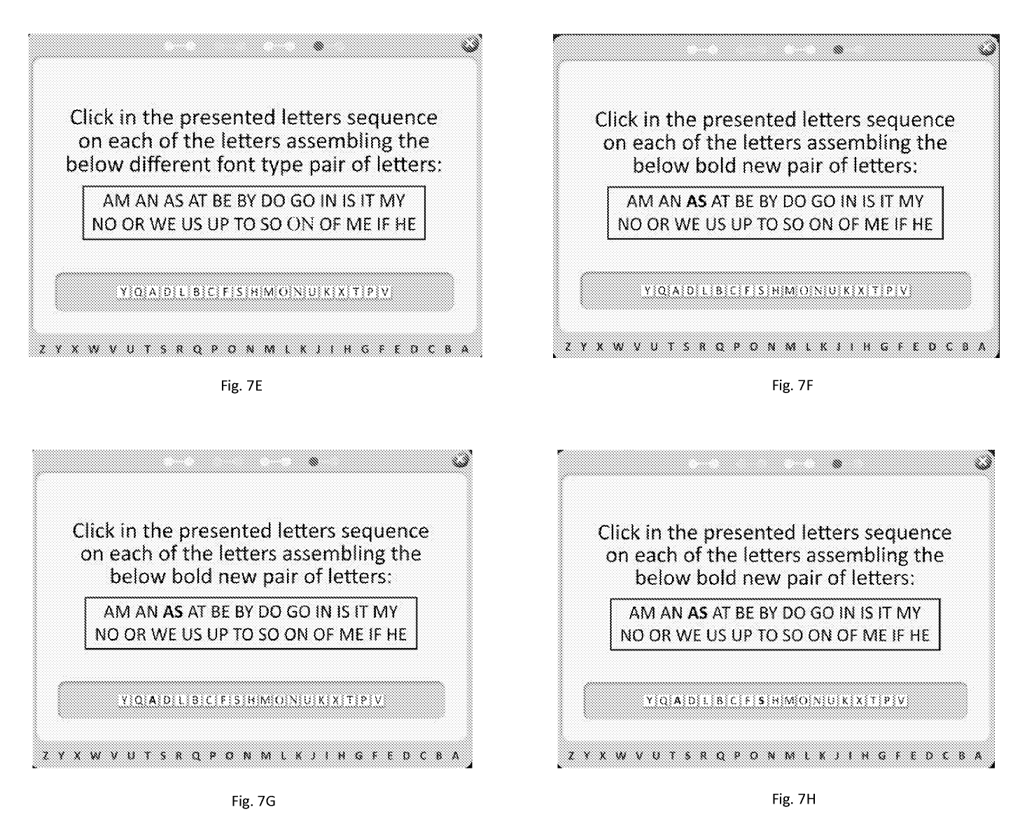

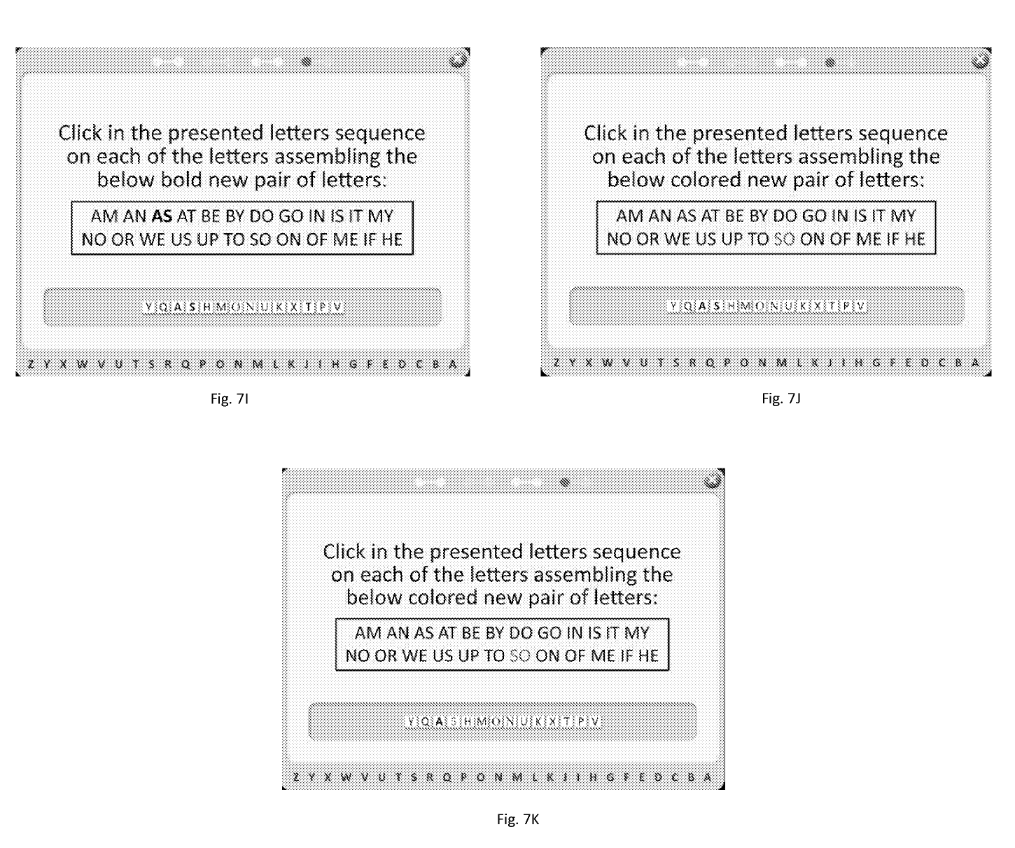

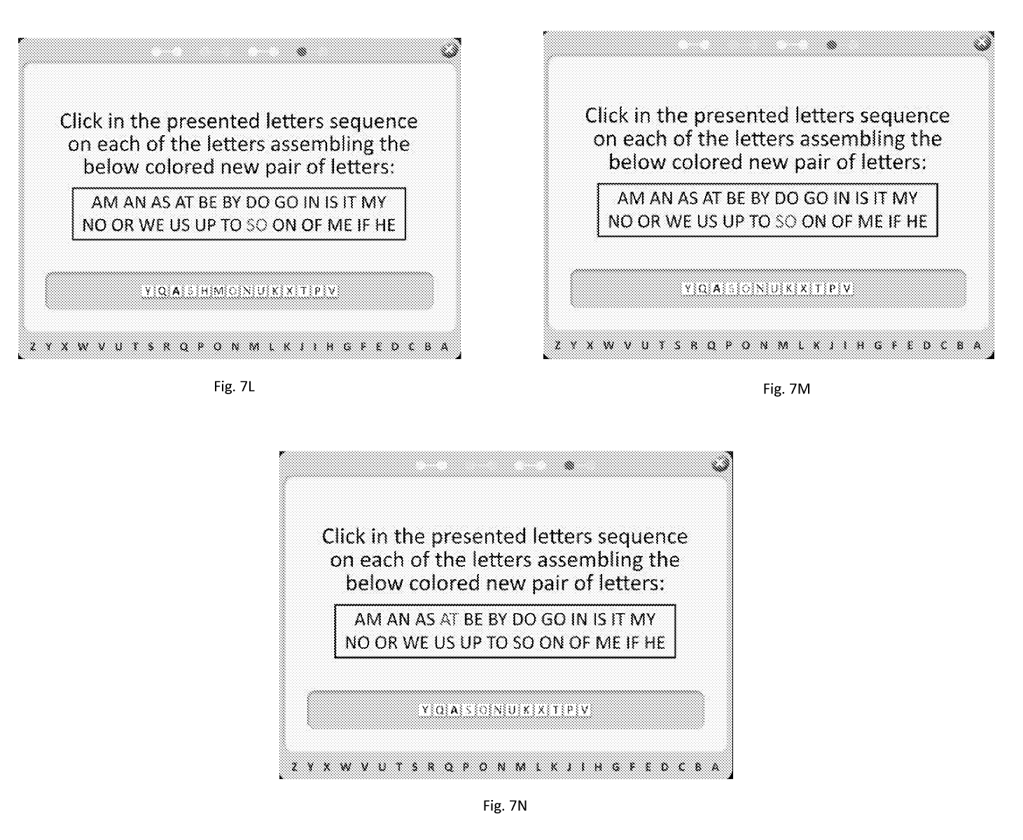

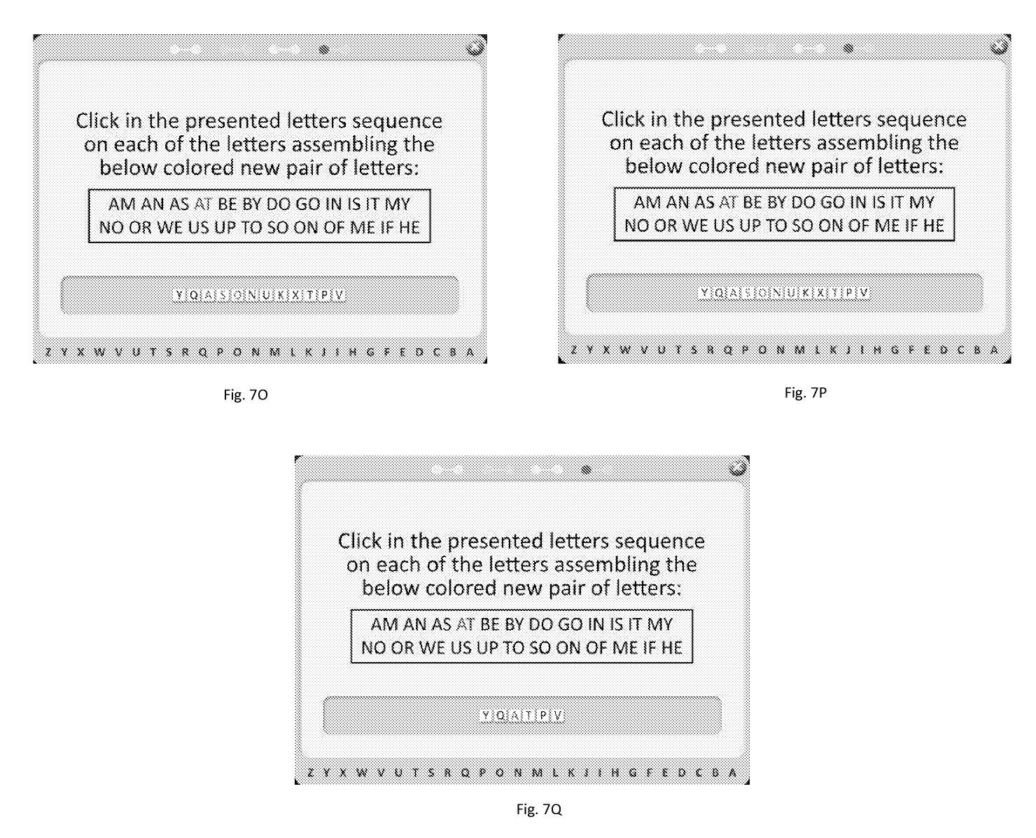

As shown in FIG. 7A, the spatial and time perceptual related attributes of the letters are set to default values for the selected non-alphabetical serial order of same letters sequence and the complete open proto-bigrams sequence displayed in the ruler. In FIG. 7B, the assigned open proto-bigram term ‘ON’ is displayed in a spatial perceptual related attribute font type in the direct open proto-bigrams sequence shown in the ruler. The subject is required to follow the same procedure as in previous block exercises. In FIGS. 7C and 7D, the selected letters ‘O’ and ‘N’ are displayed with spatial perceptual related attribute font type. FIG. 7E shows revealed assigned open proto-bigram term ‘ON’ is displayed in spatial perceptual related attribute font type in the first new obtained incomplete non-alphabetical same letters sequence as well as in the complete open proto-bigrams sequence in the ruler.

In FIG. 7F, a second assigned open proto-bigram term ‘AS’ is displayed in a spatial perceptual related attribute font boldness in the direct open proto-bigrams sequence shown in the ruler. In FIGS. 7G and 7H, the selected letters ‘A’ and ‘S’ are displayed with spatial perceptual related attribute font boldness. As shown in FIG. 7I, revealed assigned open proto-bigram term ‘AS’ is displayed in spatial perceptual related attribute font boldness in the second new obtained incomplete non-alphabetical same letters sequence as well as in the complete open proto-bigrams sequence in the ruler. The previously revealed assigned open proto-bigram term ‘ON’ is also displayed in spatial perceptual related attribute font type in the second new obtained incomplete non-alphabetical same letters sequence.

In FIG. 7J, a third assigned open proto-bigram term ‘SO’ is displayed in time perceptual related attribute font blue color in the complete open proto-bigrams sequence shown in the ruler. FIGS. 7K and 7L show each of the selected letters ‘S’ and ‘O’ displayed with time perceptual related attribute font blue color. As shown in FIG. 7M, revealed assigned open proto-bigram term ‘SO’ is displayed in time perceptual related attribute font blue color in the third new obtained incomplete non-alphabetical same letters sequence as well as in the complete open proto-bigrams sequence in the ruler.

In FIG. 7N, a fourth assigned open proto-bigram term ‘AT’ is displayed in time perceptual related attribute font red color in the complete open proto-bigrams sequence shown in the ruler. In FIGS. 7O and 7P, the selected letters ‘A’ and ‘T’ are displayed with time perceptual related attribute font red color. As shown in FIG. 7Q, revealed assigned open proto-bigram term ‘AT’ is displayed in time perceptual related attribute font red color in the fourth new obtained incomplete non-alphabetical same letters sequence as well as in the complete open proto-bigrams sequence in the ruler. Once the last assigned open proto-bigram term ‘AT’ has been exposed, it is displayed in time perceptual related attribute font red color for time interval T_{red} in the fourth and final obtained incomplete non-alphabetical same letters sequence.

The methods implemented by the exercises of Example 1 also contemplate those situations in which the subject fails to perform the given task. The following failing to perform criteria is applicable to any exercise in any block exercise of the present task in which the subject fails to perform. Specifically, for the present exercises, there are two kinds of “failure to perform” criteria. The first kind of “failure to perform” criteria occurs in the event the subject fails to perform by not sensory motor click-selecting (the subject remains inactive/passive) with the hand-held mouse device on any single letter from a pair of letters forming an assigned open proto-bigram term within a valid performance time period, such as 30 seconds; a new same kind of trial exercise is then executed immediately thereafter for the subject to begin performing from scratch.

The second “failure to perform” criteria is in the event the subject fails to perform by sensory motor selecting (e.g., mouse clicking) an incorrect single letter from a pair of letters forming an assigned open proto-bigram term in its respective initial selected or subsequently new obtained incomplete alphabetical or non-alphabetical serial order of letters sequence. An incorrect sensory motor selection is immediately undone by the computer program allowing the subject to make another sensory motor selection. However, if the subject makes an incorrect single letter sensory motor selection three (3) consecutive times, then the trial exercise at hand is immediately terminated and a new same kind of trial exercise is then executed to be performed from scratch. Still, if the subject's performance exceeds 2 attempts of the same type of trial exercises in any block exercise of Example 1, performance of the current block exercise is immediately ended and the next in-line block exercise begins. Further, if the subject exceeds 2 attempts of the same type of trial exercises in more than 2 block exercises of Example 1, performance of the present Example 1 is immediately terminated and the subject is automatically returned to the main menu.

The total duration to complete the exercises of Example 1, as well as the time it took to implement each one of the individual trial exercises, is registered in order to help generate an individual and age-gender group performance score. Incorrect sensory motor selections of letters are also recorded and counted as part of the subject's performance score. In general, the subject will perform the exercises of Example 1 about 6 times during his/her language based neuroperformance training program.

### Example 2

### Reasoning to Perform a Mental Simulation Concerning the Serial Local or Non-Local Extraordinary Compression of a Given Letters Sequence by Removing One or More Contiguous Letters Located in Between a Target Pair of Letters in a Letters Sequence to Form/Assemble and Explicitly Expose an Assigned Open Proto-Bigram Term

A goal of the presented Example 2 is to promote a subject's cognitive fluid reasoning ability to problem solve a local or non-local compression of a given letters sequence. To that effect, a subject is required to visually search and recognize the particular location of the assigned pair of letters in the given letters sequence, followed by performing a local or non-local compression of the given letters sequence by removing one or more contiguous letters located in between the visually recognized pair of letters forming the assigned open proto-bigram. This particular cognitive reasoning activity is implemented by the subject in order to problem solve a letters sequence task that requires a process of mental simulation centered in tearing down-omitting (attentional inhibiting sort of removing-ignoring) one or more contiguous letters located in between a target pair of letters to assemble and explicitly expose an assigned open proto-bigram term.

In the context of present Example 2, the subject uses fluid reasoning ability in order to perform a problem solving that requires a mental simulation of serially removing (aided by attentional inhibition/ignoring) one or more contiguous letters. This fluid reasoning aptitude herein refers specifically to a method of reasoning that focuses on a sequential fraction of letters in a letters sequence such that the user mentally simulates the serial removal (aided by attentional inhibition/ignoring) of one or more contiguous letters located in between a designated pair of letters as previously discussed in Example 1. This fluid reasoning problem solving ability manifesting a subject's ability to mentally simulate the serial removal of a number of contiguous letters held in between an assigned pair of non-contiguous letters from a letters sequence is followed by the subject's sensory-motor selection of the recognized pair of letters in the letters sequence, which is then immediately followed by the removal of one or more contiguous letters located in between this recognized pair of letters. The removal of one or more contiguous letters located in between the assigned open proto-bigram term triggers the implementation of a local compression or a non-local compression in case where more than two contiguous letters were removed from in between the assigned open proto-bigram term.

In another aspect of the present Example 2, the selected letters sequences (e.g., a non-alphabetic letters sequence) may be provided to the subject in the form of a letters matrix. For any given letters matrix, the letters may be arranged in a predefined number of rows where each row has a predefined number of letters per row. There is no particular limitation as to how the number of rows can be organized in the letters matrix.

In an aspect of the methods of Example 2, a perceptual awareness of the serial order of an alphabetic letter sequence is promoted in the subject. Particularly, this promotion of perceptual awareness in a subject may be achieved by providing the subject with one or more kinds of perceptual stimuli to facilitate the subject's discrimination of the two single letters forming an assigned open proto-bigram in the presented letters sequence. Kinds of perceptual stimuli may include one or more of visual, auditory, and tactile stimuli. In a non-limiting example, visual stimuli may be provided to the subject in the form of a ruler which distinctively displays an assigned open proto-bigram term to be consciously recognized by the subject in a selected letters sequence. Furthermore, the ruler may be considered to distinctively show an assigned open proto-bigram term through one or more spatial and/or time perceptual related attribute changes of the assigned open proto-bigram term, which differ from the spatial and/or time perceptual related attributes of the other open proto-bigram terms shown in the ruler and/or in the letters of the selected letters sequence.

In a further aspect of the present Example 2, sensory-motor selection activity is required to be performed by the subject to indicate conscious explicit recognition of the two letters forming the assigned open proto-bigram term in the selected letters sequence. This sensory-motor selection activity may include: mouse clicking on each letter; pointing at a single letter at a time with a finger while touching a screen where the selected letters sequence is displayed at the serial location where each letter is found; and spelling the name of each letter aloud, one at a time.

In present Example 2, some of the selected non-alphabetical letters sequences entail a particular serial order of letters where the first letter (head of the letters sequence) and last letter (tail of the letters sequence) form/assemble the assigned open proto-bigram term. In this case, the subject reasons to mentally simulate the serial removal (aided by a strong attentional inhibition-ignoring) of all of the contiguous letters located in between the first and last letters of the selected letters sequence. In the trial exercises of Example 2, some of the non-alphabetical serial orders of letters sequences are performed by the subject according to a method in which the head-tail pair of the letters sequence is explicitly exposed to form a single assigned open proto-bigram term. In this particular case, if there are more than two contiguous letters located in between the head and tail of the selected letters sequence which need to be removed, then an extraordinary non-local compression will take place. This particular kind of compression is in addition to the local and non-local compression already discussed in Example 1.

In the present Example 2, there are 2 consecutive block exercises, each having a single trial exercise, for a subject to perform. A number of complete non-alphabetical serial orders with different or some same letters in their letter sequences are selected from a library of non-alphabetical serial order letters sequences. The number of selected letters sequences may be 3. The exercises also permit a number of assigned open proto-bigram terms to be formed and explicitly exposed by a subject for any letters sequence. In a non-limiting example, the number of assigned open proto-bigram terms is from 1 to 7. Once a subject explicitly exposes an assigned open proto-bigram term, the correctly identified open proto-bigram term is displayed in the newly obtained incomplete non-alphabetical serial order of different or some same letters sequence. Thus, the number of newly obtained incomplete non-alphabetical serial order of different or some same letters sequences formed per trial exercise will necessarily depend on the number of assigned open proto-bigram terms in that particular exercise. Furthermore, the letters sequences displayed in each trial exercise are selected from two libraries of letters sequences: one comprising non-alphabetical serial order letters sequences and the other comprising open proto-bigrams sequences.

The exercises of present Example 2 provide the subject with a complete open proto-bigrams sequence graphically shown as a ruler. The visual presence of the ruler has a number of perceptual purposes: 1) perceptually indicates/signals the subject to a change in spatial or time perceptual related attribute of an assigned open proto-bigram term; 2) provides the subject visual orthographic information in order to better focus on the particular pairs of letters that form open proto-bigram terms thus facilitating the subject to reason in order to mentally simulate the serial removal (aided by attentional inhibition-ignoring) of one or more contiguous letters located in between the pairs of letters that form the assigned open proto-bigram term in the letters sequence; in essence, the ruler facilitates visual attentional pin-pointing of each single letter of a pair of letters forming an assigned open proto-bigram term, thus enabling a subject to visually attentionally ignore the one or more contiguous letters located in between the assigned pairs of letters; and 3) the ruler informs the subject of the kind and quantity of open proto-bigram terms potentially available to be formed and explicitly exposed in the particular selected letters sequence. In the present exercises, the ruler comprises one of a plurality of open proto-bigrams sequences from a library of open proto-bigrams sequences including at least: complete open proto-bigrams sequences, direct open proto-bigrams sequences, and inverse open proto-bigrams sequences.

In an aspect of the present exercises, each open proto-bigram term that is explicitly exposed from a provided letters sequence observes a change in one of its default spatial or time perceptual related attributes immediately after being revealed from the letters sequence. The spatial or time perceptual related attributes that may change include: 1) font type, 2) font size 3) font boldness 4) font color, and 5) font flickering. In a non-limiting example, ‘font color’ of an open proto-bigram term may be selected from 1) font red color and 2) font blue color.

For the exercises of present Example 2, there are time intervals between performances of block exercises. Let Δ₁ herein represent a time interval between the performances of block exercises, where Δ₁ is herein defined to be 8 seconds. Further, there are time intervals between the selected non-alphabetical serial order of different or some same letters in the letters sequences displayed in trial exercise #1 for block exercises #1 and #2. Let Δ₂ herein represent a time interval between the selected non-alphabetical serial order of different or some same letters sequences displayed in trial exercise #1 of block exercises #1 and #2, where Δ₂ is herein defined to be 2.5 seconds.

In an aspect of present Example 2, an explicitly exposed assigned open proto-bigram term will continue to display its respective spatial or time perceptual related attribute, in the selected letters sequence as well as in the complete open proto-bigrams sequence displayed in the ruler, for a period of t₁, where t₁ is herein defined to be 2 seconds. When a subject has explicitly exposed the very last assigned open proto-bigram term from the last obtained incomplete letters sequence in any of the present exercises, the last assigned open proto-bigram term will be displayed in its respective spatial or time perceptual related attribute in the selected letters sequence for a period of t₂, where t₂ is herein defined to be 3.5 seconds.

In the exercises presented in Example 2, the subject is required to reason in order to perform, on the fly, a mental simulation (aided by attentional inhibition-ignoring) of serially removing one or more contiguous letters to form/assemble and explicitly expose an assigned open proto-bigram term. The serial removal of one or more contiguous letters is done from the left to the right direction in the selected letters sequence. A complete non-alphabetical serial order of different letters sequence comprising 26 different letters (for the English language alphabet) is selected from a library comprising letters sequences.

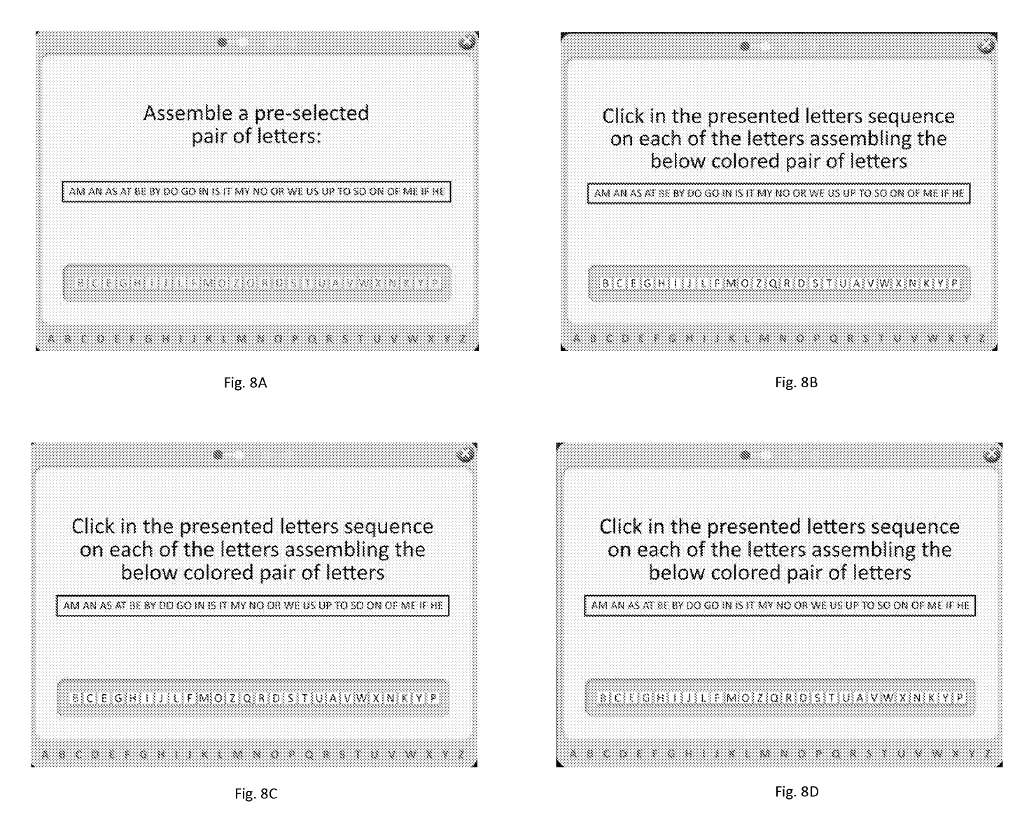

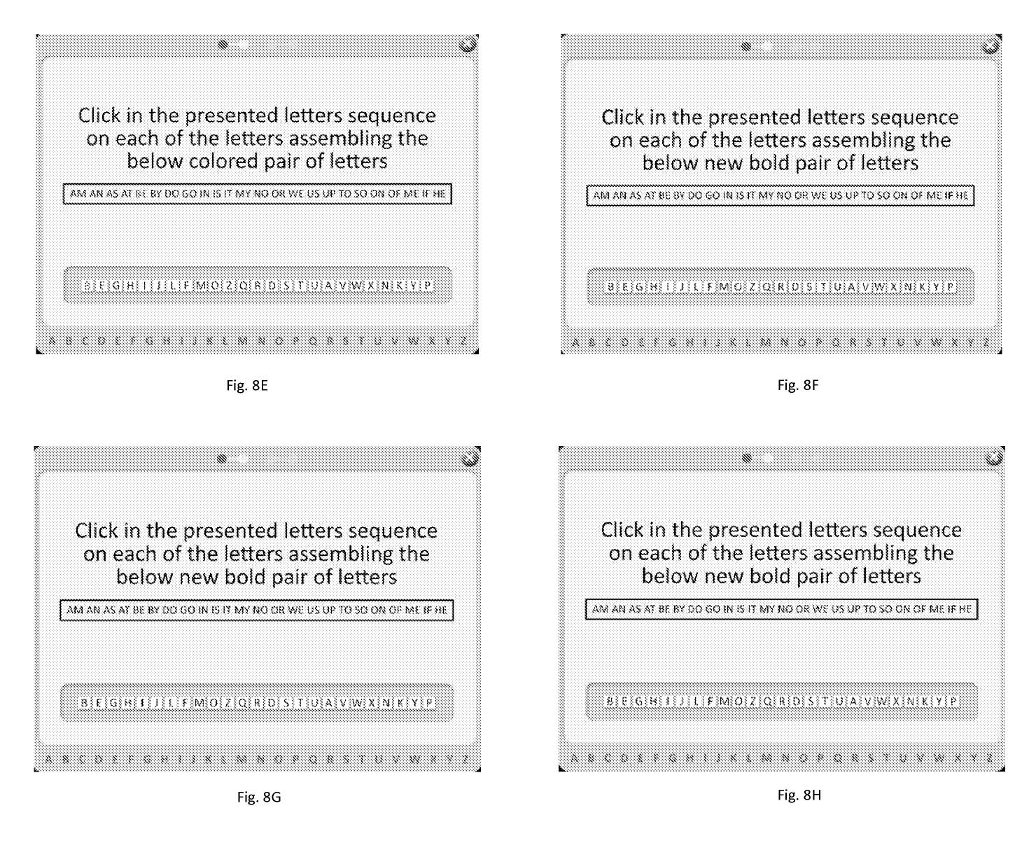

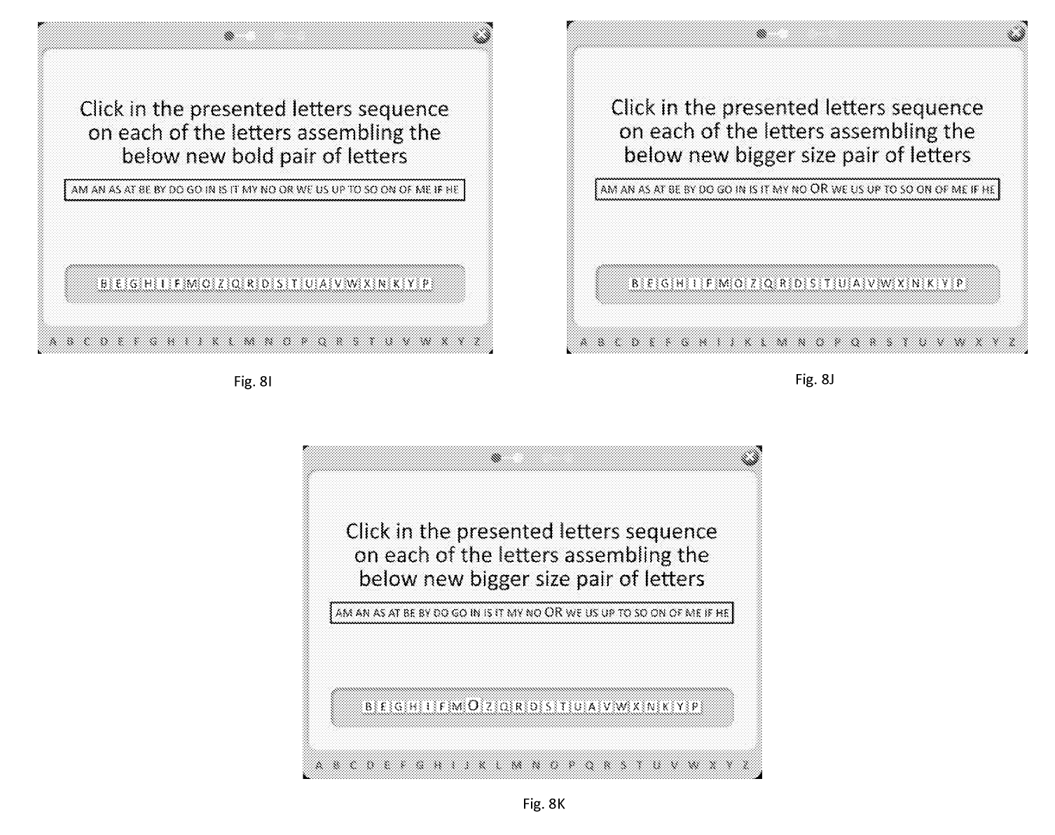

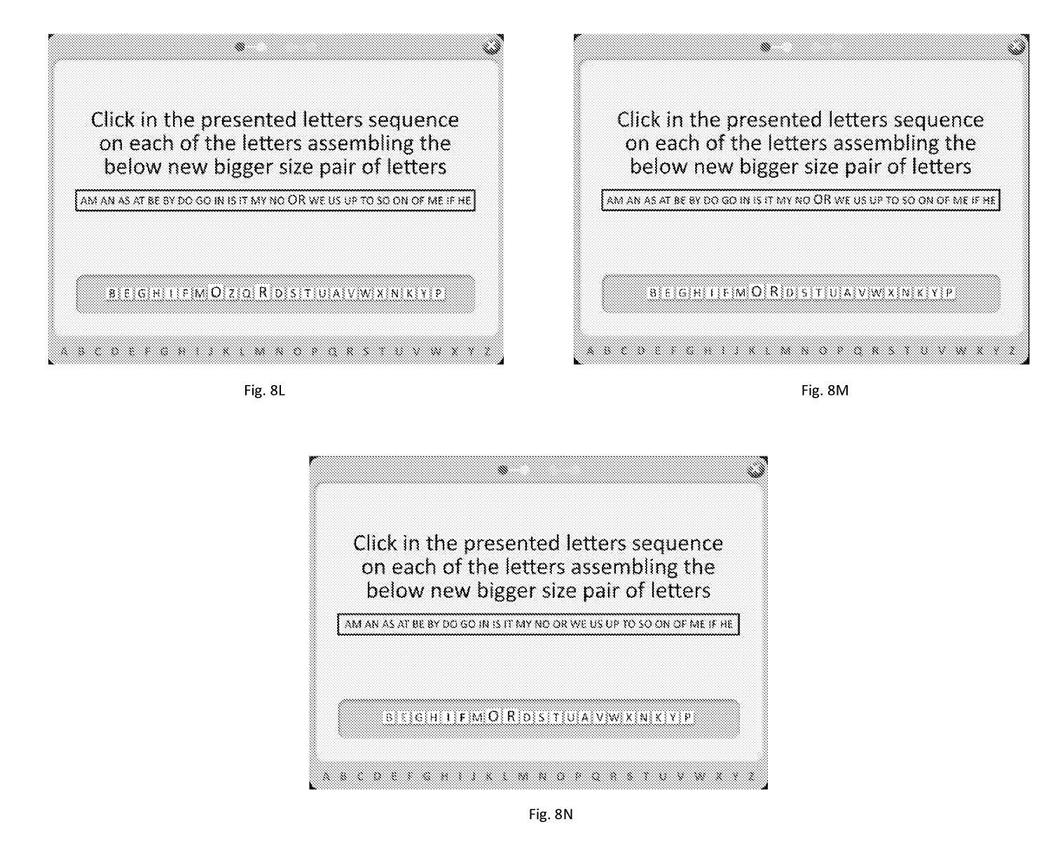

In trial exercise #1 of block exercise 1, the subject is presented with 3 selected complete non-alphabetical serial orders of different letters sequences in a sequential manner. As shown in FIG. 8A, the subject is provided with one complete non-alphabetical serial order of different letters sequence. In FIG. 8B, the assigned open proto-bigram term ‘BE’ is displayed with time perceptual related attribute font red color in the complete open proto-bigrams sequence shown in the ruler. The subject is then required to reason and visually localize the designated pair of letters ‘B’ and ‘E’ in the provided letters sequence. To achieve that end, the subject is prompted to search and recognize the assigned letter pair by sensory motor selecting (e.g. mouse click with the mouse-device) on the first valid letter of the pair of letters forming the assigned open proto-bigram term, and without delay proceed to mouse click on the second valid letter of the pair. This is shown in FIGS. 8C and 8D, wherein the selected letters ‘B’ and ‘E’ are displayed with time perceptual related attribute font red color. In FIG. 8E, a single letter located in between this pair of letters is removed, explicitly revealing the open proto-bigram term ‘BE’, which is displayed in time perceptual related attribute red font color, for time interval t₁, in the first new obtained incomplete non-alphabetical different letters sequence as well as in the complete open proto-bigrams sequence shown in the ruler.

In FIG. 8F, a second assigned open proto-bigram term ‘IF’ is displayed with spatial perceptual related attribute font boldness in the complete open proto-bigrams sequence shown in the ruler. In FIGS. 8G and 8H, the correctly selected letters ‘I’ and F′ are displayed with spatial perceptual related attribute font boldness. As shown in FIG. 8I, explicitly revealed open proto-bigram term ‘IF’ is displayed in spatial perceptual related attribute font boldness, for time interval t₁, in the second new obtained incomplete non-alphabetical different letters sequence as well as in the complete open proto-bigrams sequence shown in the ruler.

In FIG. 8J, a third assigned open proto-bigram term ‘OR’ is displayed in with spatial perceptual related attribute larger font size in the complete open proto-bigrams sequence shown in the ruler. In FIGS. 8K and 8L, the correctly identified letters ‘O’ and ‘R’ are displayed with spatial perceptual related attribute larger font size. As shown in FIG. 8M, revealed open proto-bigram term ‘OR’ is displayed in spatial perceptual related attribute larger font size in the third new obtained incomplete non-alphabetical different letters sequence as well as in the complete open proto-bigrams sequence shown in the ruler. Once the last assigned open proto-bigram term ‘OR’ has been explicitly exposed, all of the assigned open proto-bigram terms, ‘BE’, ‘IF’, and ‘OR’ are displayed in their respective spatial or time perceptual related attributes, for time interval t₂, in the third and final obtained incomplete non-alphabetical different letters sequence, as shown in FIG. 8N.

At the end of time interval t₂, the next in-line selected non-alphabetical serial order of different letters sequence is displayed. Once the subject has successfully explicitly exposed the last assigned open proto-bigram term in the third selected non-alphabetical serial order of different letters sequence and after time interval t₂ has ended, the first selected non-alphabetical serial order of some same letters sequence in trial exercise #1 of block exercise 2 begins.

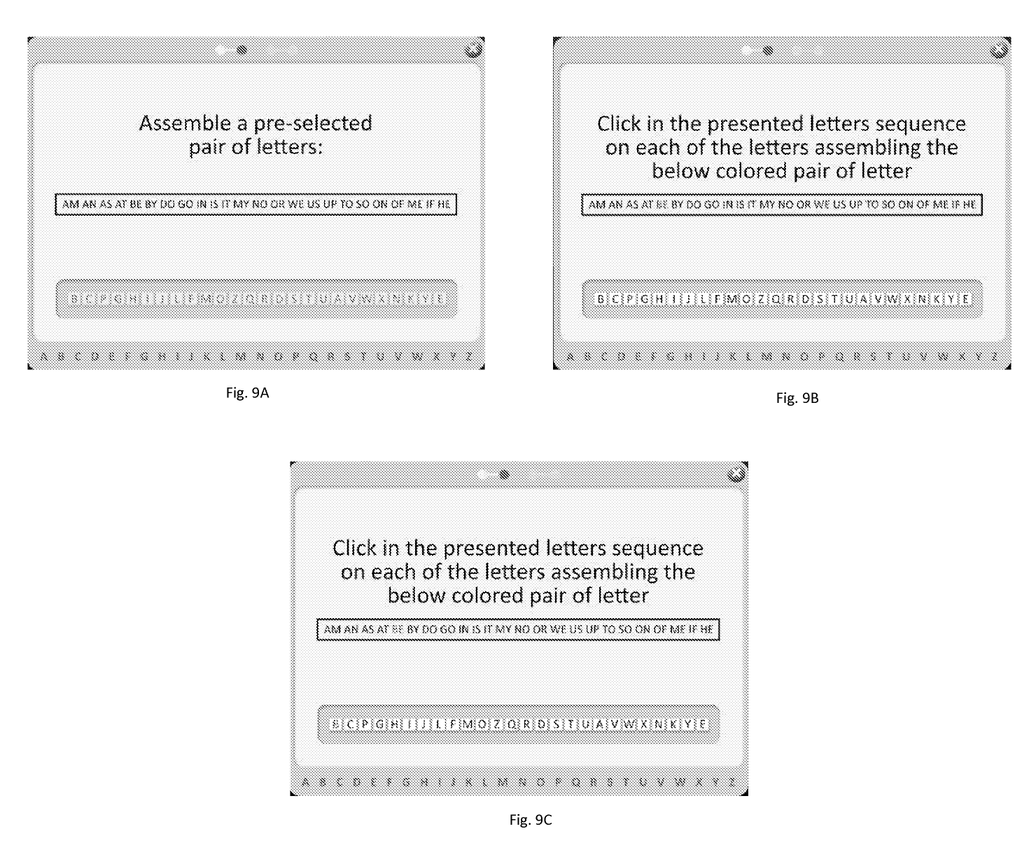

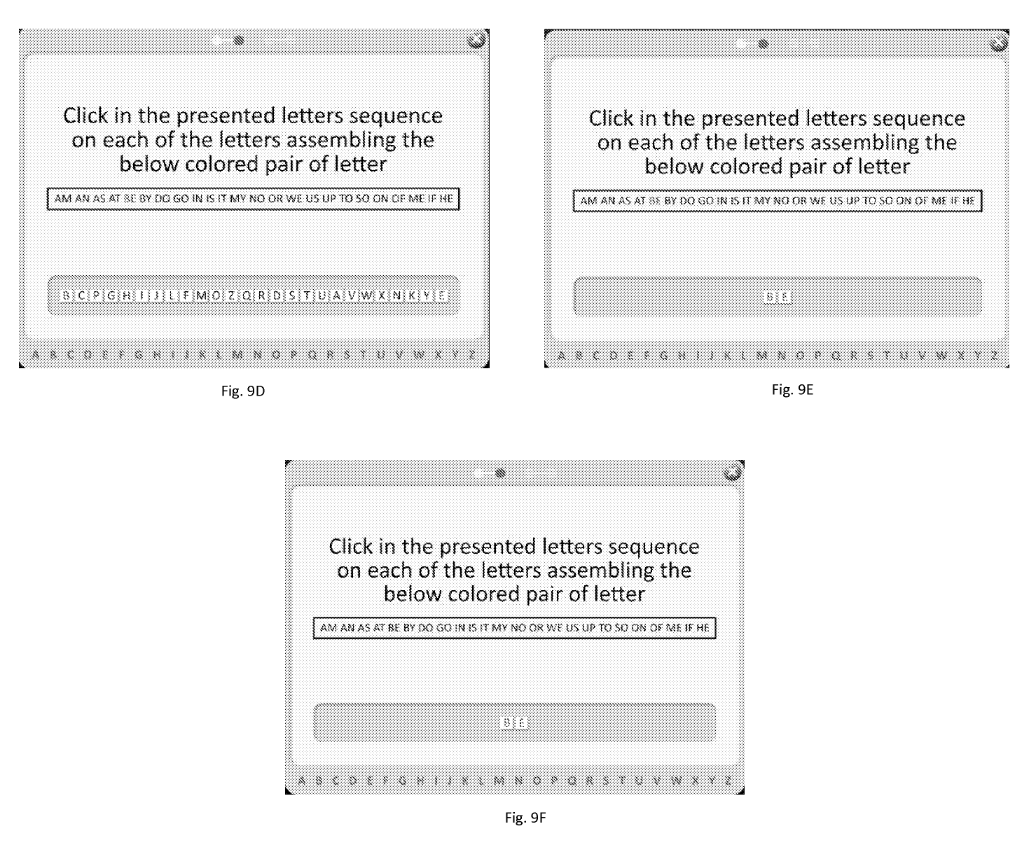

In another example and as shown in FIG. 9A, the subject is provided with a single non-alphabetical serial order of different letters sequence and a complete open proto-bigrams sequence displayed in the ruler. Both sequences have the same spatial and time perceptual related attributes In FIG. 9B, the assigned open proto-bigram term ‘BE’ is displayed in a time perceptual related attribute font red color in the complete open proto-bigrams sequence shown in the ruler. The subject must quickly visually search, recognize, and sensory motor select within the provided letter sequence each single letter of this pair of letters with the end goal of forming/assembling the assigned open proto-bigram term ‘BE’. Following the same method explained earlier, the subject should sensory motor select by clicking with the mouse-device on the first valid letter of the pair of letters forming the assigned open proto-bigram term, and without delay, proceed to sensory motor select by clicking with the mouse-device on the second valid letter of the pair. In FIGS. 9C and 9D, the correct sensory motor selected letters ‘B’ and ‘E’ are displayed with time perceptual related attribute font red color. Further, in FIG. 9E, the open proto-bigram term ‘BE’, explicitly revealed by an extraordinary non-local compression, is displayed in time perceptual related attribute font red color in the obtained non-alphabetical different letters sequence for time interval t₁ as well as in the complete open proto-bigrams sequence shown in the ruler. Finally, the open proto-bigram term ‘BE’ is displayed in time perceptual related attribute font red color only in the obtained non-alphabetical different letters sequence as shown in FIG. 9F.

In trial exercise #1 of block exercise 2, the subject is presented with 3 selected non-alphabetical serial orders of some same letters sequences in a sequential manner. The selected non-alphabetical serial order of some same letters sequence comprises the 26 letters of the English alphabet, but some of the letters included in this sequence are duplicates. Stated another way, there are a number of letters that appear repetitively in the letters sequence. Therefore, some letters of the English alphabet will be missing. A number of single letters are selected to be repeated within a selected non-alphabetical serial order of some same letters sequence. The kind of single letters that are herein allowed to be repeated in a selected letters sequence may be initially chosen by a predefined method or at random. The number of single consonant letters to be repeated may be 1 or 2 per letters sequence and the number of single vowel letters to be repeated may be 2 or 3 per letters sequence. Each single letter is also repeated within a selected non-alphabetical serial order of some same letters sequence a number of times. Each single consonant letter may be repeated 1 or 2 times per letter while each single vowel letter may be repeated 2 or 3 times per letter. Each selected non-alphabetical serial order of some same letters sequence will always include by default a complete set of vowels: A, E, I, O and U. The respective serial order positioning for the vowels in the selected letters sequence will be randomized.

In order to explicitly reveal the assigned open proto-bigram by a local or a non-local compression, the subject will need to follow the same operational procedure as discussed in Example 1 above.

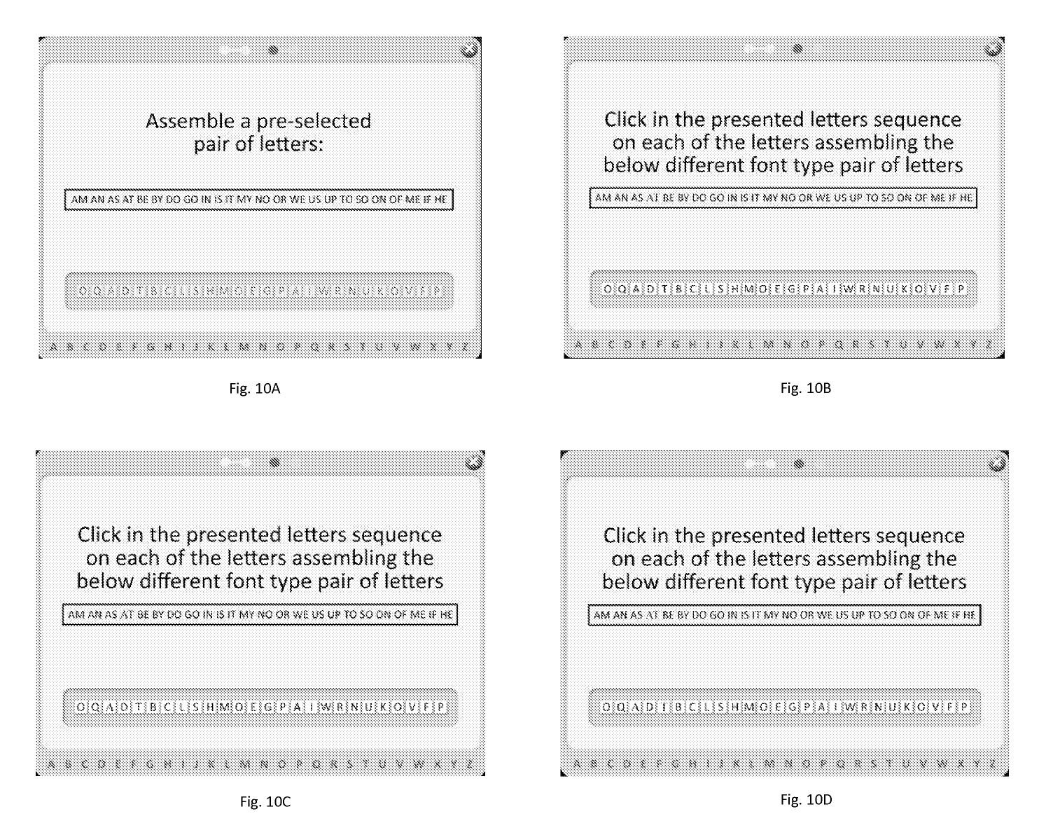

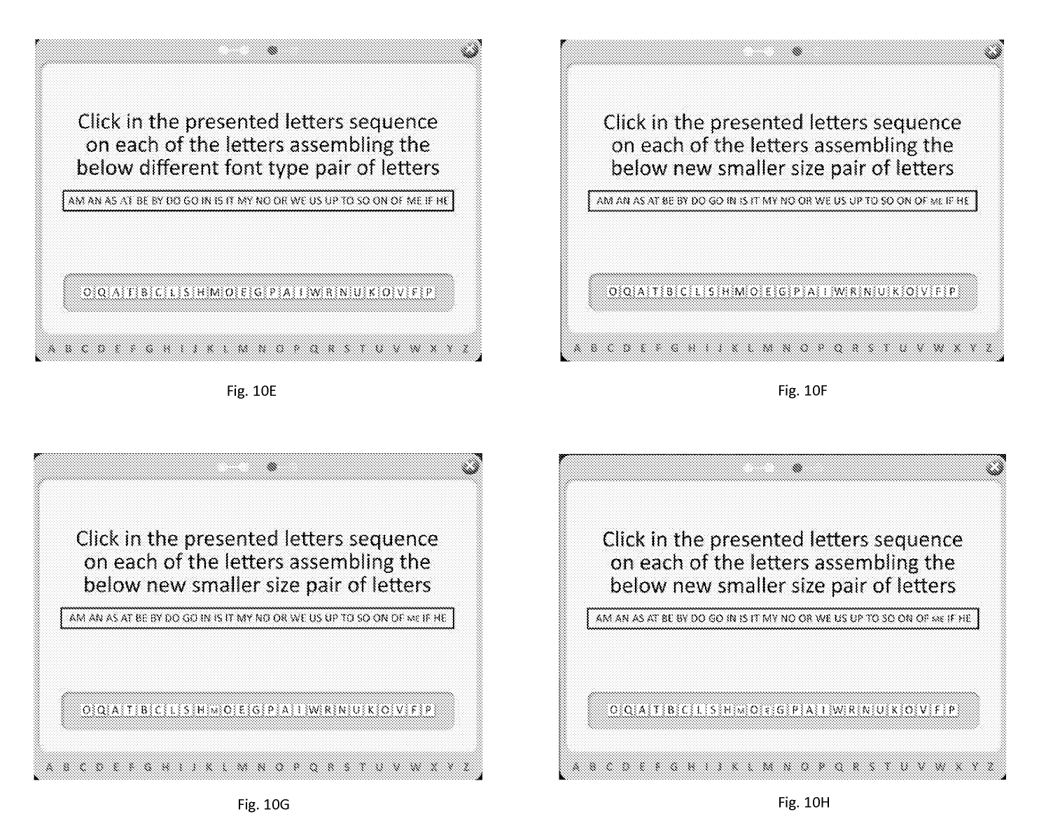

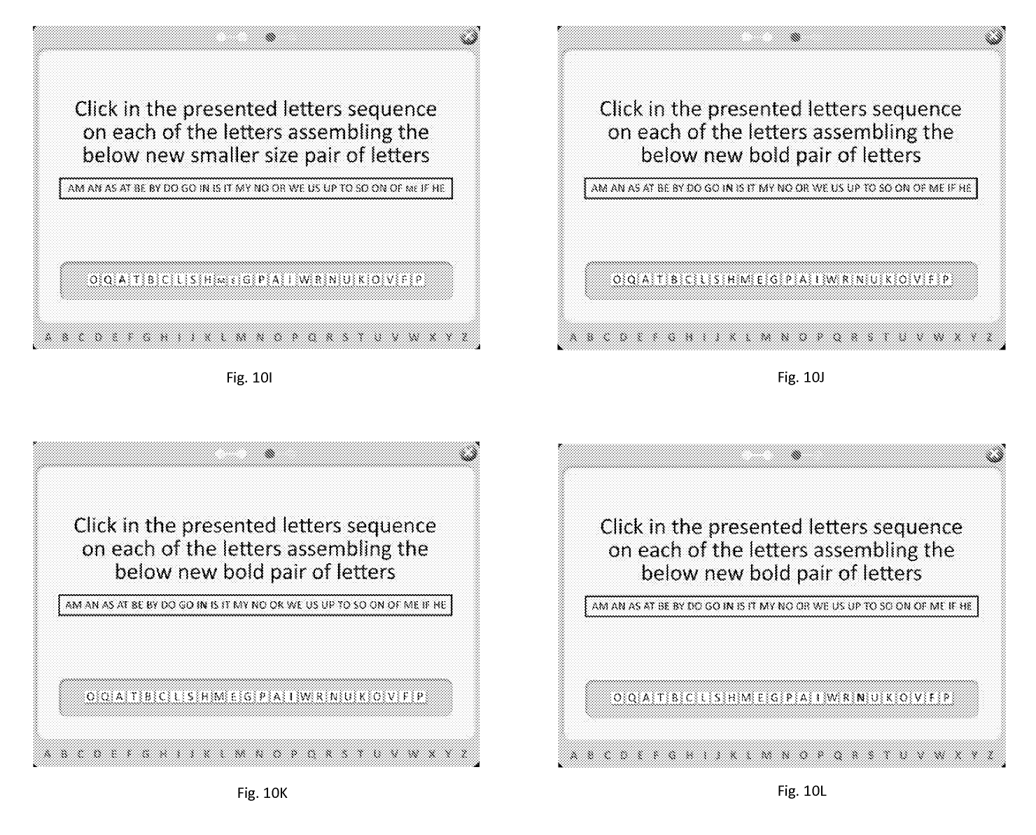

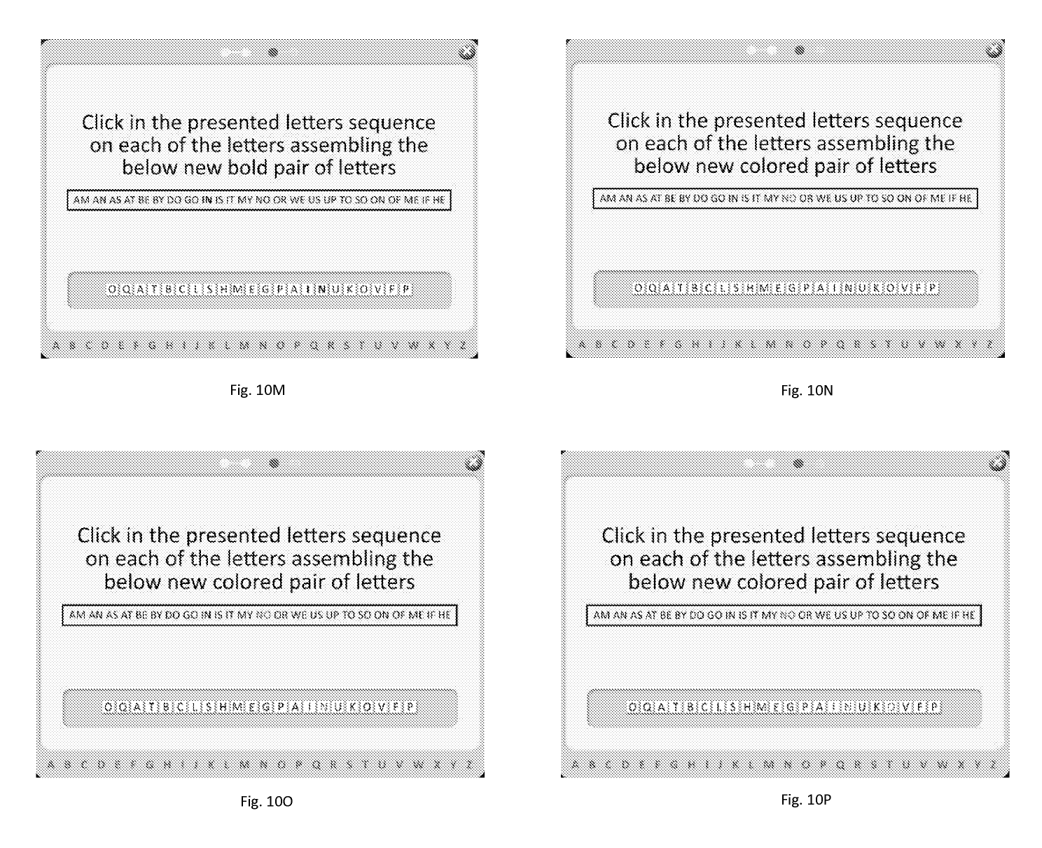

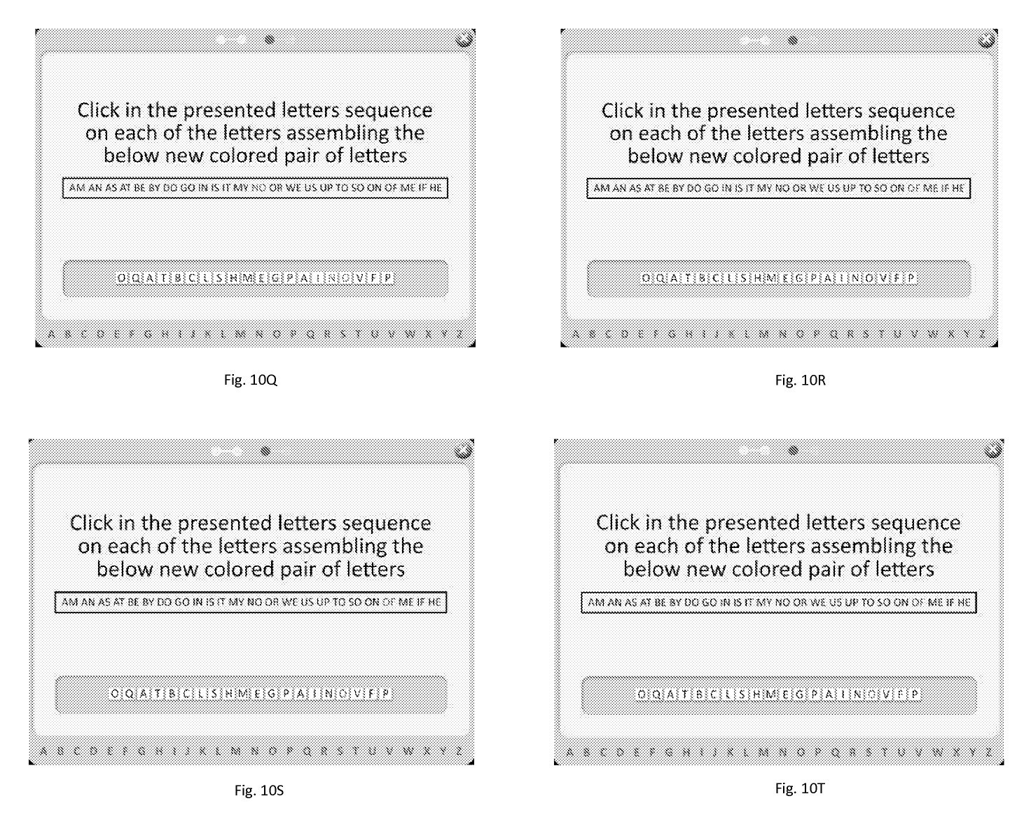

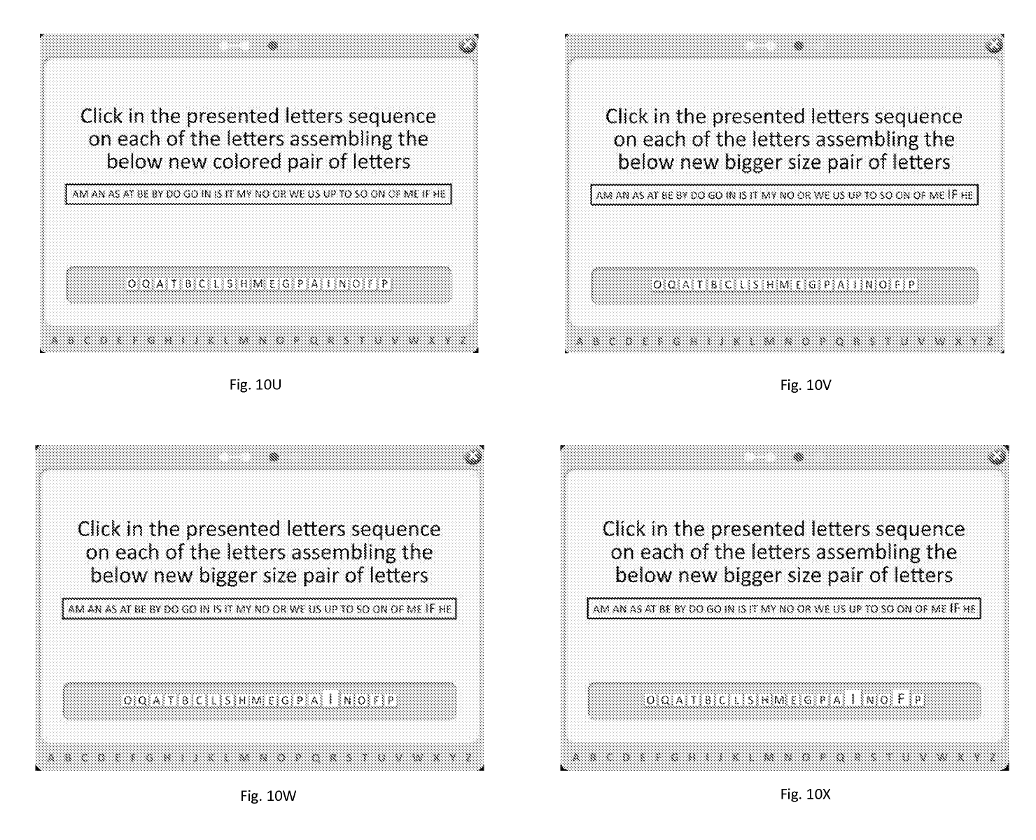

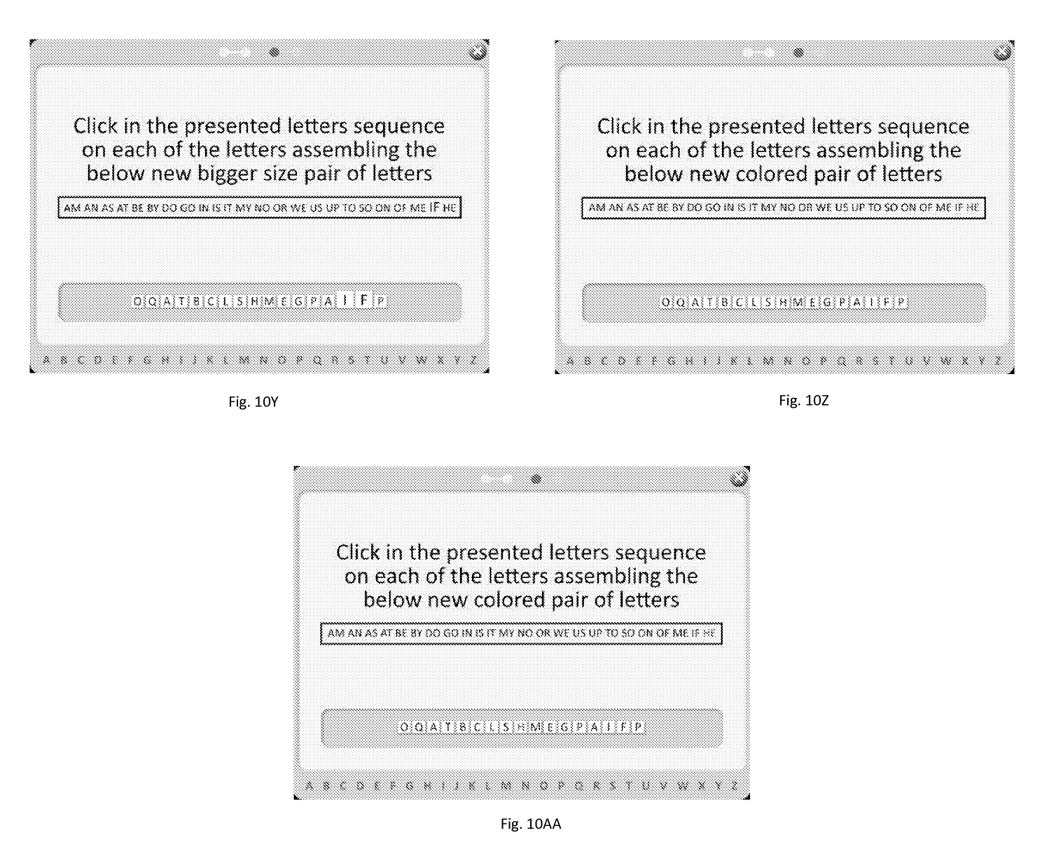

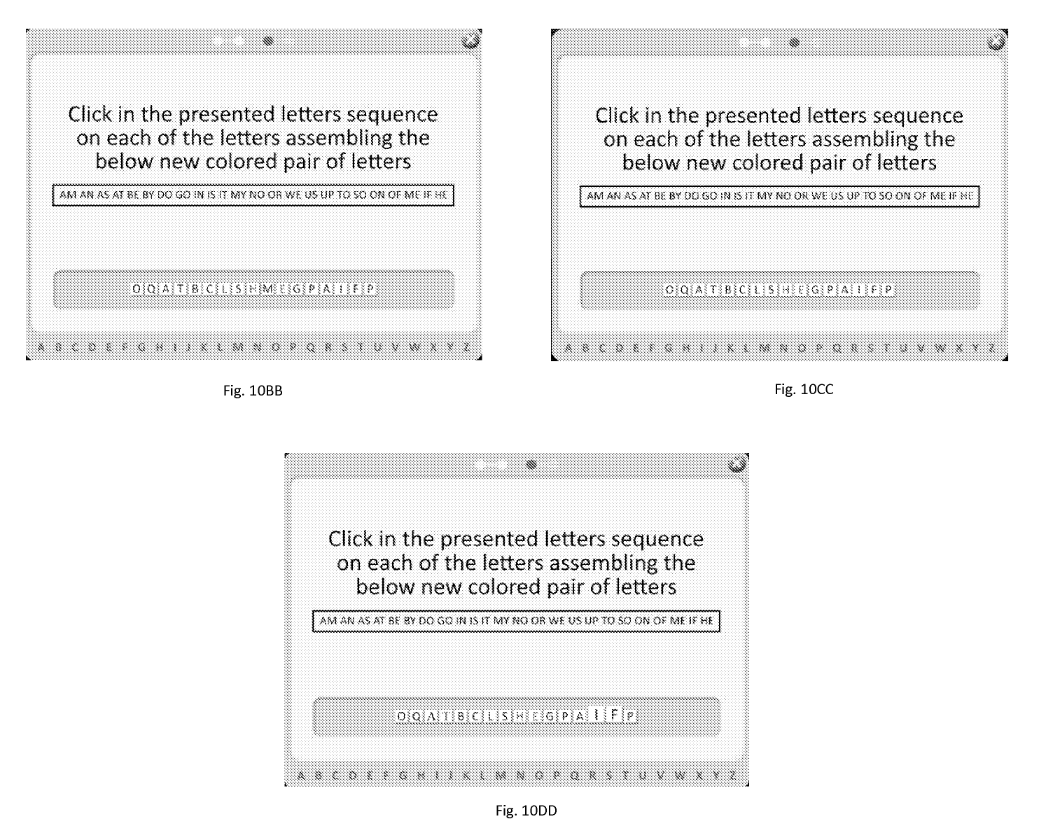

As shown in FIG. 10A, the subject is provided with a non-alphabetical serial order of some same letters sequence. In FIG. 10B, the assigned open proto-bigram term ‘AT’ is displayed in a spatial perceptual related attribute font type in the complete open proto-bigrams sequence shown in the ruler. In FIGS. 10C and 10D, the correct sensory motor selected letters ‘A’ and ‘T’ are displayed with spatial perceptual related attribute font type. In FIG. 10E, the explicitly revealed open proto-bigram term ‘AT’ is then displayed in spatial perceptual related attribute font type, for time interval t₁, in the new obtained incomplete non-alphabetical some same letters sequence and in the complete open proto-bigrams sequence shown in the ruler.

In FIG. 10F, a second assigned open proto-bigram term ‘ME’ is displayed in a spatial perceptual related attribute smaller font size in the complete open proto-bigrams sequence shown in the ruler. Correct sensory motor selected letters ‘M’ and ‘E’ are displayed with spatial perceptual related attribute smaller font size in FIGS. 10G and 10H. As shown in FIG. 10I, explicitly revealed open proto-bigram term ‘ME’ is displayed in spatial perceptual related attribute smaller font size, for time interval t₁, in the second new obtained incomplete non-alphabetical some same letters sequence and in the complete open proto-bigrams sequence shown in the ruler.

FIGS. 10J-10M, show a third compression of the selected letters sequence for the assigned open proto-bigram term ‘IN’ displayed with spatial perceptual related attribute font boldness in the complete open proto-bigrams sequence shown in the ruler. Correct sensory motor selected letters ‘I’ and ‘N’ are displayed with spatial perceptual related attribute font boldness in FIGS. 10K and 10L, while the explicitly revealed open proto-bigram term ‘IN’ is displayed with time perceptual related attribute font boldness in the third new obtained incomplete non-alphabetical some same letters sequence as well as in the complete open proto-bigrams sequence shown in the ruler as shown in FIG. 10M.

In FIG. 10N, fourth assigned open proto-bigram term ‘NO’ is displayed in a time perceptual related attribute font blue color in the complete open proto-bigrams sequence shown in the ruler. FIGS. 10O and 10P displayed the correct sensory motor selected letters ‘N’ and ‘O’ with time perceptual related attribute font blue color. As shown in FIG. 10Q, the explicitly revealed open proto-bigram term ‘NO’ is displayed in time perceptual related attribute font blue color, for time interval t₁, in the fourth new obtained incomplete non-alphabetical some same letters sequence and in the complete open proto-bigrams sequence shown in the ruler.

In FIG. 10R, a fifth assigned open proto-bigram term ‘OF’ is displayed in a time perceptual related attribute font red color in the complete open proto-bigrams sequence shown in the ruler. FIGS. 10S and 10T show the correctly identified letters ‘O’ and ‘F’ displayed with time perceptual related attribute font red color. As shown in FIG. 10U, explicitly revealed open proto-bigram term ‘OF’ is displayed in time perceptual related attribute font red color in the fifth new obtained incomplete non-alphabetical some same letters sequence, as well as in the complete open proto-bigrams sequence shown in the ruler.

In FIGS. 10V-10Y, a sixth assigned open proto-bigram term ‘IF’ is displayed in a spatial perceptual related attribute larger font size in the complete open proto-bigrams sequence shown in the ruler. Correct sensory motor selected letters ‘I’ and ‘F’ are shown with spatial perceptual related attribute larger font size in FIGS. 10W and 10X. As shown in FIG. 10Y, explicitly revealed open proto-bigram term ‘IF’ is displayed in spatial perceptual related attribute larger font size, for time interval t₁, in the sixth new obtained incomplete non-alphabetical some same letters sequence and in the complete open proto-bigrams sequence shown in the ruler.

In FIG. 10Z, the seventh assigned open proto-bigram term ‘HE’ is displayed in a spatial perceptual related attribute font red color in the complete open proto-bigrams sequence shown in the ruler. FIGS. 10AA and 10BB displayed correct sensory motor selected letters ‘H’ and E′ with spatial perceptual related attribute font red color. As shown in FIG. 10CC, explicitly revealed open proto-bigram term ‘HE’ is displayed in time perceptual related attribute font red color in the seventh new obtained incomplete non-alphabetical some same letters sequence as well as in the complete open proto-bigrams sequence shown in the ruler.

Once the last assigned open proto-bigram term ‘HE’ has been explicitly exposed, all of the previously explicitly exposed assigned open proto-bigram terms, ‘AT’, ‘HE’, and ‘IF’ are displayed in their respective spatial or time perceptual related attributes, for time interval t₂, in the seventh and final obtained incomplete non-alphabetical some same letters sequence, as shown in FIG. 10DD.

At the end of time interval t₂, the next in-line selected non-alphabetical serial order of some same letters sequence is displayed. Once the subject has successfully exposed the last assigned open proto-bigram term in the third selected non-alphabetical serial order of some same letters sequence and after time interval t₂ has ended, the current trial exercise is exited and the subject is returned to the main menu.

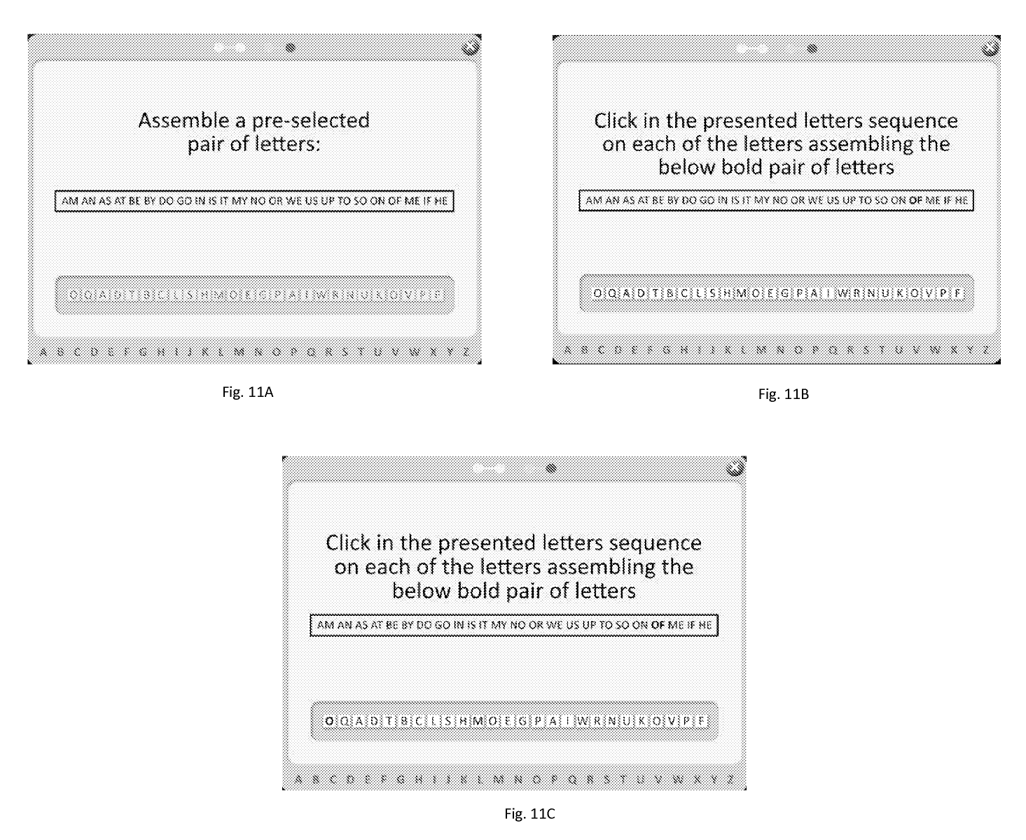

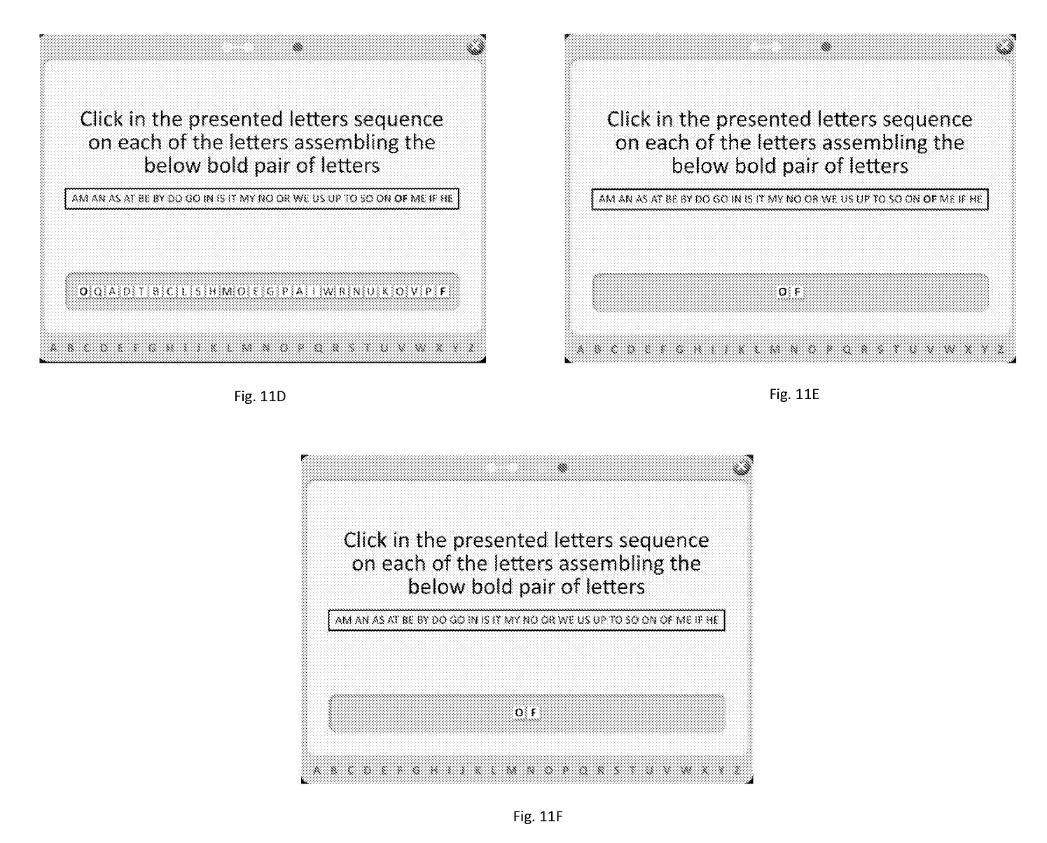

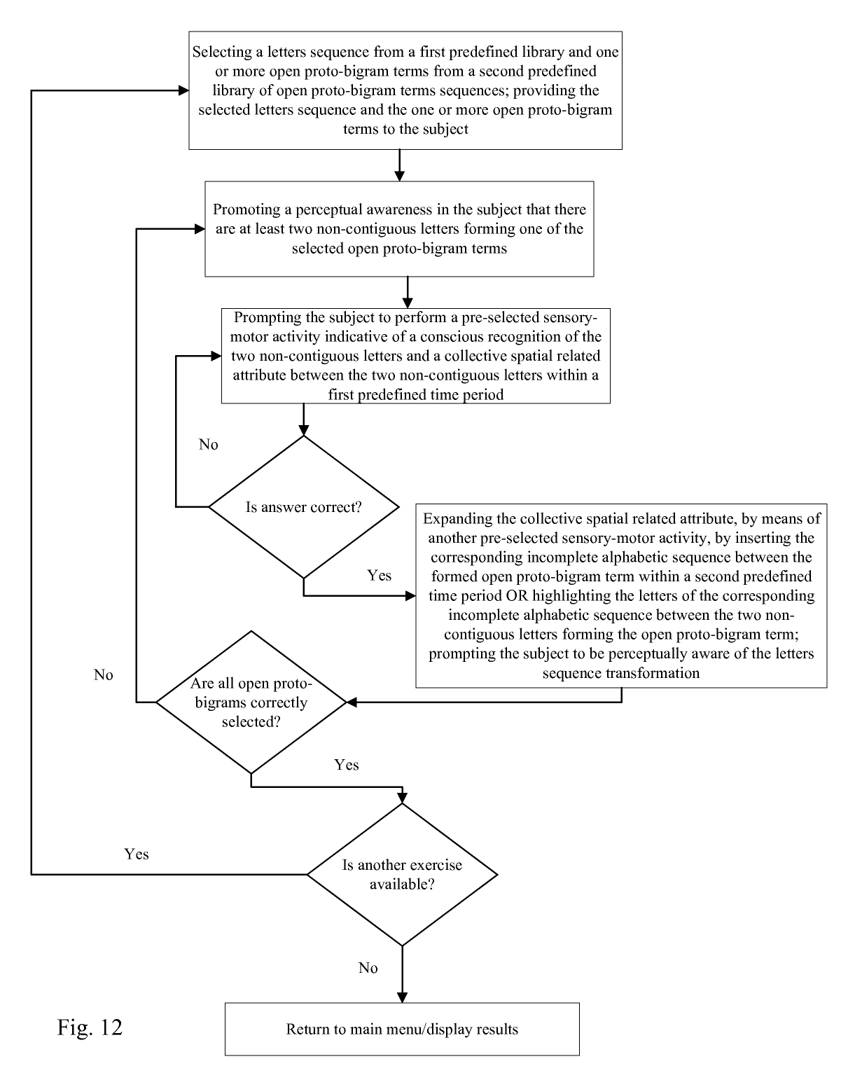

In another example and as shown in FIG. 11A, the subject is provided with a single non-alphabetical serial order of some same letters sequence and a complete open proto-bigrams sequence displayed in the ruler. Both sequences have the same spatial and time perceptual related attributes In FIG. 11B, the assigned open proto-bigram term ‘OF’ is displayed in a spatial perceptual related attribute font boldness in the complete open proto-bigrams sequence shown in the ruler. The subject must follow the same procedure as in the previous examples, which requires sensory motor selection such as clicking with the mouse-device (or other preselected means) on the first valid letter of the pair of letters forming the assigned open proto-bigram term, and without delay, proceeding to click with the mouse-device (or other preselected means) on the second valid letter of the pair of letters forming the assigned open proto-bigram term. In FIGS. 11C and 11D, the correct sensory motor selected letters ‘O’ and ‘F’ are displayed with spatial perceptual related attribute font boldness. FIG. 11E shows how the explicitly revealed open proto-bigram term ‘OF’ was obtained by an extraordinary non-local compression. Once explicitly exposed, open proto-bigram term ‘OF’ is displayed in spatial perceptual related attribute font boldness, for time interval t₁, as well as in the complete open proto-bigrams sequence shown in the ruler. Finally, open proto-bigram term ‘OF’ is displayed in spatial perceptual related attribute font boldness only in the obtained non-alphabetical some same letters sequence as shown in FIG. 11F.

The methods implemented by the exercises of Example 2 also contemplate those situations in which the subject fails to perform the given task. The following failing to perform criteria is applicable to any trial exercise in any block exercise of the present task in which the subject fails to perform. Specifically, for the present exercises, there are two kinds of “failure to perform” criteria. The first kind of “failure to perform” criteria occurs in the event the subject fails to perform by not sensory motor selecting (the subject remains inactive/passive) with the hand-held mouse device on any assigned open proto-bigram term answer within a valid performance time period, such as 20 seconds. After a valid performance time period has elapsed, a new same kind of trial exercise is then executed for the subject to begin performing from scratch.

For any trial exercise where the subject fails to respond to more than 3 selected letters sequences, either the current trial exercise ends and the next in-line trial exercise for the next block exercise immediately begins or the current trial exercise is terminated and the subject is returned to the main menu. Further, if the subject sensory motor selects the wrong pair of letters in any valid performance period, the sensory motor selected non-assigned open proto-bigram term will not be explicitly exposed from the provided letters sequence. Instead, the incorrect selection will immediately be undone and the subject will again be able to select a new pair of letters.

The second “failure to perform” criteria takes place in the event the subject fails to successfully complete the three (3) or more selected letters sequences for each trial exercise within time interval t₃, where t₃ is 180 seconds. If the subject fails to complete the selected letters sequence for trial exercise #1 of block exercise 1 within t₃, the trial exercise is terminated and trial exercise #1 of block exercise 2 begins thereafter. If the subject fails to complete the selected letters sequences for trial exercise #1 of block exercise 2 within t₃, the trial exercise is exited and the subject is returned to the main menu.

The total duration to complete the exercises of Example 2, as well as the time it took to implement each one of the individual trial exercises, is registered in order to help generate an individual and age-gender group performance score. Incorrect selections of pairs of letters are also recorded and counted as part of the subject's performance score. In general, the subject will perform the exercises of Example 2 about 6 times during his/her language based brain fitness training program.

### Example 3

### Promoting Reasoning Ability by Performing an Alphabetic Expansion of One or More Contiguous Letters Located in Between a Pre-Selected Open Proto-Bigram Term and Obtaining the Formation of an Incomplete Alphabetic Letters Sequence

A goal of the present Example 3 is to promote the fluid reasoning ability of a subject, which involves explicitly visually recognizing the two individual letters forming a pre-selected open proto-bigram term in a first step. Accordingly, the subject is required to use cognitive fluid reasoning ability in order to problem solve a particular serial order of letters exercise. To that effect, the subject needs to first visually recognize a pre-selected open proto-bigram term and then alphabetically expand this pre-selected open proto-bigram term. Thus, this method of promoting fluid reasoning ability in a subject is based in the visual recognition and sensory-motor selection activity involved in the gradual serial insertion of the letters of an alphabetic set array in between the two letters forming a pre-selected open proto-bigram term. This serial sensory motor insertion of one or more letters brings about the expansion of the selected open proto-bigram term and the formation of a particular incomplete alphabetic letter sequence in direct correlation with the selected open proto-bigram term.

When the pre-selected open proto-bigram term is shown the subject must mentally simulate, on the fly, the serial expansion of one or more contiguous letters implicitly located: 1) in between the pre-selected open proto-bigram term or; 2) in between a target pair of letters forming/assembling a pre-selected open proto-bigram term from a selected alphabetical letters sequence. The problem solving involved in the present exercise promotes cognitive fluid reasoning ability by a subject performing an on the fly mental simulation followed by sensory-motor serial insertion of a number of contiguous letters of an alphabetic letter sequence inside a pre-selected open proto-bigram term, which brings about its alphabetic expansion. The sensory motor activity may consist of selecting by mouse-clicking and dragging each of the required letters held in a selected alphabetic letters sequence.

The present task demands a novel problem solving strategy involving promoting an on the fly cognitive reasoning ability bringing forth a process of mentally simulating the alphabetical expansion of one or more contiguous letters held in between a pre-selected open proto-bigram term by which a correlated incomplete alphabetic letters sequence becomes explicitly exposed. For example, for the open proto-bigram term ‘WE’, the direct correlated implicit derived incomplete alphabetic letters sequence now exposed is: ‘VUTSRQPONMLKJIHGF’. The collective critical spatial perceptual related attribute is virtually contained in each open proto-bigram term and is herein considered to virtually comprise a corresponding incomplete alphabetic letters sequence directly derived from the above-mentioned alphabetic expansion.

In one aspect of the present Example 3, a single letters sequence is selected from the following types of letters sequences: 1) a direct alphabetic set arrays; 2) an inverse alphabetic set arrays; 3) randomized serial orders of alphabetic set arrays; and 4) randomized serial orders of incomplete alphabetical sequences.

In another aspect of the methods of Examples 3, a perceptual awareness is promoted in the subject. Particularly, this promotion of perceptual awareness in a subject may be achieved by providing the subject with one or more kinds of perceptual stimuli to facilitate the subject to effectively discriminate the two letters forming an assigned open proto-bigram term, where in between these two letters a collective critical spatial perceptual related attribute implicitly exists. Kinds of perceptual stimuli may include one or more of visual, auditory, and tactile stimuli. In a non-limiting example, visual stimuli may be provided to the subject in the form of a ruler which distinctively displays a selected open proto-bigram term to be consciously recognized by the subject inside of a selected letters sequence. In this particular example, the ruler may distinctively show the incomplete alphabetic sequence corresponding to the collective critical spatial perceptual related attribute of the selected open proto-bigram term in addition to the open proto-bigrams, and this letters sequence may be selected from a first predefined library. Furthermore, the ruler may also distinctively show a selected open proto-bigram term through one or more spatial and/or time perceptual related attribute changes of the selected open proto-bigram term implemented differently than the one or more spatial and/or time perceptual related attribute changes of the letters of the incomplete alphabetic sequence and selected changes of the spatial and/or time perceptual related attributes of the other open proto-bigram terms shown in the ruler and/or in the remaining letters of the selected letters sequence.

In a further aspect of the present Example 3, the sensory-motor selection activity required to be performed by the subject to indicate conscious explicit recognition of the two letters forming a selected open proto-bigram term may include one or more of: mouse clicking on each letter; mouse dragging of a letter; pointing at a single letter at a time with a finger while touching a screen where the selected letters sequence is displayed at the particular serial location where each letter is found; and spelling the name of each letter aloud, one letter at a time.

In the present Example 3, there are 2 consecutive block exercises for a subject to perform. Block exercise 1 consists of three (3) trial exercises. A direct or inverse alphabetical letters sequence is displayed in a ruler for two of the trial exercises of block 1. A complete non-alphabetical (randomized) letters sequence is displayed in the third trial exercise. In some embodiments, a direct or inverse alphabetic set array is also provided in a ruler for the subject's reference in the third trial exercise. Block exercise 2 consists of two (2) trial exercises, each trial exercise having one selected direct or inverse alphabetical letters sequence and a direct open proto-bigrams sequence displayed in a ruler.

For the exercises of present Example 3, there are time period intervals between performances of block exercises. Let Δ₁ herein represent a time period interval between the performances of block exercises, where Δ₁ is herein defined to be 8 seconds. Further, there are time period intervals between the performances of the trial exercises in each block exercise. Let Δ₂ herein represent a time period interval between the trial exercises performance in each block exercise, where Δ₂ is herein defined to be 4 seconds.

In trial exercise #1 of block exercise 1, the subject is presented with a direct open proto-bigram term from a second predefined library along with a ruler displaying a direct alphabetic set array from the first predefined library. After the presentation of the selected open proto-bigram term, the subject is required to reason, visually recognize, and sensory-motor select (e.g., mouse-click) the individual letters forming the selected open proto-bigram term, as quickly as possible.

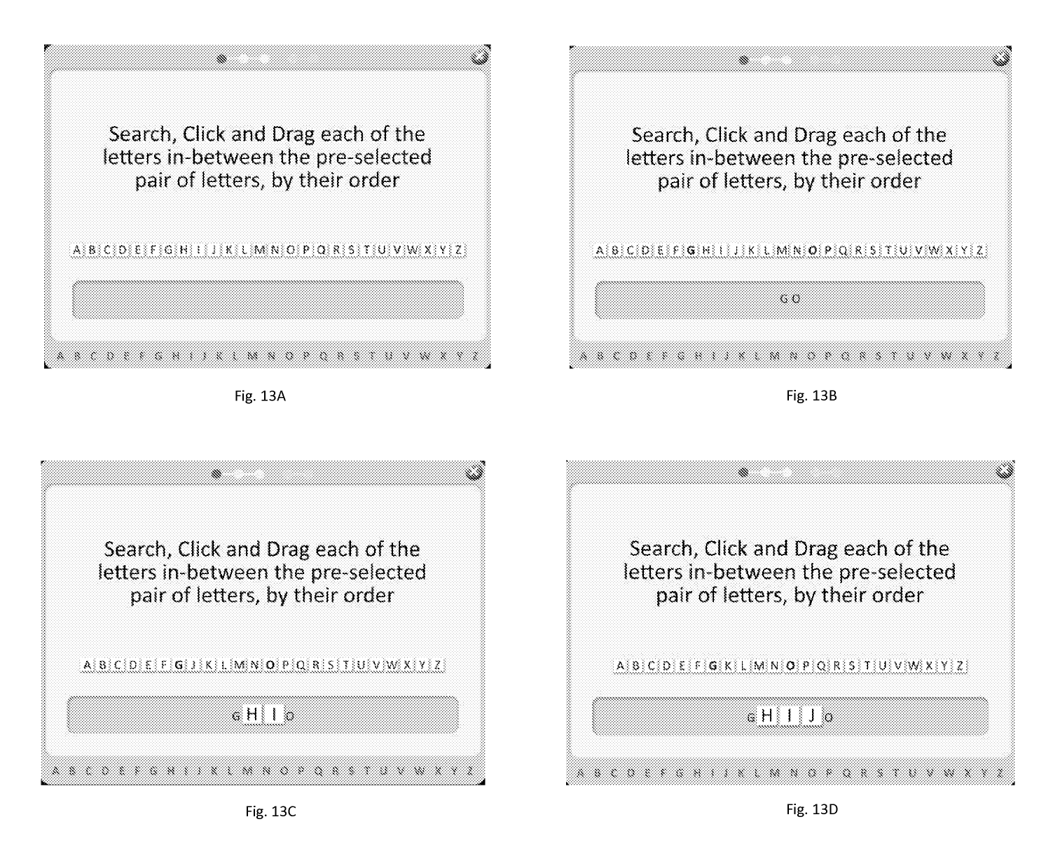

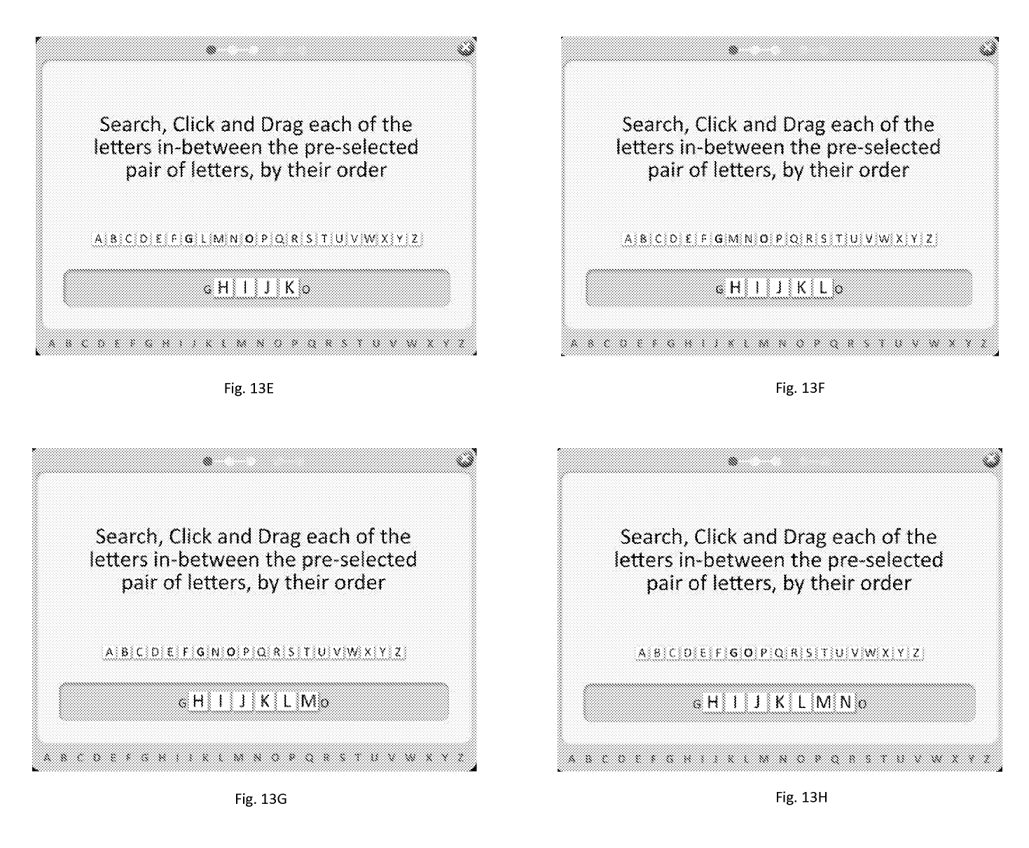

FIG. 13A shows this example exercise for when the subject has already visually recognized and sensory-motor selected the two letters. The subject is provided a direct alphabetical letters sequence to reason, visually recognize, and rapidly bring about an alphabetic expansion of the selected open proto-bigram term. In a non-limiting aspect of the present exercises, the subject will sensory motor select (mouse click and drag) each contiguous letter between the two recognized letters of a selected open proto-bigram term from the letters sequence shown in the ruler, one letter at a time from left to right, to the critical space in between the highlighted two letters of the selected open proto-bigram term. The maximal action time for sensory motor selecting (mouse clicking and dragging) each selected letter is 30 seconds. If the subject sensory-motor mouse clicking-dragging action is correct, the inserted letter will expand the implicit-collective perceptual related critical space between the two letters of the selected open proto-bigram term, and the space or time perceptual related attribute of the inserted letter will be changed.

As shown in FIG. 13B, the subject is provided with selected open proto-bigram term ‘GO.’ In FIG. 13C the correct sensory motor selected letters ‘H’ and ‘I’ are shown in spatial perceptual related attribute larger font size in between the ‘G’ and the ‘O’ letters of the selected open proto-bigram term. The same spatial or time perceptual related attribute change will apply for all future correct and successfully dragged letters inserted in between the selected open proto-bigram term. Similarly, FIGS. 13D-H each depict the next correctly inserted letters ‘J’, ‘K’, ‘L’, ‘M’, and ‘N’ in spatial perceptual related attribute larger font size. In FIG. 13H, final letter ‘N’ is dragged and inserted in between the selected open proto-bigram term.

After the last letter in between the selected open proto-bigram term has been successfully selected (clicked-dragged) into its respective serial order position inside the implicit collective critical space in between the selected direct open proto-bigram term, all of the correct inserted letters form an incomplete alphabetic sequence that is highlighted inside the selected open proto-bigram term and in the ruler by a different space or time perceptual related attribute for a time interval of 20 seconds.

Further, in a particular embodiment of the exercises of Example 3, the subject is required to insert the letters forming an incomplete alphabetic letters sequence, in between the two letters forming a selected open proto-bigram that have been consciously recognized, during a second predefined time period which may range from 3 to 6 seconds for each letter to be inserted.

Trial exercise #2 of block exercise 1 is structured and performed in the same manner as trial exercise #1, however, the difference is that the subject is presented with an inverse open proto-bigram term from the second predefined library and a ruler displaying an inverse alphabetic set array from the first predefined library. The presentation of the selected inverse open proto-bigram term requires the user to reason, visually recognize, and rapidly bring about an alphabetic expansion of the selected inverse open proto-bigram term. The subject needs to, as quickly as possible, correctly click on each of the individual letters forming the selected open proto-bigram term to explicitly expose an incomplete inverse alphabetic letters sequence.

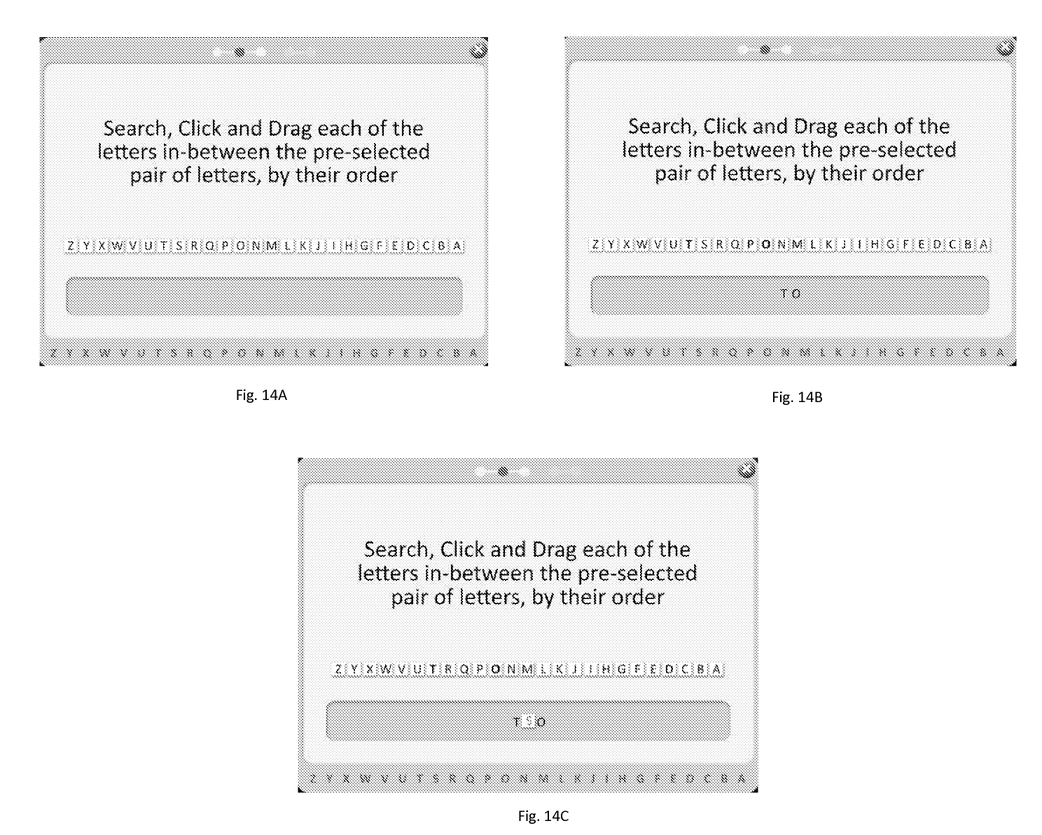

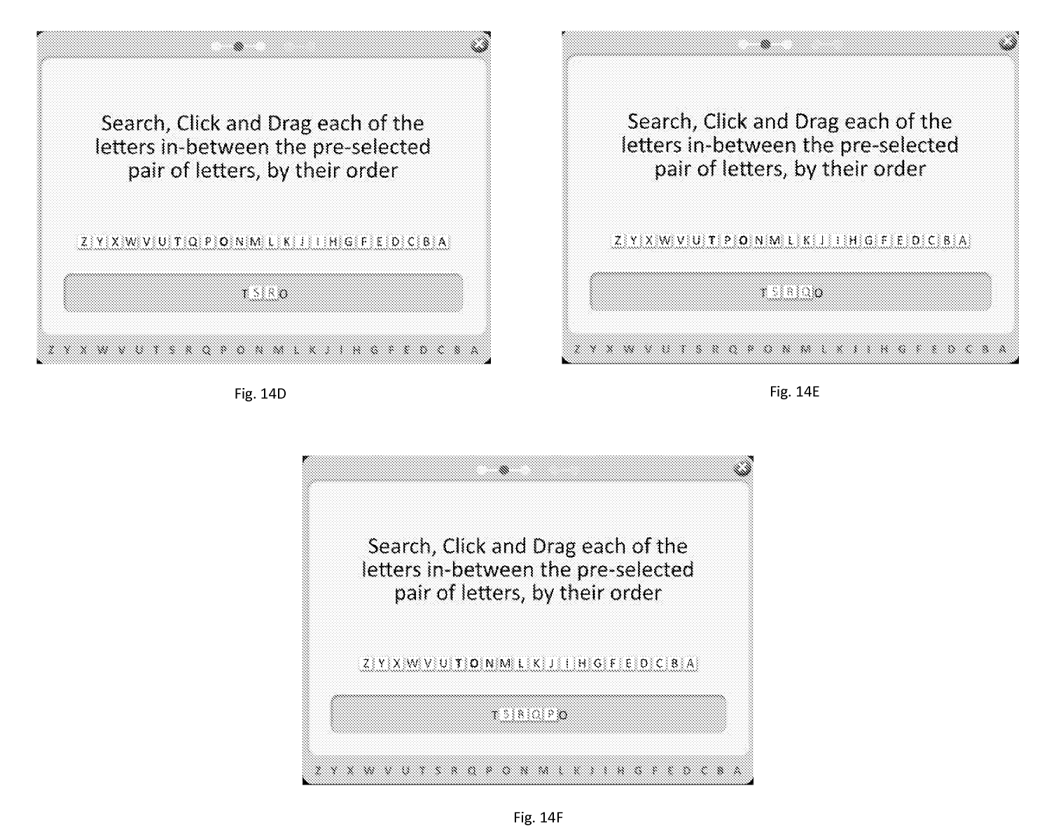

As shown in FIG. 14A, the subject is provided with an inverse alphabetical letters sequence and in FIG. 14B the selected open proto-bigram term ‘TO’ is displayed with a different spatial perceptual related attribute font boldness. The subject will mouse click and drag each contiguous letter held in between the two letters of the selected inverse open proto-bigram term, from an inverse letters sequence shown in the ruler, one letter at a time from left to right, to the implicit critical space between the highlighted letters of the selected inverse open proto-bigram term. The maximal action time available to sensory-motor select (mouse click-drag) each correctly selected letter from the inverse alphabetical letters sequence is of 30 seconds. If the subject's click-drag sensory-motor action is correct, the inserted letter will expand the implicit-collective perceptual related critical space between the two letters of the selected inverse open proto-bigram term, and the space or time perceptual related attribute of the correctly inserted letter will change.

As shown in FIG. 14C, the correctly selected letter ‘S’ is shown in time perceptual related attribute font blue color between the ‘T’ and the ‘O’ letters of the selected inverse open proto-bigram term. The same space or time perceptual related attribute change will apply for all of the future correct successfully dragged and inserted letters in between the selected inverse open proto-bigram term. Similarly, FIGS. 14D and E each depict the next correctly dragged and inserted letters ‘R’ and ‘Q’ in time perceptual related attribute font blue color. In FIG. 14F, final correct letter ‘P’ is dragged and inserted in between the selected inverse open proto-bigram term.

After the last letter in between the selected inverse open proto-bigram term has been successfully selected and clicked-dragged into its respective serial order position inside the implicit collective critical space between the selected inverse open proto-bigram term, all of the correctly inserted letters form an incomplete inverse alphabetic sequence that will be highlighted inside the selected inverse open proto-bigram term and in the ruler by a different space or time perceptual related attribute for a time interval of 20 seconds.

Trial exercise #3 of block exercise 1 is structured and performed in the same manner as trial exercises #1 and #2, where the subject is presented with a direct or inverse open proto-bigram term from the second predefined library. However, in this trial exercise, the subject is presented with a randomized serial order of an alphabetic set array from which the subject will have to select the next in-line one or more contiguous letters actualizing and forming the critical space implicitly held in between the selected direct or inverse open proto-bigram term. The presentation of the selected direct or inverse open proto-bigram term requires the user to reason, mentally simulate, and visually recognize in order to bring about an alphabetic expansion by dragging and inserting one or more contiguous letters in a direct or inverse alphabetical serial order from the provided randomized serial order letters sequence inside the critical space of the selected direct or inverse open proto-bigram term, as quickly as possible, in order to explicitly expose an implicitly held incomplete direct or inverse alphabetic letters sequence.

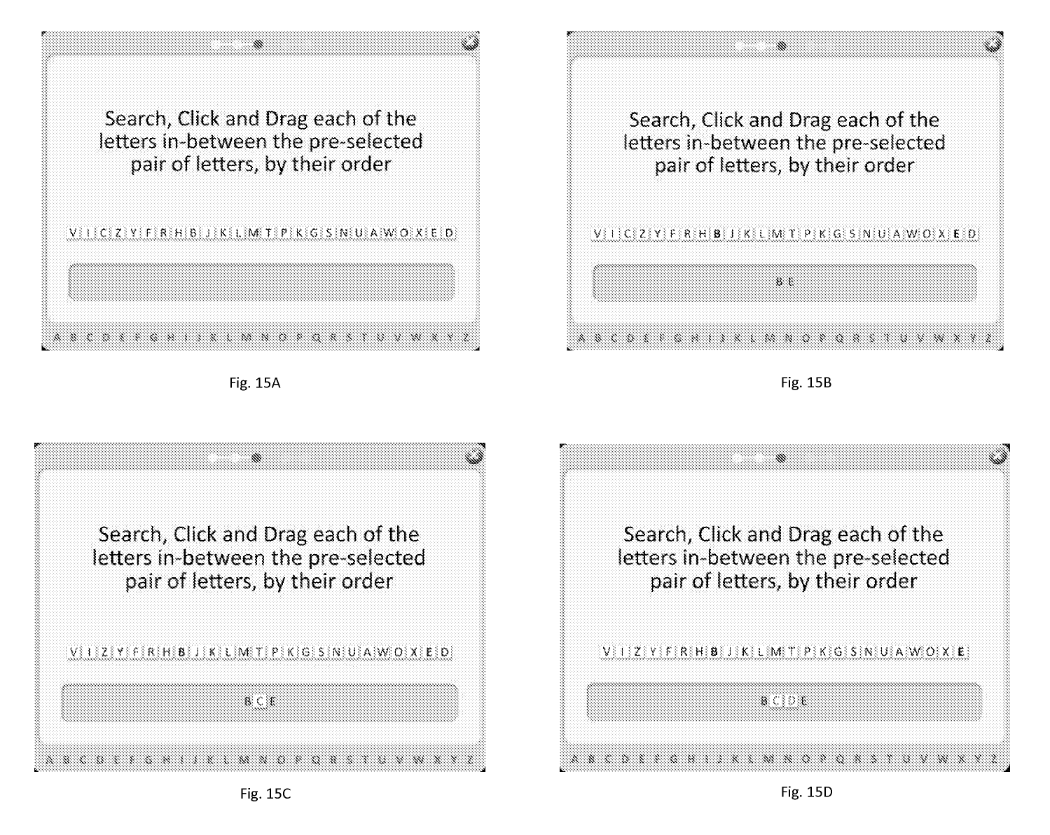

As shown in FIG. 15A, the subject is provided with a randomized serial order of an alphabetic set array and a ruler displaying a direct alphabetic set array. In FIG. 15B, selected direct open proto-bigram term ‘BE’ is displayed to the subject. The subject will have to sensory motor mouse click and drag each contiguous letter in between the two letters of the selected direct open proto-bigram term from the ruler, one letter at a time from left to right, to the implicit critical space held in between the highlighted letters of the selected direct open proto-bigram term. The maximum action time for the sensory-motor mouse clicking and dragging each of the correctly selected letters is of 30 seconds. If the subject's sensory-motor action is correct, the inserted letter will expand the collective perceptual related critical space laying implicitly in between the two letters of the selected open proto-bigram term, and the spatial or time perceptual related attribute of the correctly inserted letter will be changed.

As shown in FIG. 15C, the correctly selected letter ‘C’ is shown in time perceptual related attribute font red color between the ‘B’ and the ‘E’ letters of the selected direct open proto-bigram term. The same space or time perceptual related attribute change will apply for all of the future correctly inserted letters in between the selected direct open proto-bigram term and the selected letters in the ruler successfully dragged in between the selected open proto-bigram term. Similarly, in FIG. 15D, final letter ‘D’ is inserted between the selected open proto-bigram.

After the last letter in between the selected open proto-bigram term has been successfully selected and clicked-dragged into its respective serial order position inside the collective critical space implicitly held in between the letters of the selected direct open proto-bigram term, all of the correctly inserted letters form an incomplete alphabetic sequence that will be highlighted in the selected direct open proto-bigram term and in the ruler by a different spatial or time perceptual related attribute for a time interval of 20 seconds.

In an alternative embodiment of trial exercise #3, the subject is not provided with a ruler displaying a direct alphabetic set array. Otherwise, both embodiments of trial exercise #3 are performed in exactly the same manner.

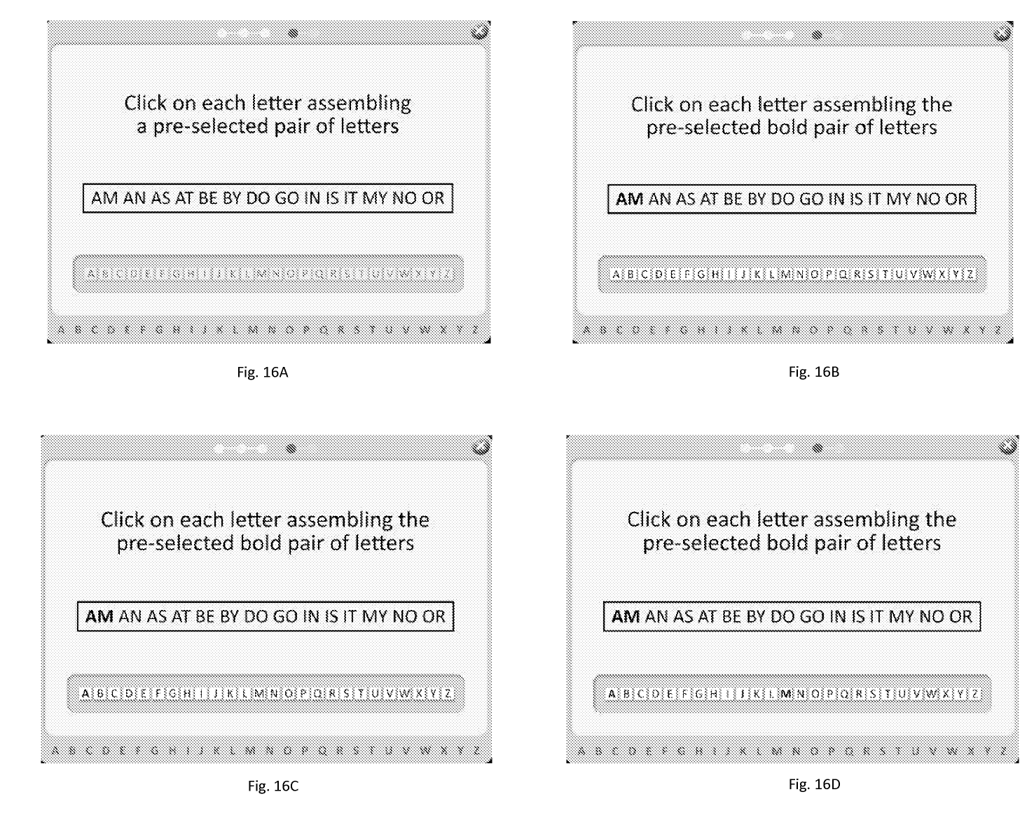

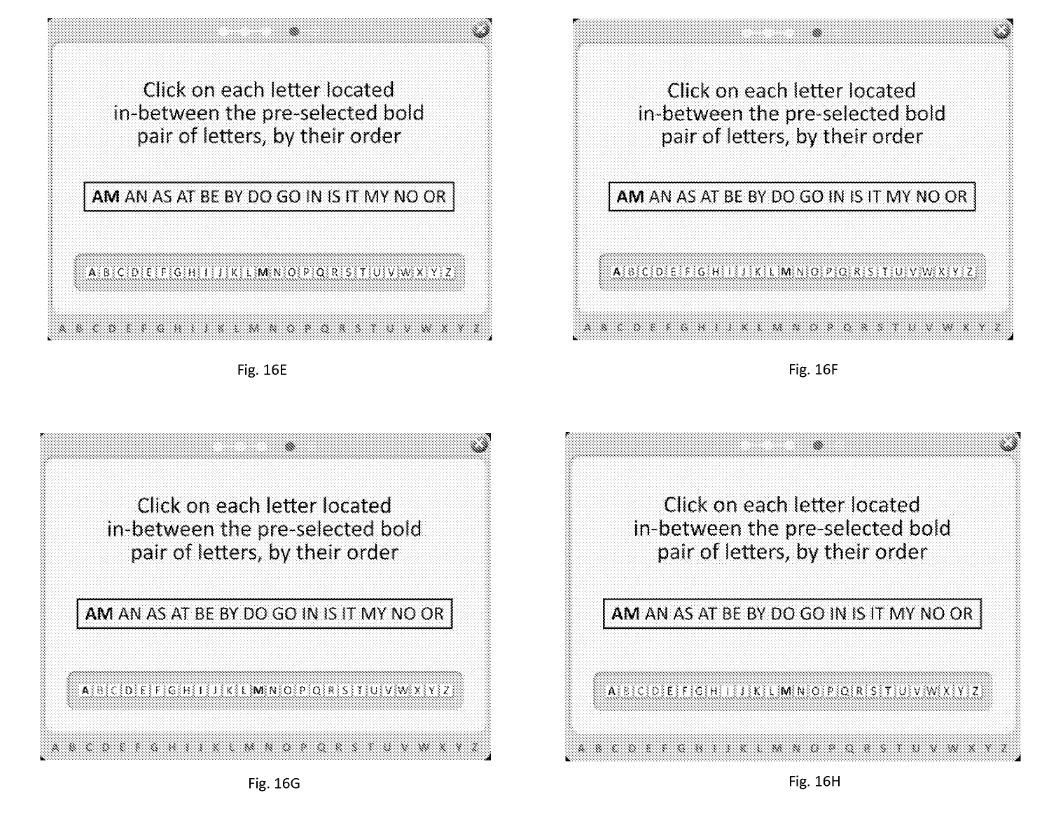

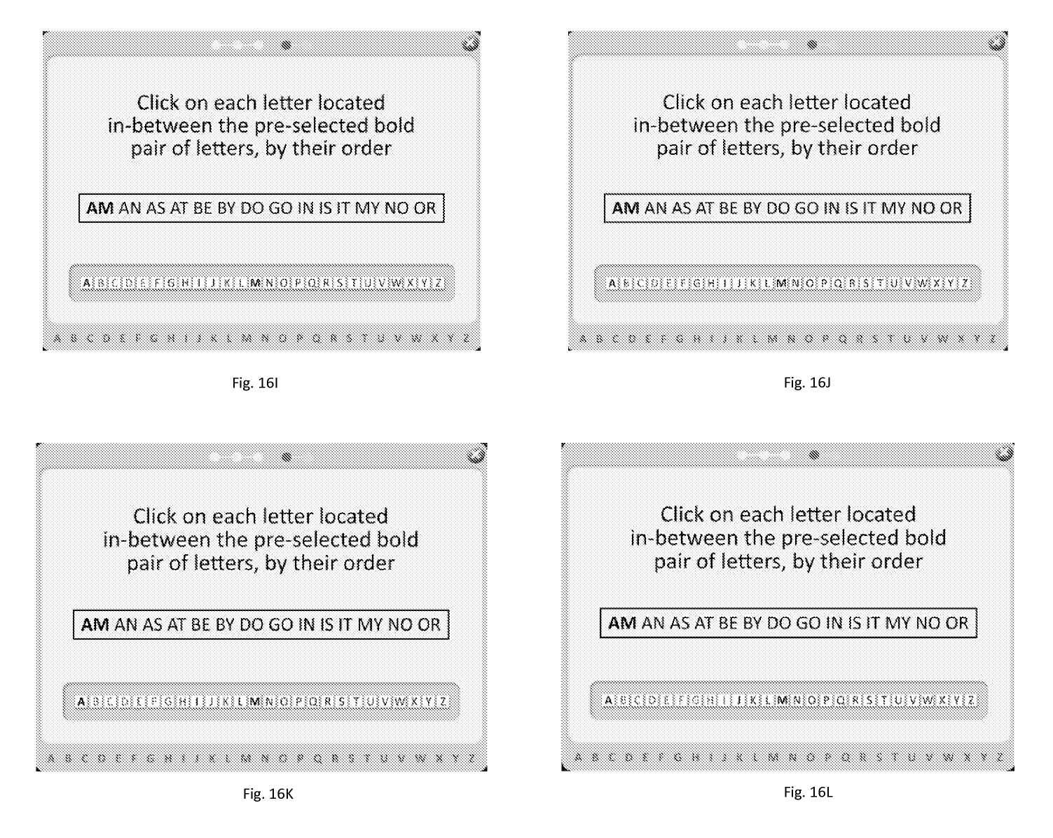

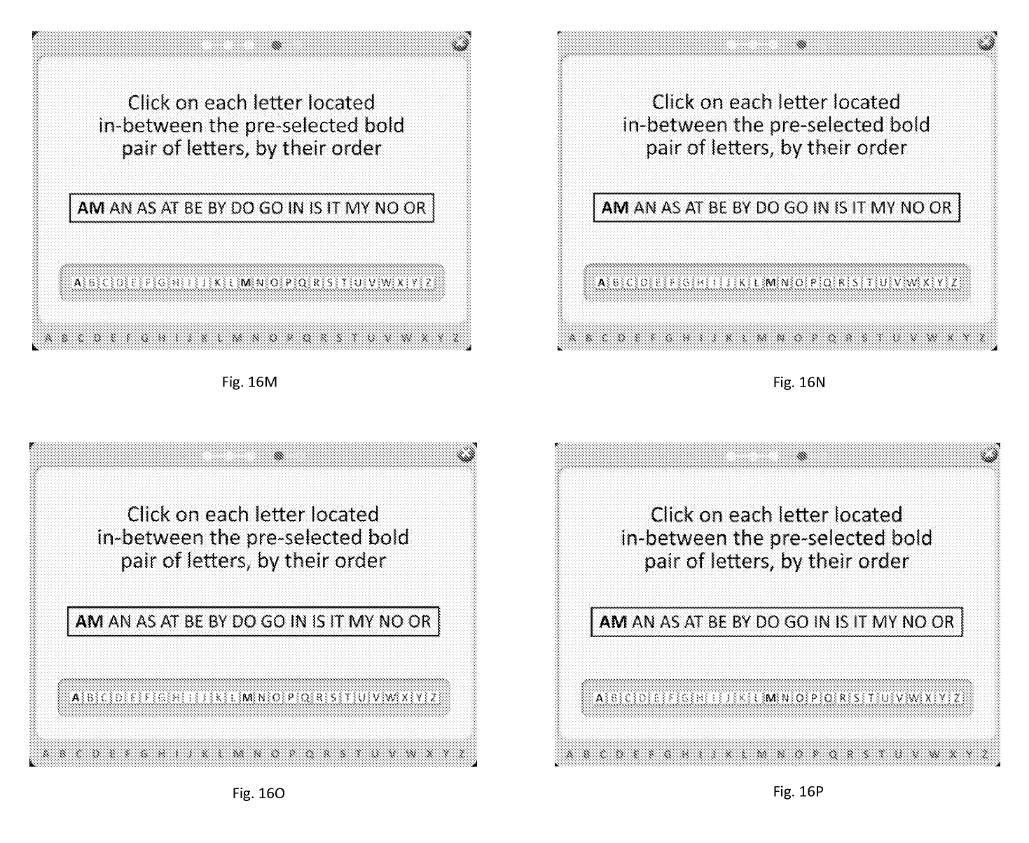

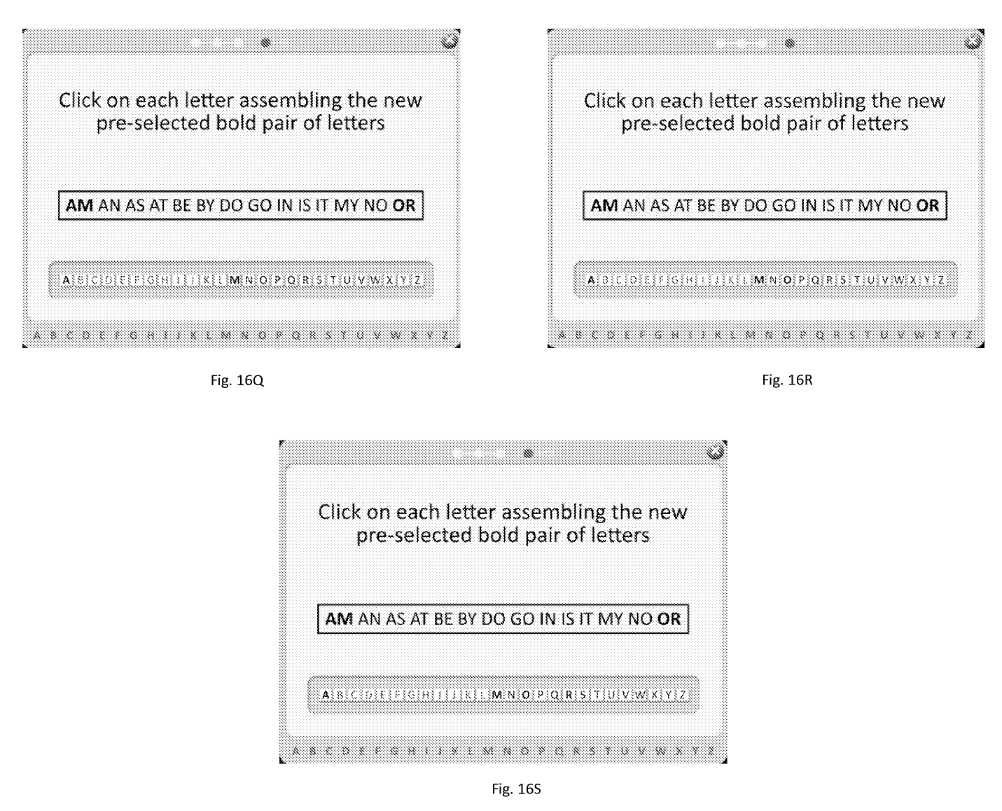

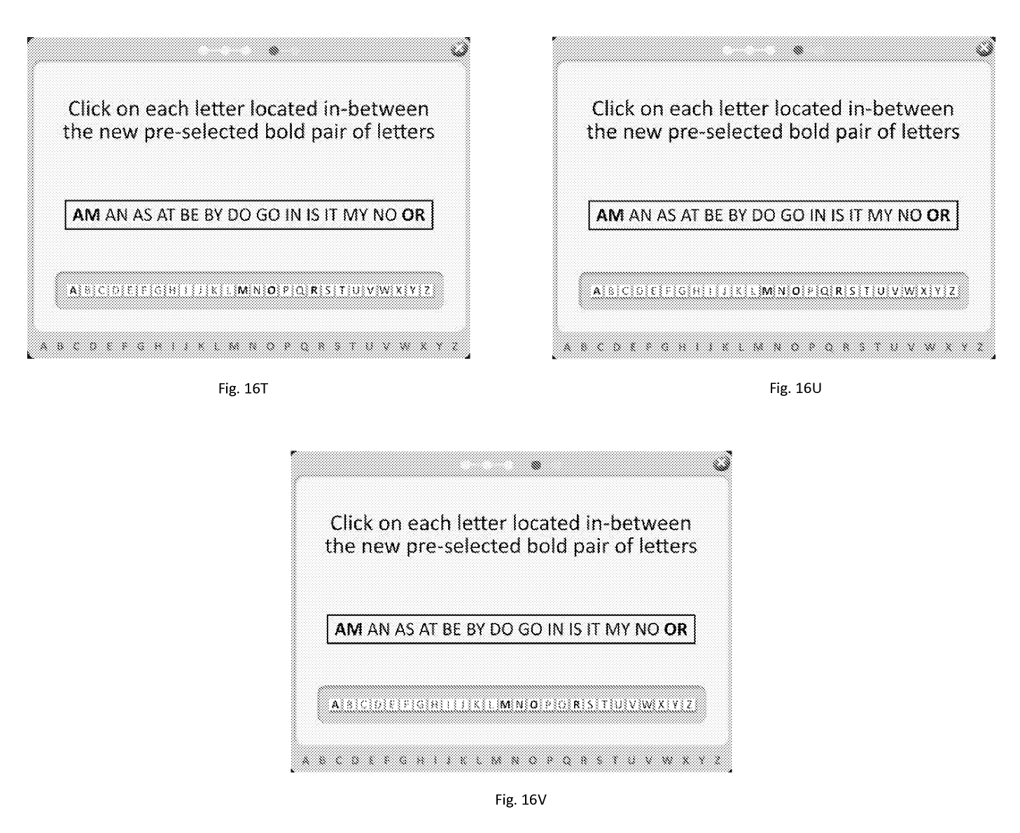

In trial exercise #1 of block exercise 2, the subject is presented with a direct alphabetic set array and a ruler displaying a direct open proto-bigrams sequence. The presentation of a selected open proto-bigram term requires the user to reason, visually recognize and bring about an alphabetic expansion by sensory motor inserting one or more contiguous letters in between the two individual letters forming the selected direct open proto-bigram term, as quickly as possible, in order to expose its corresponding incomplete alphabetic letters sequence. As shown in FIG. 16A, the subject is provided with a direct alphabetical letters sequence and a ruler displaying a direct open proto-bigrams sequence. Both the direct alphabetical letters sequence and the open proto-bigrams sequence are displayed in default spatial and time perceptual related attributes. In FIG. 16B, assigned direct open proto-bigram term ‘AM’ is displayed in spatial perceptual related attribute font boldness in the open proto-bigrams sequence shown in the ruler.

In a non-limiting aspect of the present exercises, the subject will sensory motor mouse click on the two letters (one letter at a time) of the selected direct open proto-bigram term from left to right in the direct alphabetic set array. If this sensory-motor action is done correctly, the two mouse clicked letters of the direct alphabetic set array will change their spatial perceptual related attribute, similar to the spatial perceptual related attributes possessed by the selected direct open proto-bigram term shown in the ruler. All of the selected contiguous letters of the incomplete direct alphabetic sequence embedded in the collective critical space extending in between the two letters forming the selected direct open proto-bigram term will change their time perceptual related attribute font color simultaneously. The maximal allowed time for this action to take place is 20 seconds. Still, the perceptual related attribute changes of font color will remain active for an additional 10 seconds before the next selected open proto-bigram term is displayed. In FIGS. 16C and 16D the correctly sensory motor selected letters ‘A’ and ‘M’ are displayed with spatial perceptual related attribute font boldness. In FIG. 16E, the subject is prompted to sensory motor select each letter held in between the two selected letters of the assigned direct open proto-bigram term in order to reveal the corresponding derived incomplete direct alphabetical letters sequence implicitly held there between. FIGS. 16F-16P show the revealed incomplete direct letters sequence for each correct single letter sensory motor selection between the selected letters of the direct open proto-bigram term ‘AM’ with time perceptual related attribute font red color. Direct open proto-bigram term ‘AM’ is displayed in spatial perceptual related attribute font boldness in the direct alphabetic set array and in the open proto-bigrams sequence shown in the ruler.

The same step is repeated for a newly selected direct open proto-bigram term. In this case, the newly assigned direct open proto-bigram term is highlighted in the ruler with the same spatial and/or time perceptual related attributes changes as the previously selected direct open proto-bigram term. In FIG. 16Q, newly assigned direct open proto-bigram term ‘OR’ is displayed in spatial perceptual related attribute font boldness in the open proto-bigrams sequence shown in the ruler. FIGS. 16R and 16S show the selected letters ‘O’ and ‘R’ displayed with spatial perceptual related attribute font boldness. In FIG. 16T, the subject is prompted to sensory motor select each letter located in between the letters ‘O’ and the ‘R’ of the selected direct open proto-bigram term in order to reveal the corresponding derived incomplete direct alphabetic letters sequence implicitly held therein. FIGS. 16U and 16V show the revealed incomplete direct letters sequence for each correct single letter sensory motor selection between the selected letters of the direct open proto-bigram term ‘OR’ with time perceptual related attribute font red color. In FIG. 16V, selected direct open proto-bigram term ‘OR’ is expanded to explicitly reveal the incomplete direct alphabetical letters sequence ‘PQ’ showing in time perceptual related attribute font red color. Direct open proto-bigram term ‘OR’ is displayed in spatial perceptual related attribute font boldness in the direct alphabetic set array and in the open proto-bigrams sequence shown in the ruler.

After changing the time perceptual related attribute font color for an additional time period of 20 seconds for all of the letters of the explicitly exposed incomplete direct alphabetic sequences implicitly embedded in the critical space of the selected direct open proto-bigram terms displayed in the provided alphabetic set array and changing the spatial perceptual related attribute of the pre-selected direct open proto-bigram terms shown in the ruler to their respective initial default condition, transition is made to the next trial exercise.

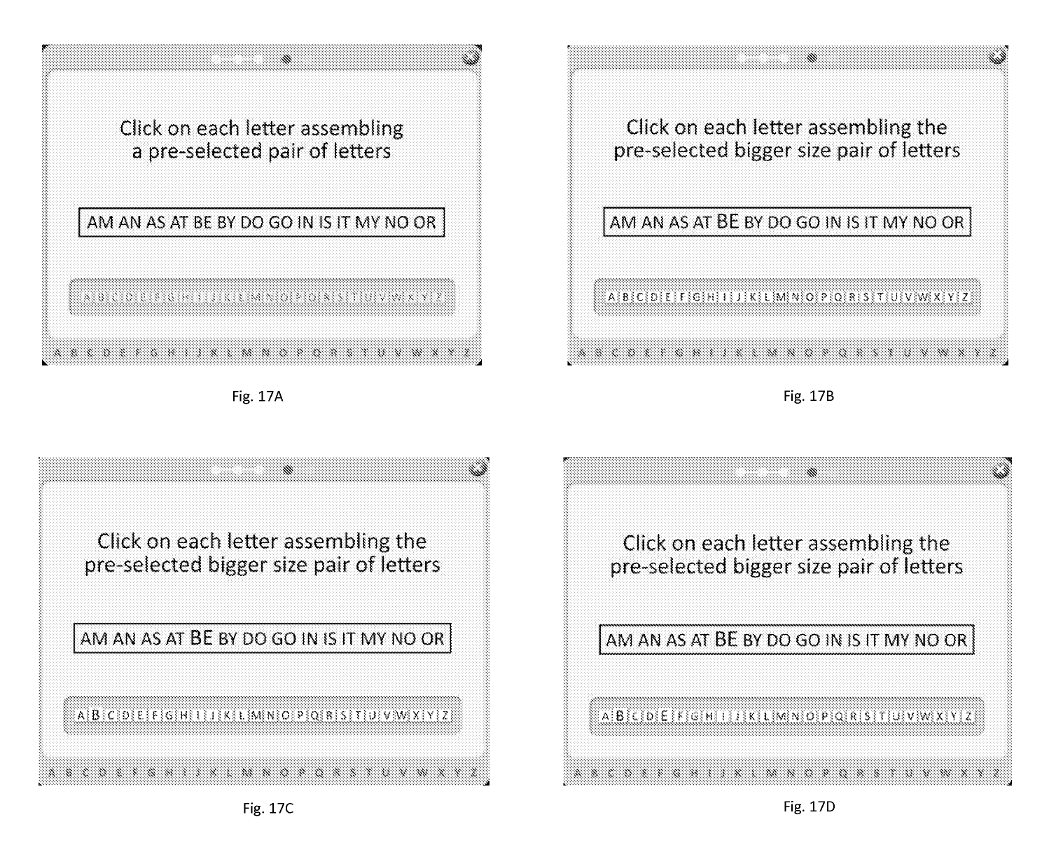

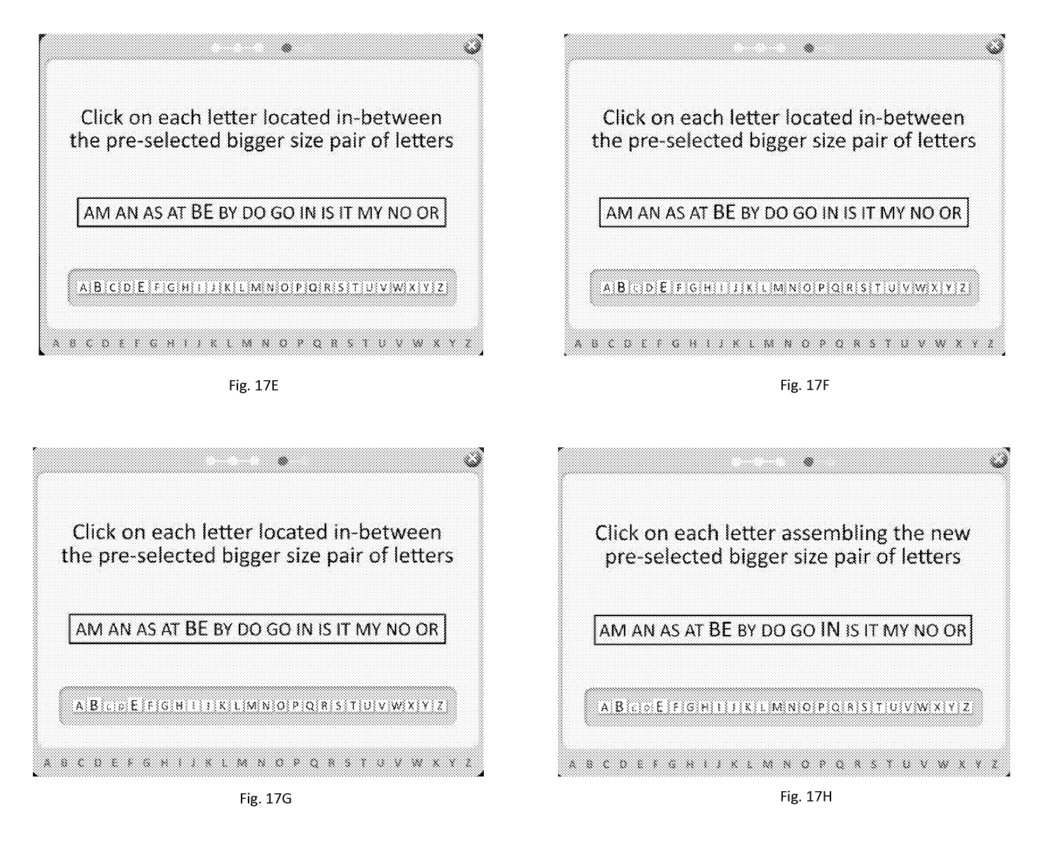

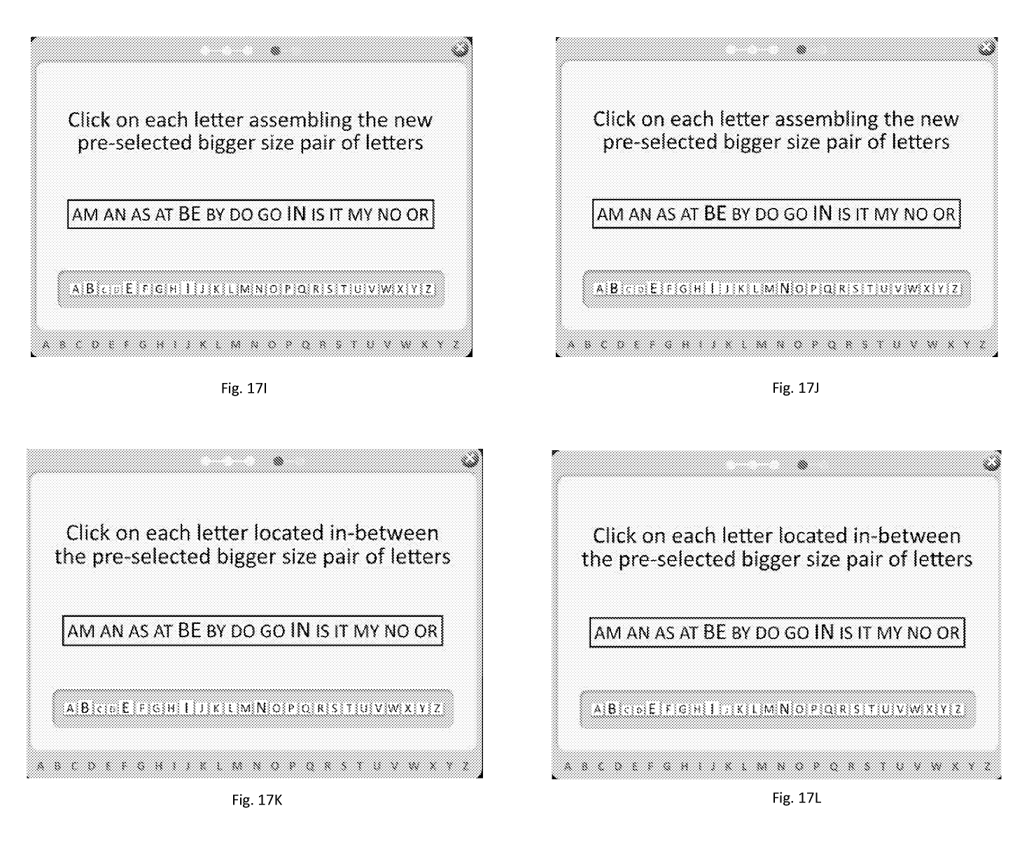

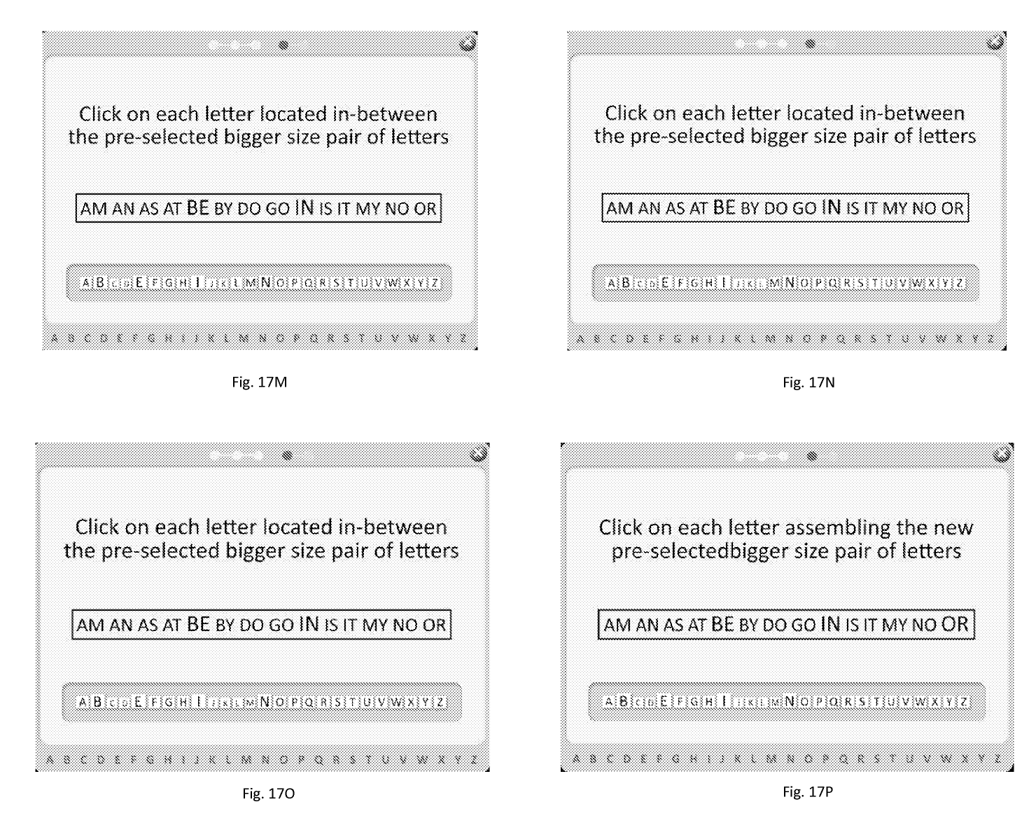

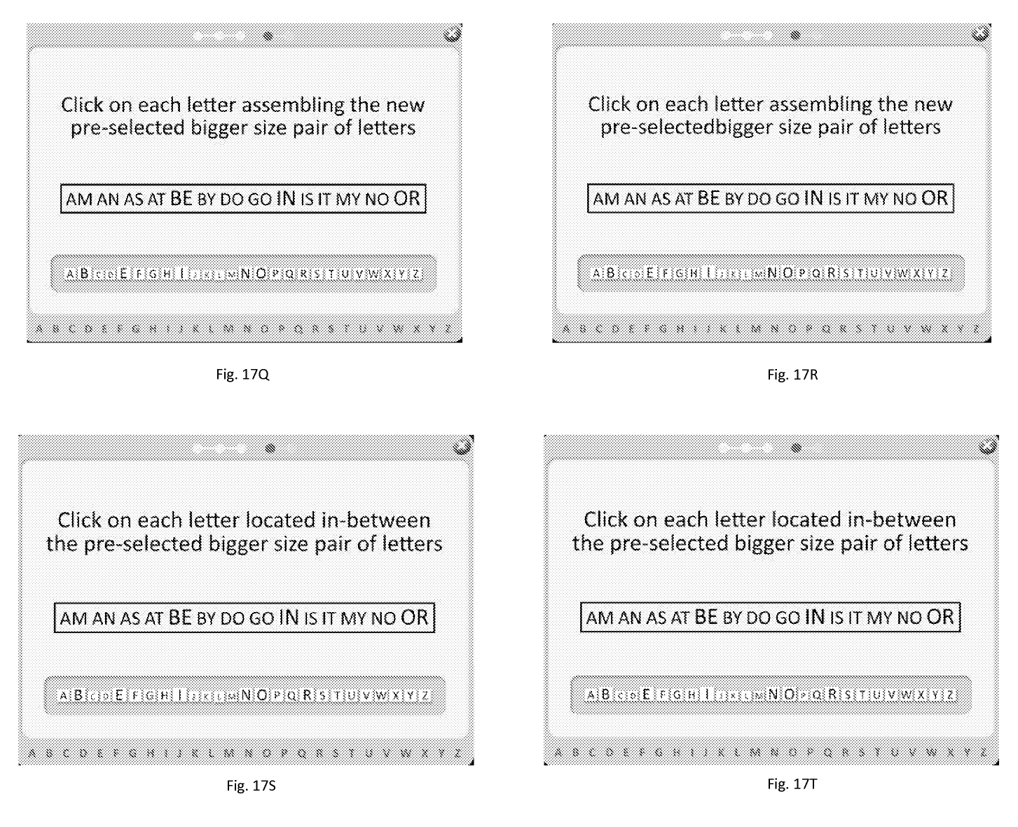

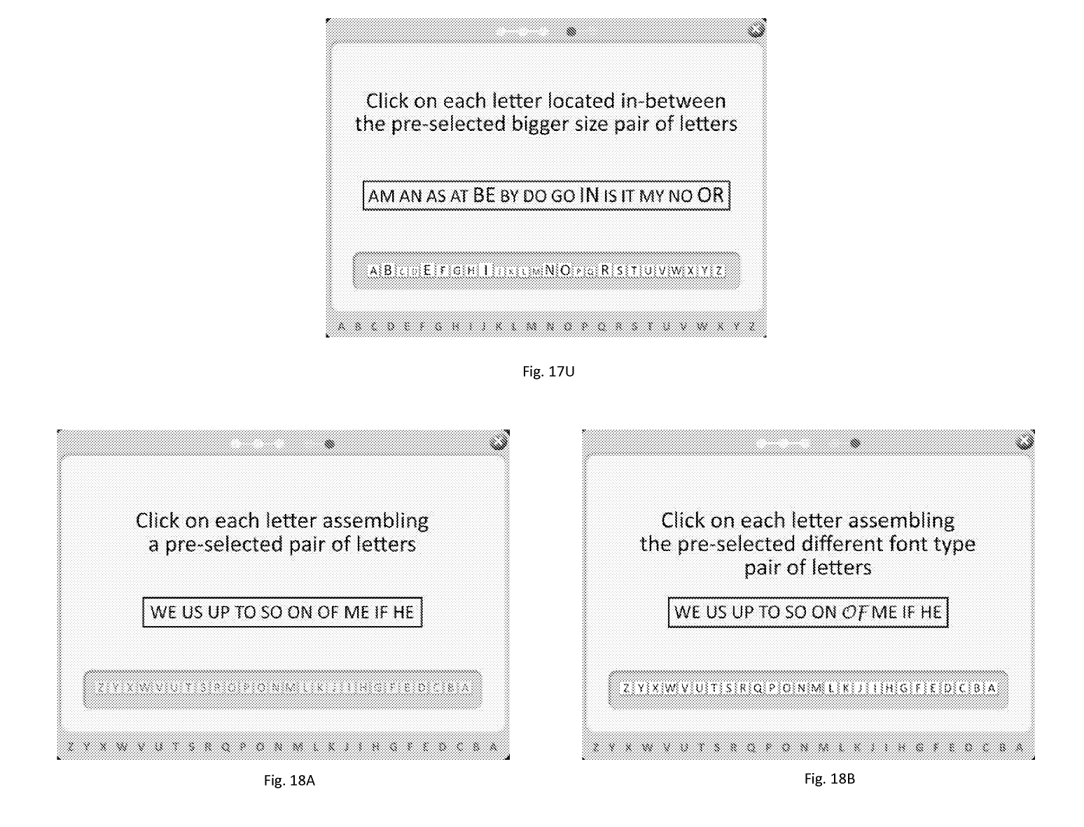

FIGS. 17A-17U depict another set of non-limiting examples of trial exercise #1 of block exercise #2. In this particular example, there is a total of three selected open proto-bigram terms for the subject to expand. As shown in FIG. 17A, the subject is provided with a direct alphabetical letters sequence and a ruler displaying a direct open proto-bigrams sequence. Both the letters sequence and the open proto-bigrams sequence shown in the ruler are displayed in default spatial and/or time perceptual related attributes. In FIG. 17B, assigned open proto-bigram term ‘BE’ is displayed in spatial perceptual related attribute font size (bigger) in the open proto-bigrams sequence shown in the ruler. FIGS. 17C and 17D show the selected letters ‘B’ and ‘E’ displayed with spatial perceptual related attribute font boldness. In FIG. 17E, the subject is prompted to sensory motor select each letter from the displayed direct alphabetic set array that serially fits in between the two selected letters of the assigned open proto-bigram ‘BE’ term. FIGS. 17F and 17G show the sensory motor selected letters in between the assigned open proto-bigram term ‘BE.’ Still, FIG. 17G shows assigned open proto-bigram term ‘BE’ expanded to reveal the incomplete direct alphabetical letters sequence ‘CD’ in spatial perceptual related attribute font size (smaller). Open proto-bigram term ‘BE’ is displayed in spatial perceptual related attribute font size (bigger) in the direct alphabetic set array and in the open proto-bigrams sequence shown in the ruler.

Likewise, in FIG. 17H, newly assigned open proto-bigram term ‘IN’ is displayed in spatial perceptual related attribute font size (bigger) in the open proto-bigrams sequence shown in the ruler. FIGS. 17I and 17J show the selected letters ‘I’ and ‘N’ displayed with spatial perceptual related attribute font size (bigger). In FIG. 17K, the subject is prompted to select each letter placed in between the two selected letters of the assigned open proto-bigram ‘IN’ term from the displayed direct alphabetic set. FIGS. 17L-17O show selected open proto-bigram term ‘IN’ expanded to explicitly reveal the incomplete direct alphabetical letters sequence ‘JLKM’ in spatial perceptual related attribute font size (smaller). Open proto-bigram term ‘IN’ is displayed in spatial perceptual related attribute font size (bigger) in the direct alphabetic set array and in the open proto-bigrams sequence shown in the ruler.

As shown in FIG. 17P, the third assigned open proto-bigram term ‘OR’ is displayed in spatial perceptual related attribute font size (bigger) in the open proto-bigrams sequence shown in the ruler. FIGS. 17Q and 17R show the selected letters ‘O’ and ‘R’ displayed with spatial perceptual related attribute font size (bigger). In FIG. 17S, the subject is prompted to sensory motor select each letter in between the two selected letters of the assigned open proto-bigram ‘OR’ term. FIGS. 17T and 17U show the sensory motor selected letters in between the assigned open proto-bigram term ‘OR’. Further, FIG. 17U shows assigned open proto-bigram term ‘OR’ expanded to reveal the incomplete direct alphabetical letters sequence ‘PQ’ in spatial perceptual related attribute font size (smaller). Open proto-bigram term ‘OR’ is displayed in spatial perceptual related attribute font size (bigger) in the direct alphabetic set array and in the open proto-bigrams sequence shown in the ruler. In the same manner as the previously described examples, after changing the spatial perceptual related attribute font size for an additional time period of 20 seconds for all of the letters of the explicitly exposed incomplete alphabetic sequences embedded in the assigned open proto-bigram terms displayed in the alphabetic set array and changing the spatial perceptual related attribute of the pre-selected open proto-bigram terms shown in the ruler to their respective default spatial and/or time perceptual related attributes, transition is made to the next trial exercise.

Trial exercise #2 of block exercise 2 is structured and performed in essentially the same manner as trial exercise #1 as previously discussed. However, the difference is that the subject is presented with an inverse open proto-bigram term to perform along with an inverse alphabetic set array from the first predefined library and a ruler displaying an inverse open proto-bigrams sequence from the second predefined library. As shown in FIG. 18A, the subject is provided with an inverse alphabetic set array and a ruler displaying an inverse open proto-bigrams sequence. Both the inverse alphabetic set array and the inverse open proto-bigrams sequence shown in the ruler are displayed in default spatial and/or time perceptual related attributes. In FIG. 18B, assigned inverse open proto-bigram term ‘OF’ is displayed in spatial perceptual related attribute font type in the inverse open proto-bigrams sequence shown in the ruler.

FIGS. 18C and 18D show the selected letters ‘O’ and ‘F’ displayed with spatial perceptual related attribute font type. In FIG. 18E, the subject is prompted to select each letter placed in between the two selected letters of the assigned inverse open proto-bigram term ‘OF.’ FIGS. 18F-18M show the sensory motor selected letters in between the inverse open proto-bigram term ‘OF’ expanded to explicitly reveal the incomplete inverse alphabetical letters sequence ‘NMLKJIHG’ shown in time perceptual related attribute font blue color. Inverse open proto-bigram term ‘OF’ is displayed in spatial perceptual related attribute font type in the inverse alphabetic set array and in the inverse open proto-bigrams sequence shown in the ruler.

The same procedure is repeated for a new selected inverse open proto-bigram term. The newly assigned inverse open proto-bigram term is highlighted in the ruler with the same spatial and/or time perceptual related attributes changes as the previously assigned inverse open proto-bigram term. In FIG. 18N, newly assigned inverse open proto-bigram term ‘UP’ is displayed in spatial perceptual related attribute font type in the inverse open proto-bigrams sequence shown in the ruler. FIGS. 18O and 18P show the selected letters ‘U’ and ‘P’ displayed with spatial perceptual related attribute font type. In FIG. 18Q, the subject is prompted to select each letter in between the two selected letters of the assigned inverse open proto-bigram ‘UP’ term. FIGS. 18R-18U show the sensory motor selected letters in between the assigned inverse open proto-bigram term ‘UP’ expanded to reveal the incomplete inverse alphabetical letters sequence ‘TSRQ’ in time perceptual related attribute font blue color. Inverse open proto-bigram term ‘UP’ is displayed in spatial perceptual related attribute font type in the inverse alphabetic set array and in the inverse open proto-bigrams sequence shown in the ruler.

After changing the time perceptual related attribute font color for an additional time period of 20 seconds for all of the letters of the explicitly exposed incomplete inverse alphabetic sequences embedded in the assigned inverse open proto-bigram terms displayed in the inverse alphabetic set array and changing the spatial perceptual related attribute of the pre-selected inverse open proto-bigram terms shown in the ruler, the trial exercise ends.

The methods implemented by the exercises of Example 3 also contemplate those situations in which the subject fails to perform the given task. The following failing to perform criteria is applicable to any trial exercise in any block exercise of the present task in which the subject fails to perform. The “failure to perform” criteria occurs in the event the subject fails to perform by not sensory motor click-selecting (the subject remains inactive/passive) with the hand-held mouse device on any assigned open proto-bigram term answer within a valid performance time period. After a valid performance time period has elapsed, a new same kind of trial exercise is then executed for the subject to begin performing from scratch.

For any trial exercise where the subject fails to respond for 3 consecutive times, the current trial exercise ends and the next in-line block exercise is presented to the subject. If the lack of response occurs for 3 consecutive times during the last block exercise, the current trial exercise ends and the subject is returned to the main menu. Further, any time the subject sensory motor selects the wrong pair of letters in any valid performance period, the incorrect sensory motor selection will immediately be undone and the subject will again be able to make a new sensory motor selection.

The total duration to complete the exercises of Example 3, as well as the time it took to implement each one of the individual trial exercises, is registered in order to help generate an individual and age-gender group performance score. Incorrect sensory motor selections of letters are also recorded and counted as part of the subject's performance score. In general, the subject will perform the exercises of Example 3 about 6 times during his/her language based neuroperformance training program.

1. A method for promoting reasoning ability in a subject by a step by step integrating process of serially displayed orthographic symbols involving non-contiguous letter symbols for assembling letter symbol pairs embedded in a letter sequence, wherein each pair is formed by two different letter symbols, has a semantic meaning that has a high frequency of use in a language, and must be discriminated by sight, the integration process promoting the reasoning ability in the subject to conceptualize sequentially ordered different non-contiguous letters to infer about serial integration of different non-contiguous letters in the letter sequence, the method comprising:
a) selecting a letters sequence from a first predefined library of letters sequences and one or more letter symbol pairs, which are sight words, from a second predefined library of open proto-bigram terms sequences, and showing the selected letters sequence along with a ruler displaying the selected one or more letter symbol pairs to the subject;
b) promoting a sensorial perceptual awareness in the subject about the presence of at least two non-consecutive different letters in the provided letters sequence, which form one of the selected letter symbol pairs displayed in the ruler of step a);
c) prompting the subject to perform, within a first predefined time period, a pre-selected sensory-motor activity indicative of a conscious discrimination of the presence of the at least two non-consecutive different letters, which form one of the letter symbol pairs of step b) within the provided letters sequence;
d) within a second predefined period of time and by a predefined sensory-motor activity, removing all of the letters in the selected letters sequence between the two non-consecutive different letters forming the discriminated letter symbol pair of step c) to create two remaining letter sections;
e) within a third predefined period of time, collapsing the two remaining letter sections together to perform either a local or non-local compression of the selected letters sequence, such that the two non-consecutive different letters forming the discriminated letter symbol pair of step c) become serially contiguous with each other thereby transforming the selected letters sequence, and prompting the subject to be sensorially perceptually aware of the letters sequence transformation;
f) repeating steps b)-e), for each letters sequence selected from the first predefined library in step a), for a predefined number of times, where each repetition is separated by a first predefined time interval;
g) repeating the above steps for a predefined number of iterations, where each iteration is separated by a second predefined time interval; and
h) showing the subject results of each iteration at the end of the predefined number of iterations.

2. The method of claim 1, wherein the open proto-bigram terms sequences of the second predefined library comprise direct open proto-bigram terms sequences and inverse open proto-bigram terms sequences.

3. The method of claim 1, wherein the letters in the selected letters sequence from the first predefined library and the selected letter symbols pairs of step a) all have the same spatial and time perceptual related attributes.

4. The method of claim 1, wherein the selected letters sequence from the first predefined library in step a) is selected from a group of English alphabet letter sequences including:
direct alphabetic set array, inverse alphabetic set array, non-alphabetic array, non-alphabetic array having a subset of missing letters replaced by repeated letters from among the remaining letters of the non-alphabetic array, incomplete alphabetic set array, and non-alphabetic letters sequences with a predefined number of different letters and repeated letters.

5. The method of claim 1, wherein the predefined number of iterations comprises a predefined serial order from which the subject will perform the selected letters sequences from the first predefined library.

6. The method of claim 1, wherein the selected letters sequence from the first predefined library is provided to the subject in a letters matrix, wherein the letters are arranged in a predefined number of rows, each row having a predefined number of letters.

7. The method of claim 6, wherein the selected letters sequence is a non-alphabetic letters sequence.

8. The method of claim 1, wherein promoting the sensorial perceptual awareness in the subject is achieved by providing one or more kinds of sensorial perceptual stimuli in order for the subject to efficiently discriminate the two non-consecutive different letters forming the letter symbol pair in step b), and where the sensorial perceptual stimuli are selected from the group including: visual, auditory, and tactile stimuli.

9. The method of claim 8, wherein the visual stimuli is provided to the subject from a ruler, distinctively showing an assigned open proto-bigram term to be consciously discriminated by the subject inside of the selected letters sequence.

10. The method of claim 9, wherein distinctively showing an assigned open proto-bigram term to the subject comprises one or more spatial and/or time perceptual related attribute changes of the assigned open proto-bigram term, which differ from the spatial and/or time perceptual related attributes of the other open proto-bigram terms in the ruler and/or the letters in the selected letters sequence.

11. The method of claim 1, wherein the pre-selected sensory-motor activity of the subject in step c) and the predefined sensory-motor activity in step d) include one or more of: mouse clicking on each letter; pointing at a single letter at a time with a finger while touching a screen where the selected letters sequence is displayed in a serial location where each letter is found; and spelling the name of each letter aloud, one at a time.

12. The method of claim 1, wherein the removal of all of the letters in step d) is done simultaneously or each letter removal is separated by a third predefined time interval, and the collapsing of step e) is concluded after the third predefined time period following the removal of the last letter.

13. The method of claim 1, wherein prompting of the subject to be sensorially perceptually aware of the letters sequence transformation in step e) includes changing one or more spatial and/or time perceptual related attributes of the discriminated letter symbol pair, during and after the local or non-local compression of the selected letters sequence in step e).

14. The method of claim 1, wherein no more than two consecutive letters are in between the two non-consecutive different letters of step b).

15. The method of claim 1, wherein more than two consecutive letters are in between the two non-consecutive different letters of step b).

16. The method of claim 1, wherein the selected letters sequence provided to the subject has a total number of letters equal to N, and wherein N−2 letters are located between the two non-consecutive different letters of step b).

17. The method of claim 16, wherein the N total number of letters is from 3 to 120 letters.

18. The method of claim 1, wherein the predefined number of iterations ranges from 1 to 7 iterations.

19. The method of claim 12, wherein the first predefined time period is within 10 to 20 seconds, the second predefined time period is in a range of 1 to 5 seconds per letter to be removed, the third predefined time period is in a range of 1 to 3 seconds, the first and second predefined time intervals are in a range of 4 to 8 seconds, and the third predefined time interval is in a range of 1 to 3 seconds.

20. A computer program product for promoting reasoning ability in a subject by a step by step integrating process of serially displayed orthographic symbols involving non-contiguous letter symbols for assembling letter symbol pairs embedded in a letter sequence, wherein each pair is formed by two different letter symbols, has a semantic meaning that has a high frequency of use in a language, and must be discriminated by sight, the integration process promoting the reasoning ability in a subject to conceptualizes sequentially ordered different non-contiguous letters to infer about serial integration of different non-contiguous letters in the letter sequence, the computer program product stored on a non-transitory computer-readable medium which when executed causes a computer system to perform a method, comprising:
a) selecting a letters sequence from a first predefined library of letters sequences and one or more letter symbol pairs, which are sight words, from a second predefined library of proto-bigram terms sequences, and showing the selected letters sequence along with a ruler displaying the selected one or more letter symbol pairs to the subject;
b) promoting a sensorial perceptual awareness in the subject about the presence of at least two non-consecutive different letters in the provided letters sequence, which form one of the selected letter symbol pairs displayed in the ruler of step a);
c) prompting the subject to perform, within a first predefined time period, a pre-selected sensory-motor activity indicative of a conscious discrimination of the presence of the at least two non-consecutive different letters, which form one of the letter symbol pairs of step b) within the provided letters sequence;
d) within a second predefined period of time and by a predefined sensory-motor activity, removing all of the letters in the selected letters sequence between the two non-consecutive different letters forming the discriminated letter symbol pair of step c) to create two remaining letter sections;
e) within a third predefined time period, collapsing the two remaining letter sections together to perform either a local or non-local compression of the selected letters sequence, such that the two non-consecutive different letters forming the discriminated letter symbol pair of step c) become serially contiguous with each other thereby transforming the selected letters sequence, and prompting the subject to be sensorially perceptually aware of the letters sequence transformation;
f) repeating steps b)-e), for each letters sequence selected from the first predefined library in step a), for a predefined number of times, where each repetition is separated by a first predefined time interval;
g) repeating the above steps for a predefined number of iterations, each separated by a second predefined time interval; and
h) presenting the subject with results from each iteration at the end of the predefined number of iterations.

21. A system for promoting reasoning ability in a subject by a step by step integrating process of serially displayed orthographic symbols involving non-contiguous letter symbols for assembling letter symbol pairs embedded in a letter sequence, wherein each pair is formed by two different letter symbols, has a semantic meaning that has a high frequency of use in a language, and must be discriminated by sight, the integration process promoting the reasoning ability in the subject to conceptualize sequentially ordered different non-contiguous letters to infer about serial integration of different non-contiguous letters in the letter sequence, the system comprising;
a computer system comprising a processor, memory, and a graphical user interface (GUI), the processor containing instructions for:
a) selecting a letters sequence from a first predefined library of letters sequences and one or more letter symbol pairs, which are sight words, from a second predefined library of open proto-bigram terms sequences, and showing the selected letters sequence along with a ruler displaying the selected one or more letter symbol pairs to the subject on the GUI;
b) promoting a sensorial perceptual awareness in the subject about the presence of at least two non-consecutive different letters in the provided letters sequence, which form one of the selected letter symbol pairs displayed in the ruler of step a);
c) prompting the subject on the GUI to perform, within a first predefined time period, a pre-selected sensory-motor activity indicative of a conscious discrimination of the presence of the two non-consecutive different letters, which form one of the letter symbol pairs of step b) within the provided letters sequence;
d) within a second predefined time period and by a predefined sensory-motor activity, removing all of the letters in the selected letters sequence between the two non-consecutive different letters forming the discriminated letter symbol pair of step c) to create two remaining letters sections;
e) within a third predefined time period, collapsing the two remaining letter sections together to perform either a local or non-local compression of the selected letters sequence, such that the two non-consecutive different letters forming the discriminated letter symbol letter pair of step c) become serially contiguous with each other thereby transforming the selected letters sequence, and prompting the subject to be sensorially perceptually aware of the letters sequence transformation on the GUI;
f) repeating steps b)-e) for each letters sequence selected from the first predefined library in step a) a predefined number of times, where each repetition is separated by a first predefined time interval;
g) repeating the above steps a predefined number of iterations, where each iteration is separated by a second predefined time interval; and
h) presenting the subject with results from each iteration at the end of the predefined number of iterations on the GUI.

22. A method for promoting reasoning ability in a subject by a step by step integrating process of serially displayed orthographic symbols involving non-contiguous letter symbols for assembling letter symbol pairs embedded in a letter sequence, wherein each pair is formed by two different letter symbols, has a semantic meaning that has a high frequency of use in a language, and must be discriminated by sight, the integration process promoting sensorial perceptual awareness of non-contiguity in letter sequences in the subject to infer about serial integration of different non-contiguous letters in the letter sequence, the method comprising:
a) selecting a letters sequence from a first predefined library of letters sequences and one or more letter symbol pairs, which are sight words, from a second predefined library of open proto-bigram terms sequences, and providing the selected letters sequence and the selected one or more letter symbol pairs to the subject;
b) promoting a sensorial perceptual awareness in the subject about the presence of at least two non-contiguous different letters in the selected letters sequence, which form one of the selected letter symbol pairs;
c) prompting the subject to perform, within a first predefined time period, a pre-selected sensory-motor activity indicative of a conscious discrimination of the presence of the at least two non-contiguous different letters, which form one of the letter symbol pairs of step b) within the provided letters sequence;
d) within a second predefined time period and by a pre-selected sensory-motor activity, alphabetically expanding the discriminated letter symbol pair by explicitly inserting the serial order of letters found in between the two non-contiguous different letters in an alphabetic set array, one letter at a time, in between the discriminated letter symbol pair to transform the selected letters sequence, and prompting the subject to be sensorially perceptually aware of the letters sequence transformation by highlighting the inserted letters;
e) repeating steps b) to d), for each letter symbol pair selected from the second predefined library in step a) and discriminated in step c), a predefined number of times, where each repetition is separated by a first predefined time interval;
f) repeating the above steps for a predefined number of iterations, where each iteration is separated by a second predefined time interval; and
f) showing the subject results of each iteration at the end of the predefined number of iterations.

23. The method of claim 22, wherein the letter sequences of the first predefined library comprise: direct alphabetic set arrays, inverse alphabetic set arrays, randomized serial orders of alphabetic set arrays, and randomized serial orders of incomplete alphabetical sequences.

24. The method of claim 22, wherein the proto-bigram terms sequences of the second predefined library comprise direct open proto-bigram term sequences and inverse open proto-bigram term sequences.

25. The method of claim 22, wherein the letters in the selected letters sequence from the first predefined library and the selected letter symbols pairs of step a) all have the same spatial and time perceptual related attributes.

26. The method of claim 22, wherein the predefined number of iterations comprises a predefined serial order from which the subject will perform the selected letters sequences from the first predefined library and the selected proto-bigrams terms of the second predefined library.

27. The method of claim 22, wherein promoting the sensorial perceptual awareness in the subject is achieved by providing one or more kinds of sensorial perceptual stimuli to facilitate visual discrimination of the two non-contiguous different letters forming the letter symbol pair in step b), and wherein the sensorial perceptual stimuli are selected from the group including: visual, auditory, and tactile stimuli.

28. The method of claim 27, wherein the visual stimuli is provided to the subject from a ruler distinctively showing an assigned open proto-bigram term to be consciously discriminated by the subject embedded in the selected letters sequence and, if predefined, the ruler will also distinctively show the serial order of letters to be sensory motor inserted in between the discriminated letter symbol pair in step d).

29. The method of claim 28, wherein distinctively showing the assigned open proto-bigram term and the serial order of letters comprises one or more spatial and/or time perceptual related attribute changes of the assigned open proto-bigram term, which are different than one or more spatial and/or time perceptual related attribute changes of the letters in the serial order of letters and from selected changes of the spatial and/or time perceptual related attributes of the other open proto-bigram terms in the ruler and/or in the remaining letters of the selected letters sequence.

30. The method of claim 22, wherein the pre-selected sensory-motor activities of the subject in steps c) and d) consist of one or more of the group including: mouse clicking on each letter; mouse dragging of a letter; pointing at a single letter at a time with a finger while touching a screen where the selected letters sequence is displayed in a serial location where each letter is found; and spelling the name of each letter aloud, one at a time.

31. The method of claim 22, wherein prompting of the subject to be sensorially perceptually aware of the letters sequence transformation in step d) includes changing one or more spatial and/or time perceptual related attributes of the discriminated letter symbol pair and of the inserted serial order of letters from the alphabetic set array.

32. The method of claim 22, wherein the selected letters sequence of step a) includes at least one letter symbol pair serially separated by no more than two contiguous letters.

33. The method of claim 22, wherein the selected letters sequence of step a) includes at least one letter symbol pair serially separated by more than two contiguous letters.

34. The method of claim 22, wherein the first and last letters of the selected letters sequence of step a) form an open proto-bigram term, and where there are N number of letters between the first and last letters.

35. The method of claim 34, wherein the N number of letters ranges from 3 to 120 letters.

36. The method of claim 22, wherein the predefined number of iterations ranges from 1 to 7 iterations.

37. The method of claim 22, wherein the first predefined time period is within a range of 10 to 20 seconds, the second predefined time period is within a range of 3 to 6 seconds per letter of the serial order of letters to be inserted, and the first and second predefined time intervals are any time intervals within a range of 4 to 8 seconds.

38. A computer program product for promoting reasoning ability in a subject by a step by step integrating process of serially displayed orthographic symbols involving non-contiguous letter symbols for assembling letter symbol pairs embedded in a letter sequence, wherein each pair is formed by two different letter symbols, has a semantic meaning that has a high frequency of use in a language, and must be discriminated by sight, the integration process promoting sensorial perceptual awareness of non-contiguity in letter sequences in the subject to infer about serial integration of different non-contiguous letters in the letter sequence, the computer program product stored on a non-transitory computer-readable medium which when executed causes a computer system to perform a method, comprising:
a) selecting a letters sequence from a first predefined library of letters sequences and one or more letter symbol pairs, which are sight words, from a second predefined library of open proto-bigram terms sequences, and providing the selected letters sequence and the selected one or more letter symbol pairs to the subject;
b) promoting a sensorial perceptual awareness in the subject about the presence of at least two non-contiguous different letters in the selected letters sequence, which form one of the selected letter symbol pairs;
c) prompting the subject to perform, within a first predefined time period, a pre-selected sensory-motor activity indicative of a conscious discrimination of the presence of the at least two non-contiguous different letters, which form one of the letter symbol pairs of step b) within the provided letters sequence;
d) within a second predefined time period and by a pre-selected sensory-motor activity, alphabetically expanding the discriminated letter symbol pair by explicitly inserting the serial order of letters found in between the two non-contiguous different letters in an alphabetic set array, one letter at a time, in between the discriminated letter symbol pair to transform the selected letters sequence, and thereby prompting the subject to be sensorially perceptually aware of the letters sequence transformation by highlighting the inserted letters;
e) repeating steps b) to d), for each letter symbol pair selected from the second predefined library in step a) and discriminated in step c), a predefined number of times, where each repetition is separated by a first predefined time interval;
f) repeating the above steps for a predefined number of iterations, where each iteration is separated by a second predefined time interval; and
g) showing the subject results of each iteration at the end of the predefined number of iterations.

39. A system for promoting reasoning ability in a subject by a step by step integrating process of serially displayed orthographic symbols involving non-contiguous letter symbols for assembling letter symbol pairs embedded in a letter sequence, wherein each pair is formed by two different letter symbols, has a semantic meaning that has a high frequency of use in a language, and must be discriminated by sight, the integration process promoting sensorial perceptual awareness of non-contiguity in letter sequences in the subject to infer about serial integration of different non-contiguous letters in the letter sequence, the system comprising:
a computer system comprising a processor, memory, and a graphical user interface (GUI), the processor containing instructions for:
a) selecting a letters sequence from a first predefined library of letters sequences and one or more letter symbol pairs, which are sight words, from a second predefined library of open proto-bigram terms sequences, and providing the selected letters sequence and the selected one or more letter symbol pairs to the subject on the GUI;
b) promoting a sensorial perceptual awareness in the subject about the presence of at least two non-contiguous different letters in the selected letters sequence, which form one of the selected letter symbol pairs;
c) prompting the subject on the GUI to perform, within a first predefined time period, a pre-selected sensory-motor activity indicative of a conscious discrimination of the at least two non-contiguous different letters, which form one of the letter symbol pairs of step b) within the provided letters sequence;
d) within a second predefined time period and by a pre-selected sensory-motor activity, alphabetically expanding the discriminated letter symbol pair by explicitly inserting the serial order of letters found in between the two non-contiguous different letters in an alphabetic set array, one letter at a time, in between the discriminated letter symbol pair to transform the selected letters sequence, and thereby prompting the subject on the GUI to be sensorially perceptually aware of the letters sequence transformation by highlighting the inserted letters;
e) repeating steps b) to d), for each letter symbol pair selected from the second predefined library in step a) and discriminated in step c), a predefined number of times, where each repetition is separated by a first predefined time interval;
f) repeating the above steps for a predefined number of iterations, where each iteration is separated by a second predefined time interval; and
g) showing the subject results of each iteration at the end of the predefined number of iterations on the GUI.
